(19) United States
(12) Patent Application Publication
(10) Pub. No.: US 2025/0326993 A1
(43) Pub. Date: Oct. 23, 2025

(54) BIODEGRADABLE GRAFT POLYMERS AS DYE TRANSFER INHIBITORS

(71) Applicant: BASF SE, Ludwigshafen am Rhein (DE)

(72) Inventors: Jan Ole MUELLER, Ludwigshafen am Rhein (DE); Ouidad BENLAHMAR, Ludwigshafen am Rhein (DE); Sophia EBERT, Ludwigshafen am Rhein (DE); Florian SCHOEN, Ludwigshafen am Rhein (DE); Kian MOLAWI, Ludwigshafen am Rhein (DE); Adam BLANAZS, Ludwigshafen am Rhein (DE); Swati DE, Ludwigshafen am Rhein (DE)

(73) Assignee: BASF SE, Ludwigshafen am Rhein (DE)

(21) Appl. No.: 19/235,671

(22) Filed: Jun. 12, 2025

Related U.S. Application Data
(63) Continuation of application No. PCT/EP2023/084830, filed on Dec. 8, 2023.

(30) Foreign Application Priority Data
Dec. 12, 2022 (EP) 22212908.2
Dec. 12, 2022 (EP) 22212911.6

(51) Int. Cl. C11D 3/00; C08F 263/04; C08F 269/00; C08F 271/00

(52) U.S. Cl. CPC C11D 3/0021; C08F 263/04; C08F 269/00; C08F 271/00

(57) ABSTRACT

Novel graft polymers having a polymer backbone (A) as a graft base having polymeric sidechains (B) grafted thereon. The polymeric sidechains (B) are obtainable by polymerization of optionally (B1) at least one vinyl ester monomer, at least one, preferably a least two nitrogen-containing monomer (B2), and optionally further monomer(s) (B3). The polymer backbone (A) comprises polyalkylene-oxide-derived moieties and moieties derived from lactone(s) and/or hydroxy acid(s), those moieties being mixed such that the polymer backbone contains ester-functions within the polymer chains. Process for obtaining such a graft polymer, the process is preferably carried out by free-radical polymerization. Use of such a graft polymer within, for example, fabric and home care products. Compositions and products, such as fabric and home care products, containing such graft polymer. The graft polymers are preferably employed in cleaning compositions as dye transfer inhibitor.

### INCORPORATION BY REFERENCE

PCT/EP2023/084830 filed Dec. 8, 2023, and EP 22212908.2 and EP 22212911.6, both filed Dec. 12, 2022, are all incorporated herein by reference as if fully written out.

### DESCRIPTION

The present invention relates to novel graft polymers for use as dye transfer inhibitors especially in laundry applications, such graft polymer comprising a polymer backbone (A) as a graft base having polymeric sidechains (B) grafted thereon. The polymeric sidechains (B) are obtainable by (co-) polymerization of optionally at least one vinyl ester monomer (B1), at least one, preferably at least two nitrogen-containing monomer(s) (B2), and optionally further monomer(s) (B3), and optionally further monomers. The polymer backbone (A) is made from at least two sub-units (a1) and (a2), wherein (a1) is derived from at least one alkylene oxide monomer, and (a2) is a unit derived from at least one lactone and/or at least one hydroxy acid.

The present invention further relates to a process for obtaining such a graft polymer, the process is preferably carried out by polycondensation. Furthermore, the present invention relates to the use of such a graft polymer within, for example, fabric and home care products. Another subject-matter of the present invention are compositions comprising at least one graft polymer, such as fabric and home care products.

### BACKGROUND

Various states have already introduced initiatives to ban microplastics especially in cosmetic products. Beyond this ban of insoluble microplastic there is an intense dialog on future requirements for soluble polymers used in consumer products. It is therefore highly desirable to identify new better biodegradable ingredients for such applications. This problem is predominantly serious for polymers produced by radical polymerization based on carbon-only backbones (a backbone not containing heteroatoms such as oxygen), since a carbon-only backbone is particularly difficult to degrade for microorganisms. Even radically produced graft polymers of industrial importance with a polyethylene glycol backbone show only limited biodegradation in wastewater. However, the polymers described by the current Invention are preferably produced by radical graft polymerization and provide enhanced biodegradation properties compared to the state-of-the-art.

When laundering fabrics, dye transfer can cause challenges such as that dyes from one portion of a fabric may become suspended in a wash liquor and may then deposit on a different portion of the fabric, or on a different fabric altogether. Transfer of such dyes (known as “fugitive dyes”) can cause dye graying and discoloration of fabrics, especially of those of a light or white color.

Certain polymers, generally known as dye transfer inhibitor/inhibition polymers (“DTI”-polymers; “DTI” also used for “dye transfer inhibition”), have traditionally been used in laundry compositions to address the dye transfer problem. Such polymers include poly-1-vinylpyrrolidone (PVP), poly(vinylpyridine-N-oxide) (PVNO), poly-1-vinylpyrrolidone-co-1-vinylimidazole (PVPVI), and polyvinylpyrrolidone (vinylpyridine-N-oxide (PVPVNO) polymers, which have typically included relatively high levels of 1-vinyl pyrrolidone (“VP”). These traditional DTI polymers are quite effective at inhibiting the transfer of direct dyes, but are not biodegradable due to their carbon-carbon-backbone, which cannot be attacked successfully by microbes.

Copolymers of 1-vinylimidazole and 1-vinylpyrrolidone and their use as efficient dye transfer inhibitor (DTI) in laundry application (liquid, gel-like and solid colour care detergents) are well known (such as “Sokalan@ HP 56” by BASF) and are regarded as “gold-standard”. Those polymers show an excellent dye transfer inhibition at very low amounts, but are—as well as all the before mentioned other known DTI-polymers—not biodegradable in any significant amount as they also have a carbon-carbon-bonded polymer backbone chain.

However, biodegradation of such polymers for use in detergent applications is highly desirable, as a certain amount of consumer products containing such polymers is rinsed away after their use and may, if not biodegraded or otherwise removed in the sewage treatment plant, end up in the river or sea.

It is therefore highly desirable to identify better biodegradable ingredients for such applications.

This problem of poor biodegradability is predominantly serious for polymers produced by radical polymerization based on carbon-only backbones (i.e., a backbone not containing heteroatoms such as oxygen or nitrogen), since a carbon-only backbone is particularly difficult to degrade for microorganisms. Even radically produced graft polymers of industrial importance with a polyethylene glycol backbone show only limited biodegradation in wastewater.

Low molecular weight polyethylene oxide with Mw of 600 g/mol is known to be easily biodegradable, whereas polyethylene oxide with Mw of 6000 g/mol is only poorly biodegradable. BASF's safety data sheet for Pluriol® E 600, revised version 2.0, dated 5. January 2021, affirms for polyethylene glycol with Mw=600 g/mol a DOC value (dissolved organic carbon) measured according to OECD 301A of >70%. In contrast to that, the biodegradability of polyethylene glycol with Mw=6000 g/mol is mentioned in BASF's safety data sheet for Pluriol® E 6000 Pellet, revised version 2.0, dated 10. August 2018, to be only poor, showing only 10-20% CO₂ formation relative to the theoretical value (60 d) according to OECD 301B.

Various further attempts have already been made to provide DTI-polymers of similar performance as the copolymers 1-vinylimidazole and 1-vinylpyrrolidone, but none has achieved a similar performance in DTI or/neither a useful bio-degradability.

Polyalkylene oxides are important polymers with a wide range of applications. They have been extensively used as basis to produce graft polymers which are widely employed in consumer formulations, including cleaning compositions for household and other uses.

Similarly, graft polymers of a vinylester being grafted onto polyalkylene oxide-polymers such as vinylacetate-graft-polyethylene glycol are known polymers. Their application in the detergent area as well as many other application areas are known as well.

Those polymers however lack biodegradability or at least suffer from very limited biodegradability.

However, a certain amount—if not all—of such consumer products is rinsed finally away after their use and may, if not biodegraded or otherwise removed in the sewage treatment plant, end up in the rivers or sea.

Thus, biodegradability is one of the upcoming very important features not only in the area of detergents, as a biodegradable polymer can avoid the issue of building up in the environment.

Such issues will no longer be acceptable according to applicable laws in certain countries, which are expected to be made into law within the very near future if not already implemented and valid.

On the other hand, the functionalities imparted by such polymers is of utmost importance as well, as they allow for high cleaning efficiencies and thus among other advantages also for a low use of cleaning additives for a single cleaning run, and thus allow for saving material used and hence avoid also the pollution of the environment. AS those specialty polymers also allow for cleaning at lower temperatures, in shorter times and with lower amounts of water, they are needed for an environment-friendly cleaning process.

Hence, providing bio-degradable polymers for the area of detergents is of utmost importance to solve the problem of pollution of the environment without compromising cleaning efficiency, as such lower cleaning efficiency would also pollute the environment more than unavoidable.

The poor biodegradability of polyalkylene oxides decreases in the range from a few hundred g/mol molecular weight up to a few thousand g/mol molecular weight. Even more so, graft polymers based on such polyalkylene oxides are usually even poorer in their biodegradation likely due to the grafting.

### Prior Art Graft Polymers

WO 03/042262 relates to “graft polymers” comprising (A) a polymer graft skeleton with no mono-ethylenic unsaturated units and (B) polymer sidechains formed from co-polymers of two different mono-ethylenic unsaturated monomers (B1) and (B2), each comprising a nitrogen-containing heterocycle, whereby the proportion of the sidechains (B) amounts to 35 to 55 wt. % of the total polymer.

However, the graft polymers according to WO 03/042262 do employ larger amounts of vinyl imidazole and vinylpyrrolidone-monomers for the production of the respective polymer sidechains grafted onto the backbone. The performance of those polymers in DTI is acceptable but still far from the gold-standard. Bio-degradation is not mentioned. In view of the higher amounts of vinyl monomers, also the production cost is higher.

U.S. Pat. No. 5,318,719 relates to a class of biodegradable water-soluble graft copolymers having building, anti-filming, dispersing and threshold crystal inhibiting properties comprising (a) an acid functional monomer and optionally (b) other water-soluble, monoethylenically unsaturated monomers copolymerizable with (a) grafted to a biodegradable substrate comprising polyalkylene oxides and/or polyalkoxylated materials. However, U.S. Pat. No. 5,318,719 does employ for the production of the side chains of said graft polymers mandatorily a high amount of acid-functional monomers such as acrylic acid or methacrylic acid. Such type of acid monomers are not useful within the context of the present invention, as they would disturb the DTI-action of the amine-(imidazole) groups and lactam groups.

US 2019/0390142 relates to fabric care compositions that include a graft copolymer, which may be composed of (a) a polyalkylene oxide, such as polyethylene oxide (PEG); (b) N-vinylpyrrolidone (VP); and (c) a vinyl ester, such as vinyl acetate. However, US 2019/0390142 does not disclose further Nitrogen-containing monomers such as vinylimidazole. Also, the amounts of backbone and monomers employed and the intended uses differ.

WO 2007/138053 discloses amphiphilic graft polymers based on water-soluble polyalkylene oxides (A) as a graft base and side chains formed by polymerization of a vinyl ester component (B), said polymers having an average of less than one graft site per 50 alkylene oxide units and mean molar masses M of from 3 000 to 100 000. However, WO 2007/138053 does not contain any disclosure in respect of the biodegradability of the respective graft polymers disclosed therein nor does it disclose any high amounts of nitrogen-containing monomers.

WO2021160795A1 relates to graft polymers comprising a block copolymer backbone (A) as a graft base having polymeric sidechains (B) grafted thereon. The polymeric sidechains (B) are obtainable by polymerization of at least one vinyl ester monomer (B1) and optionally N-vinylpyrrolidone as optional further monomer (B2). Most preferably, the block copolymer backbone (A) is a triblock copolymer of polyethylene oxide (PEG) and polypropylene oxide (PPG). The invention further relates to the use of such a graft polymer within, for example, fabric and home care products. However, besides the only as “optional” included monomer vinylpyrrolidone and the required vinyl ester monomer, no other monomers are to be included, specifically no vinylimidazole-monomer. The application as a DTI is also not mentioned.

WO2020/005476 discloses a fabric care composition comprising a graft copolymer and a so-called treatment adjunct, the graft copolymer comprising a polyalkylene oxide as backbone based on ethylene oxide, propylene oxide, or butylene oxide, preferably poly ethylene oxide, and N-vinylpyrrolidone and vinyl ester as grafted side chains on the backbone and with backbone and both monomers in a certain ratio. Vinylimidazole is not disclosed as a monomer. However, DTI is mentioned as target application of the inventive fabric care composition; the explicit use of the graft polymer as such as DTI-polymer is not explicitly disclosed besides a “belief” that if the molecular weight of the graft base, e.g. polyethylene glycol, is relatively low, there may be a performance decrease in dye transfer inhibition, but also that when the molecular weight is too high, the polymer may not remain suspended in solution and/or may deposit on treated fabrics. DTI-performance seems to be attributed to the specific combinations of compounds claimed but not the graft polymer as such alone, even more so, further “treatment adjuncts” mentioned as preferred ingredients are the known DTI-polymers as mentioned above as general state of the art known to a skilled person.

WO2020/264077 discloses cleaning compositions containing a combination of enzymes with a polymer such composition being suitable for removal of stains from soiled material. This publication discloses a so-called “suspension graft copolymer” which is selected from the group consisting of poly(vinylacetate)-g-poly(ethylene glycol), poly(vinylpyrrolidone)-poly(vinyl acetate)-g-poly(ethylene glycol), and combinations thereof, and thus does not include vinylimidazole as monomer. Moreover, specifically claimed is that besides that suspension graft polymer typical known dye transfer inhibitor-polymers (those mentioned above as general state of the art known to a skilled person) are comprised in the claimed fabric cleaning compositions.

WO0018375 discloses pharmaceutical compositions comprising a graft polymers obtained by polymerization of at least one vinyl ester of aliphatic C1-C24-carboxylic acids in the presence of polyethers, with the vinyl ester preferably being vinyl acetate. In the most preferred version the graft polymer is prepared from grafting vinyl acetate on PEG of Mw 6000 g/mol and thereafter hydrolyzing the vinyl acetate to the alcohol (which would then resemble a polymer being obtained from the hypothetical monomer “vinlyalcohol”). Main use is the formation of coatings and films on solid pharmaceutical dosage forms such as tablets etc.

Also claimed in WO0018375 however is a polymer being obtained by polymerization of at least one vinyl ester of aliphatic C1-C6-carboxylic acids in the presence of polyethers with at least one monomer selected from the group of c1) C1-C6-alkyl esters of monoethylenically unsaturated C3-C8-carboxylic acids; c4) N-vinylpyrrolidone, N-vinylimidazole, N-vinylcaprolactam; c5) (meth)acrylic acid. 35 Also claimed in WO0018375 is a polymer wherein, in addition to the vinyl esters, at least one other monomer c) selected from the group of c1) C1-C24-alkyl esters of monoethylenically unsaturated C3-C8-carboxylic acids; c2) C1-C24-hydroxyalkyl esters of monoethylenically unsaturated C3-C8-carboxylic acids; c3) C1-C24-alkyl vinyl ethers; c4) N-vinyllactams; c5) monoethylenically unsaturated C3-C8-carboxylic acids is used for the polymerization. 40 Further claimed in WO0018375 is also a polymer wherein, in addition to the vinyl esters, at least one other monomer c) selected from the group of c1) C1-C6-alkyl esters of monoethylenically unsaturated C3-C8-carboxylic acids; c4) N-vinylpyrrolidone, N-vinylimidazole, N-vinylcaprolactam; c5) (meth)acrylic acid is used for the polymerization.

As polymer backbones in WO0018375 polyethers having a number average molecular weight in the range below 500000, preferably in the range from 300 to 100000, particularly preferably in the range from 500 to 20000, very particularly preferably in the range from 800 to 15000 g/mol are disclosed. It is further mentioned a advantageous to use homopolymers of ethylene oxide or copolymers with an ethylene oxide content of from 40 to 99% by weight and thus a content of ethylene oxide units in the ethylene oxide polymers preferably being employed from 40 to 100 mol %. Suitable as comonomers for these copolymers are said to be propylene oxide, butylene oxide and/or isobutylene oxide, with suitable examples being said to be copolymers of ethylene oxide and propylene oxide, copolymers of ethylene oxide and butylene oxide, and copolymers of ethylene oxide, propylene oxide and at least one butylene oxide. The ethylene oxide content in the copolymers is stated to be preferably from 40 to 99 mol %, the propylene oxide content from 1 to 60 mol % and the butylene oxide content in the copolymers from 1 to 30 mol %. Not only straight-chain but also branched homo- or copolymers are said to be usale as grafting base for the grafting.

Exemplified however are in WO0018375 only PEG 6000 and 9000, a “polyethylene glycol/polypropylene glycol block copolymer” (with average molecular weight “about 8000”) and “polyglycerol” (with average molecular weight “2200”) (all in g/mol). Five examples only employ vinyl acetate, and only one example employs vinylacetate and methyl methacrylate as monomers. No other monomers are exemplified. All examples employ as final step the hydrolysis of the polymerized vinyl acetate monomer.

Hence, no polymer is being produced and characterized in WO0018375 containing no vinyl ester monomer but the further required monomers as claimed in the present invention.

Also not disclosed in WO0018375 is the use of such polymers as disclosed herein for detergent and cleaning or fabric care applications, and specifically not for use as DTI-polymers. No such application or uses are mentioned at all in this disclosure.

US2008/255326 discloses a process for preparing a graft polymer comprising a polyalkylene oxide polymer as a graft base, such as poly ethylene glycol, a vinyl ester such as vinyl acetate, and a vinyllactame such as vinyl pyrrolidone, both to be grafted onto the poly alkylene oxide-backbone, and optionally a monomer from a third category (“monomer c)”) in amounts of zero to up to 10 (ten) weight percent based on the total amount of the graft monomers, with the total amount of graft monomers adding up to 100 weight percent, and the amount of all graft monomers being 10 to 95 weight percent based on the total weight of the resulting graft polymer. Vinyl acetate nor any other vinyl ester-monomer however is being used by the present invention.

US 2019/390142 A1 does not disclose graft-polymers comprising vinyl imidazole as monomer, nor any other amine-containing monomer as required by the present invention. Also, the use of the graft polymers of this disclosure for inhibition of the transfer of dyes during washing is not disclosed. The only mentioned vinylimidazol-containing polymers being employed as dye transfer inhibitors within the disclosed compositions are the known copolymers of vinylimidazol and vinylpyrrolidone such as Sokalan HP 56, i.e. standard linear copolymers of those two monomers.

The task of improving the biodegradation of graft polymers based on backbones with polyalkylene oxide-units in the backbone was tackled already in un-published patent application PCT/EP2022/065983, which discloses graft polymers based on backbones comprising as functional units ester-functions and polyalkylene oxide-units. The backbones are prepared by oxidizing polyalkylene oxides in a first reaction, and then esterifying the oxidized PEG-mixtures either with itself or with additionally added polyalkylene oxides. The backbones are then grafted with vinyl acetate.

The polymers in this disclosure suffer from the two-step-synthesis for the backbone: the oxidation as first reaction step is expensive and lengthy, and the composition obtained from the oxidation is difficult to control, as-depending on the time taken for the reaction—the content of the mixture changes. Typically, the mixture obtained contains non-oxidized starting material, polyalkylene oxides with one hydroxy-group being oxidized to carboxyl-function and polyalkylene oxides with both ends being oxidized. Hence, the flexibility of designing the backbone is highly limited.

The patent application does also not disclose the use of nitrogen-containing monomers for preparing the graft polymers.

### Prior Art on Backbones

This present invention discloses the uses of three main types of polymeric backbones comprising (oligo-/poly-)alkylene oxide-moieties and (oligo-/poly-) lactone/hydroxy acid-derived moieties.

Such backbones are named (A1), (A2) and (A3) (see definitions below), and are in principle known so far:

### (A1)

WO2002046268 (Cognis, now BASF) discloses biodegradable polymers as surfactants, emulsifier etc., obtained by reacting an organic initiator with 1. alkylene oxides, 2. mixture of alkylene oxides and lactones. “Organic initiator” is defined on page 4 as mono- or polyfunctional alcohol or amine.

To obtain copolymers from alkylene oxides and caprolactone, suitable starters are reacted with a premixed combination of alkylene oxides and caprolactone.

To obtain (A1)-backbone-type copolymers from alkylene oxides and lactones such as caprolactone, suitable starters are reacted with a premixed combination of alkylene oxides and caprolactone.

Alcohols with 2 hydroxy groups (diols) are used as starters. Examples for such diols are: ethylene glycol, polyethylene glycol, propylene glycol, polypropylene glycol, ethylene oxide and propylene oxide block copolymers, 1,3-propylene diol, 1,4-butane diol, 1,6-hexane diol, neopentyl glycol, and the like.

Used alkylene oxides in combination with caprolactone are: ethylene oxide, 1,2-propylene oxide or 1,2-butylene oxide, 2,3-butylene oxide, 1,2-pentylene oxide, preferred ethylene oxide and propylene oxide.

The copolymerization of alkylene oxides and caprolactone is carried out under typical conditions for alkoxylation reactions. Basic catalysts are used like potassium hydroxide, sodium hydroxide, sodium methoxide, potassium methoxide.

### (A2)

(A2)-backbone-type polymers can be obtained in principle by alkoxylation of polylactones. Polylactones are for example accessible by polymerization of lactones such as caprolactone onto starters having 2 hydroxy-groups such as diols like ethylene glycol, polyethylene glycol, propylene glycol, polypropylene glycol, ethylene oxide and propylene oxide block copolymers, 1,3-propylene diol, 1,4-butane diol, 1,6-hexane diol, neopentyl glycol, and the like.

Polymerization of caprolactone is carried out with various catalysts like transesterification catalysts tin (II) alkanoates.

The alkoxylation of such polycaprolactones is done under typical alkoxylation conditions. Due to basic reaction conditions for the alkoxylation, transesterification reaction at ester bonds from polycaprolactone can occur.

U.S. Pat. No. 4,281,172 describes acrylic acid esters from polyester-polyether copolymers. To obtain these structures, a polylactone ester from mono-, di-, tri-, or tetraols, is reacted with alkylene oxides.

The polylactone esters are synthesized according to U.S. Pat. No. 3,169,945 from a hydroxy group-containing component with various catalysts, including Ti or Sn catalysts or alkali metal hydroxides.

The alkoxylation reaction is catalyzed with BF3-etherate or potassium hydroxide etc.

JP07149883 describes the process to obtain polyester-polyols from a compound with at least two active hydrogen, reacted with a lactone, followed by reaction with alkylene oxide. Both reactions are carried out with the same catalyst. Catalysts are alkali metal hydroxides or alkali metal alcoholates.

WO9636656 claims biodegradable alkylene oxide-lactone copolymers. The polymers are synthesized from a di- or polyfunctional starter, that are reacted with alkylene oxide and lactones in a copolymerization reaction, followed by an end-cap with an alkylene oxide block. Catalysts are alkali metal hydroxide or earth alkali metal hydroxide or Lewis acid. The patent application describes improved biodegradability of claimed polymers over polyalkylene oxides, and use as surfactants, emulsifiers etc. but not as backbones for graft polymers.

### (A3)

(A3)-backbone-type polymers can be obtained in principle by poly-esterification of polyalkylene glycols with lactones yielding-simplified-tri-block-polymers.

Triblock copolymers from caprolactone and alkylene oxides with a middle polyalkylene oxide block are synthesized by 1. formation of a polyalkoxylate from a diol or water by reaction with alkylene oxides, and 2. polymerization of caprolactone onto the polyalkoxylate. Both reactions can be carried out under typical reaction conditions for alkoxylation reactions (polyalkoxylate) and for caprolactone polymerization (polycaprolactone block).

Such triblock copolymers with a middle polyethylene oxide block are known since about the 1990s. These polymers are used for drug release and solubilization purposes (Z. Zhu et al., Journal of Polymer Science, Part A: Polymer Chemistry 1997, 35 (4), 709-714; M. Boffito et al., Journal of Biomedical Materials Research, Part A 2015, 103A (3), 1276-1290).

### (A4)

(A4)-type backbones are known as well:

WO96/36656 discloses biodegradable oxide-lactone copolymers and copolyesters as already described for (A3) above.

WO2002046268 (Cognis, now BASF) discloses alkylene oxide-lactone copolymers as already described for (A1).

Not known however are the use of such polymers as backbones for graft polymers, introducing via the backbone an improved biodegradation into such graft polymers.

### OBJECT OF INVENTION

It was recognized that the graft polymers based on conventional polyalkylene oxides (without ester-groups in the backbone) show a surprisingly low biodegradation, which is often very much lower than the expected biodegradation percentage, which is calculated on the biodegradation of the pure polyalkylene oxides.

The graft polymers being based on such conventional polyalkylene oxides commonly show a decrease in biodegradation compared to the unmodified polyakylene oxides and unmodified polyalkylene glycols, as the degree of modification of polyalkylene oxides (often polyalkylene oxides with two hydroxy-end groups are employed, thus such polyakylene oxides with hydroxy-groups being named commonly “polyalkylene glycols”) with polymerizable monomers by radical grafting onto such backbones increases (i.e. the number of side chains on the backbone increases). This is sometimes attributed to the blocking of the biodegradation mechanism, as it seems that the polyalkylene oxides/glycols are degraded starting from their respective end group then following the polymer chain along. Thus, any additional branching on a carbon-atom of the backbone-which occurs when a polymeric side chain is grafted onto such backbone-impedes and possibly completely stops degradation. As a result, it is suggested that the higher the degree of grafting (i.e. the more side chains are attached to the backbone) the lower is the biodegradation percentage of such graft polymer. Unfortunately it is also commonly observed that with higher degree of branching the performance increases in the desired applications, as only with a higher amount of side chains the chemical structure of the backbone is changed enough that the new graft polymer exerts its specific properties compared to the separated properties of the unmodified backbone in simple mixture with the (unattached/ungrafted) homopolymer which would make up the side chain of the graft polymer.

Hence, the difficulty of combining the conflicting properties of a suitable graft polymer with superior application performance with the biodegradation percentage of the unmodified backbone (i.e. an unmodified polyalkylene oxide/glycol) has not been met up to date when polyalkylene oxides are used as backbones.

Although the unpublished patent application PCT/EP2022/065983 has provided a first solution to the problem of lacking biodegradation of the polyalkylene oxide-backbones, the practical aspects of the solution found is still not satisfactory, as the two-step-reaction is lengthy and costly, as two completely different types of chemical reactions are employed (oxidation and polymerization) and the structural variations are not easily controlled as the oxidation leads to mixtures of compounds being diols (i.e. the starting material polyalkylene glycols), mono-ol-mono-carbonic acid (i.e. partially oxidized polyalkylene glycol) and di-carboxyl-polylakylene oxide (i.e. fully oxidized polyalkylene glycol). Structures as the ones used here are not obtainable by the method disclosed in that document. Similarly, nitrogen-containing monomers are not disclosed.

Hence, there was a need to improve the biodegradation of conventional graft polymers based on polyalkylene oxides by improving the biodegradability of the graft base and keeping the general structure of the graft polymer and thus maintaining the application performance or even improve it, and to improve the cost and efficiency of the unpublished patent application PCT/EP2022/065983 by reducing the production process to just one reaction step employing only one reaction type and improving the variability of the chemical structure at the same time.

Even though polymers of the type (A1), (A2) and (A3) as defined herein are known, the use of such polymers as backbones to prepare graft polymers is not yet known.

Thus, the object of the present invention is to provide novel graft polymers based on polyalkylene-oxide-type graft backbones which impart ester-functions.

Furthermore, these novel graft polymers should have beneficial properties in respect of biodegradability and/or their washing behavior, when being employed within compositions such as cleaning compositions.

### BRIEF DESCRIPTION OF THE DRAWINGS

FIG. 1 provides a comparison of 1H NMR spectra (298 K, D₂O, 400 MHZ) of the fresh sample comparative graft polymer Comp. Ex. VIII (red spectrum) and after storage of an 9 wt % aqueous solution for two weeks at 54° C. (blue spectrum). a) full spectrum, b) enlargement of the region 4.0 to 4.35 ppm.

FIG. 2 provides a comparison of 1H NMR spectra (298 K, D₂O, 400 MHZ) of the fresh graft polymer 11 (bottom spectrum) and after storage of an 9 wt % aqueous solution for two weeks at 54° C. (up spectrum). a) full spectrum, b) enlargement of the region 3.75 to 4.35 ppm.

### GRAFT POLYMERS

The graft polymers of the invention comprise a polymer backbone as graft base as a first structural unit and polymeric side chains as a second structural unit.

### First Structural Unit (Backbone)

The first structural unit of the graft polymer is a polymer backbone used as a graft base for the inventive graft polymer, wherein said polymer backbone (A) is obtainable by polymerization of at least one sub-unit (a1) and at least one sub-unit (a2).

The sub-unit (a1) is made from least one alkylene oxide monomer and/or at least one polyalkylene oxide-polymer having two hydroxy-end-groups, the alkylene oxide monomer selected from the group of C2- to C10-alkylene oxides, preferably C2 to C5-alkylene oxides, such as ethylene oxide, 1,2 propylene oxide, 1,2 butylene oxide, 2,3 butylene oxide, 1,2-pentene oxide or 2,3 pentene oxide; from 1,4-diols or their cyclic or oligomeric analogs, or being based on polymeric ethers of such 1,4-diols; from 1,6-diols or their cyclic or oligomeric analogs, or being based on polymeric ethers of such 1,6-diols; or any of their mixtures in any ratio, either as blocks of certain polymeric units, or as statistical polymeric structures, or a polymers comprising one or more homo-block(s) of a certain monomer and one or more statistical block(s) comprising more than one such monomer, and any combination thereof such as polymers having several different blocks of two or more different monomers, or blocks of two or more different monomers, blocks of statistical mixtures of two or more monomers etc.

The term “block (co) polymer” as used herein means that the respective polymer comprises at least two (i.e. two, three, four, five or more) homo- or co-polymer subunits (“blocks”) linked by covalent bonds. “Two-block” copolymers have two distinct blocks (homo- and/or co-polymer subunits), whereas “triblock” copolymers have, by consequence, three distinct blocks (homo- and/or co-polymer subunits) and so on. The number of individual blocks within such block copolymers is not limited; by consequence, a “n-block copolymer” comprises n distinct blocks (homo- and/or co-polymer subunits). Within the individual blocks the size/length of such a block may vary independently from the other blocks. The smallest length/size of a block is based on two individual monomers (as a minimum), but may be as large as 50 or even 100 or 200, and any number in between 2 and 200. The respective monomers to be employed for preparing the individual blocks of a block copolymer backbone (a1) may be added in sequence. However, it is also possible that there is a transition of the feed from one monomer to the other to produce so called “dirty structures” wherein at the edge/border of the respective block a small number of monomers of the respective neighboring block may be contained within the individual block to be considered (so called “dirty structures” or “dirty passages”). However, it is preferred that the block copolymer sub-units (a1) according to the present invention do not contain any dirty structures at the respective border of the blocks, although for commercial reasons (i.e. mainly cost for efficient use of reactors etc.) small amounts of dirty structures may still be contained although not deliberately being made.

Preferably at least one monomer in the polymer stems from the use of ethylene oxide.

In another embodiment, more than one alkylene oxide monomer is comprised in the structure of the polymer-subunit (A1); in such case the polymer backbone is a random copolymer, a block copolymer or a copolymer comprising mixed structures of block units (with each block being a homo-block or a random block itself) and statistical/random parts comprised of two or more alkylene oxides, with one of the monomers being ethylene oxide. Preferably the further monomer beside ethylene oxide is propylene oxide (PO) and/or 1,2-butylene oxide (BO), preferably only 1,2-propylene oxide.

The sub-unit (a2) is made from at least one lactone and/or at least one hydroxy acid.

The at least one lactone and/or hydroxy acid is/are selected from the groups i) and/or ii), with
i) lactone(s), i.e. cyclic esters, starting with α-lactone (three ring atoms) followed by β-lactone (four ring atoms), γ-lactone (five ring atoms) and so on; such lactones preferably being β-propiolactone, g-butyrolactone, δ-valerolactone, g-valerolactone, e-caprolactone, d-decalactone, g-decalactone, e-decalactone; preferably caprolactone;
   and
ii) hydroxy acid(s), which may be derived from any lactone by hydrolyzation, specifically from any lactone within group i) before, specifically an α-, β- or γ-hydroxy acid derived from the corresponding lactone by hydrolyzation, and lactic acid, glycolic acid, 4-hydroxybutanoic acid, 6-hydroxy hexanoic acid, 12-hydroxy stearic acid, citric acid; preferably lactic acid or caprolactone, more preferably caprolactone.

The sub-units (a1) and (a2) may be combined in any order depending on how the starting material are employed and depending on the relative amounts.

As a result, the polymer backbone (A) obtained from the reaction of (a1) and (a2) can be defined in a very broad range by selecting the desired sub-units (a1) and (a2), and—within sub-unit (a1) by selecting the number of different alkylene oxides, their relative amounts, their reaction order etc, and of course also for (a2) by selecting the compounds, their relative amounts etc., in such way
1) to obtain first defined (a1)-subunits which are then reacted with (a2)-sub units,
2) to directly react monomeric alkylene oxides from sub-unit (a1) with monomeric sub-units (a2); or
3) to combine approach 1) and 2) before.

Hence, three principal backbone-structures can be defined and obtained:

### (A1):

sub-units (a2) can be added during alkylene oxide polymerization (a1-units) yielding random copolymers; in a variation thereof, polyalkylene oxides having two hydroxy-groups can be added to such polymerisation thus introducing specific (a1)-sub-unit-blocks; this variation is useful if the alkylene oxides employed are at least partially different to the alkylene oxides employed for preparing the polyalkylene oxide also employed or if the structure of the polyalkylene oxide (i.e. the order of the alkylene oxide-units therein) is different to what is obtained by reacting the at least one alkylene oxide employed for the co-polymerisation with (a2)-sub-unit and the polyalkylene oxide.

In a simplifying approach this (A1)-backbone can be described as a randomly arranged order of (a1)-sub-units and (a2)-sub-units. Depending on the relative amount of (a1) to (a2) and their reactivity the block length of the (a1) and the (a2) is varied.

Structures like the one shown below can be obtained by this approach:
Poly [random-{lactone}-{alkylene oxide}]
   (“oligo/poly lactone” depicts the (a2)-sub-unit, thus made from lactone(s)/hydroxy acid(s); “PAG”=polyalkylene glycol is used here to depict the (a1)-sub-unit)

Hence, in one preferred embodiment, the polymer backbone is selected from (A1) a backbone consisting of a randomly arranged order of monomeric, oligomeric and/or polymeric (a1)-sub-units and monomeric, oligomeric and/or polymeric (a2)-sub-units, with more than one sub-unit (a1) and/or more than one sub-unit (a2) being present.

### (A2):

sub-units (a2) can be oligomerized/polymerized first and the co-polymerized with at least one alkylene oxide yielding mixed random/block structures; depending on the degree of oligomerization of the lactone/hydroxy-acid and if still monomeric lactone/hydroxy acid is present when the alkylene oxide(s) is/are added, the structure can be further varied by tuning the amount and length of (a2)-sub-unit-chains within the (A2)-backbone.

As with (A1), in a further variation thereof, also polyalkylene oxides having two hydroxy-groups can be added to such polymerisation thus also introducing specific (a1)-sub-unit-blocks; this variation is useful if the alkylene oxides employed are at least partially different to the alkylene oxides employed for preparing the polyalkylene oxide also employed or if the structure of the polyalkylene oxide (i.e. the order of the alkylene oxide-units therein) is different to what is obtained by reacting the at least one alkylene oxide employed for the co-polymerisation with (a2)-sub-unit and the polyalkylene oxide.

In a simplifying approach, this (A2)-backbone can be described as a tri-block-polymer with an inner (a2)-block and two outer (a1)-blocks.

(Switching the order to the opposite leads to structure (A3); see below.)

Structures like the one shown below (in its most simple version) can be obtained by this approach:
[PAG]-[oligo/poly lactone]-[PAG]
   (“lactone” is used here to denote the (a2)-sub-units, thus made from lactone(s)/hydroxy acid(s) and can be single monomeric units or oligo- or polymeric units made from monomers in a first reaction step; “PAG”=polyalkylene glycol is used here to depict the (a1)-sub-unit)

In case the (a2)-sub-unit-starting material has not completely reacted when the alkylene oxide(s) are added, the structure will not be anymore a true tri-block structure, but will in addition contain further, shorter (a2)-units in the chains and thus consist of a multi-block-structure or even shift towards a mixture of block and random-structural arrangement.

Hence, the in one preferred embodiment the polymer backbone is selected from (A2) a backbone consisting of oligo- or polymerized sub-units (a2) as an inner block and two outer blocks of oligomeric and/or polymeric (a1)-sub-units, defined as “-[block of (a1)]-[block of (a2)]-[block of (a1)]-”, and also possibly comprising higher block-polymers such as 5-, 7- and 9-etc. blocks where at the outside of the tri-block structure further blocks of (a1) and (a2) are connected, such as a penta-block “[block of (a1)]-[block of (a2)]-[block of (a1)]-[block of (a2)]-[block of (a1)]-[block of (a2)]-[block of (a1)]” and so on.

### (A3):

sub-units (a2) can be added after alkylene oxide oligomerization or (almost complete) polymerization yielding block structures containing larger (a2)-chains and larger (a1)-chains; in case of complete polymerization of (a1) before addition of (a2) the structure resulting can be described as “(a2)-polyalkylene oxide-(a2)”; such structures can be also obtained by directly reacting polyalkylene oxides with (a2). By only oligomerizing the alkylene oxide(s) first and then reacting the mixtures containing alkylene-oxide(s)-oligomers and monomeric alkylene oxides with (a2) or by polymerizing (a2) with alkylene oxide(s) and with polyalkylene oxide(s) more complex structures can be obtained.

In a simplifying approach, this (A3)-backbone can be described as a tri-block-polymer with an inner (a1)-block and two outer (a2)-blocks:

(Switching the order to the opposite leads to structure (A2); see above.)
[oligo/poly lactone]-[PAG]-[oligo/poly lactone]
   (“oligo/poly lactone” depicts the (a2)-sub-unit, thus made from lactone(s)/hydroxy acid(s); “PAG”=polyalkylene glycol is used here to depict the (a1)-sub-unit)

Hence, in one preferred embodiment, the polymer backbone is selected from (A3) a backbone consisting of and inner block of oligomeric and/or polymeric (a1)-sub-units and two outer blocks of oligo- or polymeric sub-units (a2), in the form of at least an tri-block-polymer defined as “-[block of (a2)]-[block of (a1)]-[block of (a2)]-”.

Similarly as for case of (A2), in case the (a2)-sub-unit-starting material has not completely reacted, the structure will not be anymore a true tri-block structure, but will in addition contain further, shorter (a1)-units in the chains and thus consist of a multi-block-structure or even shift towards a mixture of block and random-structural arrangement.

### Similarities of (A1), (A2) and (A3)

The more unreacted species of (a2) (in case of (A2)-backbone) or the more unreacted species of (a1) (in case of (A3)-backbone) are present when the respective other sub-unit-species are added, the difference between (A2) and (A3) diminishes.

To the extreme, the result of that would be a true co-polymerization of sub-units (a1) and (a2) and thus would be similar or even identical also to (A1).

Hence, (A1), (A2) and (A3) are “just” extreme ends of the overall principle of co-polymerizing alkylene oxides, polyalkylene glycols and lactones/hydroxy acids in every thinkable order, ratio and variation of reaction times before adding the other starting materials.

Hence, in one preferred embodiment, the polymer backbone is selected from a backbone obtained by such overall principle of co-polymerizing alkylene oxides, polyalkylene glycols and lactones/hydroxy acids in every thinkable order, ratio and variation of reaction times before adding the other starting materials.

### (A4):

(A4) is a structure which starts from an oligo- or polymeric sub-unit (a1) which is end-capped on one side, preferably etherified with alcohols, more preferably short-chain alcohols C1 to C4. This one-sided end-capped oligo-/polymer of sub-unit (a1) is then thereafter reacted with at least one sub-unit (a2) and optionally at least one sub-unit (a1)—wherein the sub-unit (a1) may be different to that/those in the starter block or may be arranged in a different order compared to those in the starter block—to attach to the non-endcapped side of the starter block a new block comprising moieties from the sub-units employed for the (co-) polymerization, thereby obtaining a di-block-structure of
[end-cap]-[sub-unit(s) (a1)]-[sub-unit(s) (a2)], or
[end-cap]-[sub-unit(s) (a1)]-[random-{sub-unit(s) (a2)-sub unit(s) (a1)}].

It is to be emphasized that the oligo- or polymerization of sub-unit(s) (a1) and (a2) can each be effected with the use of “starter molecules”, which are then incorporated into the oligomers and polymers of sub-unit (a1) and (a2). Suitable starter molecules for such polycondensation reaction of lactones and hydroxy acids as well as alkylene oxides are known; such compounds comprise at least two hydroxy-groups accessible for condensation reaction, such asdiols like ethylene glycol, polyethylene glycol, propylene glycol, polypropylene glycol, ethylene oxide and propylene oxide block copolymers, 1,2- and 1,3-propane diol, 1,4-butane diol, 1,6-hexane diol, neopentyl glycol and the like. For the condensation of alkylene oxides also water is a suitable starter molecule.

Hence, the backbones (A1) to (A4) may comprise moieties derived from such starter molecule, specifically any one or more of water, ethylene glycol, polyethylene glycol, 1,2- and 1,3-propane diol, polypropylene glycol, ethylene oxide and propylene oxide block copolymers, 1,4-butane diol, 1,6-hexane diol, neopentyl glycol.

In case where a compound derived from alkylene oxides is used as starter molecule, such use is already described in the backbone definitions above, and thus such starter molecule derived from alkylene oxide can be added as a molecule or can—in case of oligomers or polymers of alkylene oxide(s)-prepared in a first reaction step, before sub-unit (a2) is added for condensation reaction. The use of starter molecules not derived from alkylene oxides however is also encompassed as an option in any of the embodiments herein for any of the backbones disclosed; preferably, such starter molecule is used for the preparation of any such backbone (A1), (A2) and (A3).

Typical reaction procedure to obtain such structures is, firstly, the formation of a oligo-/polyalkoxylate from a starter molecule by reaction with alkylene oxide(s) (i.e. sub-units (a1)), and then, secondly, further polycondensation reaction sub-unit(s) (a2) onto the polyalkoxylate. Both reactions can be carried out under typical reaction conditions for alkoxylation reactions (to abtain the oligo-/polyalkoxylate) and for polymerization of sub-unit (a2).

The polymerization of sub-unit(s) (a2) is carried out in a known way with various catalysts like transesterification catalysts tin (II) alkanoates.

The alkoxylation of such oligo-/poly-[sub-unit(s) (a2)] is done under typical, known alkoxylation conditions. Due to basic reaction conditions for the alkoxylation, transesterification reaction at ester bonds from oligo-/poly-[sub-unit(s) (a2)] can occur and thus lead to compounds having a mixed random/block structures.

In a preferred embodiment, the polymer backbone as a graft base comprises at least one sub-unit (a1) and at least one sub-unit (a2), wherein
(a1) is a unit comprising, preferably essentially consisting of, moieties derived from at least one alkylene oxide monomer and/or at least one polyalkylene oxide-polymer having two hydroxy-end-groups, the alkylene oxide monomer selected from the group of C2- to C10-alkylene oxides, preferably C2 to C5-alkylene oxides,
(a2) is a unit comprising, preferably consisting of, at least one lactone and/or at least one hydroxy acid, such sub-unit (a2) being a moiety derived from a single lactone and/or hydroxy-acid or being oligo-or-polymeric units consisting of at least one type of lactone and/or at least one type of hydroxy acid,
   wherein preferably the at least one lactone and/or hydroxy acid is/are selected from the groups i) and/or ii), with
i) lactone(s), i.e. cyclic esters, starting with α-lactone (three ring atoms) followed by β-lactone (four ring atoms), γ-lactone (five ring atoms) and so on; such lactones preferably being β-propiolactone, g-butyrolactone, O-valerolactone, g-valerolactone, e-caprolactone, d-decalactone, g-decalactone, e-decalactone; preferably caprolactone; and
ii) hydroxy acid(s), which may be derived from any lactone by hydrolyzation, specifically from any lactone within group i) before, specifically an α-, β- or γ-hydroxy acid derived from the corresponding lactone by hydrolyzation, and lactic acid, glycolic acid, 4-hydroxybutanoic acid, 6-hydroxy hexanoic acid, 12-hydroxy stearic acid, citric acid; preferably lactic acid or caprolactone, more preferably caprolactone,
wherein the polymer backbone is obtained
(A1) by co-polymerization of at least one sub-unit (a1) and at least one sub-unit (a2), wherein optionally at least one oligomer or polymer made from at least one sub-unit (a1) or at least one sub-unit (a2) can be employed within the copolymerization of at least one sub-unit (a1) and at least one sub-unit (a2) as well;
(A2) by first oligo-/polymerizing sub-unit(s) (a2) and then polymerizing the product with sub-unit(s) (a1); or
(A3) By first oligo-/polymerizing sub-unit(s) (a1) and then co-polymerizing the product with sub-unit(s) (a2);
(A4) by first providing an oligo- or polymeric sub-unit (a1) which is bears an end-cap on one side, preferably is etherified with alcohols, more preferably short-chain alcohols C1 to C4, which—as starter-block—is thereafter reacted with at least one sub-unit (a2) and optionally at least one sub-unit (a1)—wherein the sub-unit (a1) may be different to that/those in the starter block or may be arranged in a different order compared to those in the starter block—to attach to the non-end capped side of the starter block a new block comprising moieties from the sub-units employed for the (co-) polymerization, thereby obtaining a di-block-structure of [end-cap]-[sub-unit(s) (a1)]-[sub-unit(s) (a2)], or [end-cap]-[sub-unit(s) (a1)]-[random-{sub-unit(s) (a2)-sub unit(s) (a1)}];
   wherein in case more than one sub-unit (a1) and/or more than one sub-unit (a2) are present already in an employed oligomer or polymer, those sub-units can be arranged in any order within such employed oligomer or polymer, and
   wherein in case more than one sub-unit (a1) and/or more than one sub-unit (a2) are present for the polymerization, those sub-units (and the optional oligomer/polymers if employed) can be arranged in any order within the obtained backbone,
   and wherein—optionally—at least one starter molecule is included in the backbone structure The polymer backbone (A) and specifically (A1), (A2) and (A3), may be optionally capped at the end groups, the capping is done by C1 C25 alkyl groups using known techniques, preferably C1 to C4-groups. Such capping will be done after the production of the backbones and may be done preferably prior to the grafting.

In case of (A4), the capping on one end-group is either to be done prior to the condensation polymerization with sub-unit(s) (a1) and/or sub-unit(s) (a2), as only then a structure (A4) can be obtained. In another, more preferred approach, the production of the (A4) starts with a mono-alcohol, which is then reacted with alkylene oxide(s) to obtain the “mono-end-capped” oligo/polymer of sub-unit (a1) (bearing one hydroxy-group at the oligo/poly alkylene oxide-chain end), which is then reacted with sub-unit(s) (a2) to obtain (A4).

When preparing the oligo-/poly-alkylene oxide as a starting block, a diol may be used as a starter molecule for preparing this oligo/poly alkylene oxide, thus such oligo-/polymer of sub unit (a1) may contain in its structure a moiety derived from such diol. Diols for such use and methods to prepare such oligo/poly alkylene oxide comprising diols in their structure are known. Typical diols are ethylene glycol, propylene glycol etc. All of the commonly known diols can in principle be used for such purpose.

In another preferred embodiment, the polymer backbone as a graft base comprises at least one sub-unit (a1) and at least one sub-unit (a2), wherein
(a1) is a unit comprising, preferably essentially consisting of, moieties derived from at least one alkylene oxide monomer and/or at least one polyalkylene oxide-polymer having two hydroxy-end-groups, the alkylene oxide monomer selected from the group of C2- to C10-alkylene oxides, preferably C2 to C5-alkylene oxides,
(a2) is a unit comprising, preferably consisting of, at least one lactone and/or at least one hydroxy acid, such sub-unit (a2) being a moiety derived from a single lactone and/or hydroxy-acid or being oligo-or-polymeric units consisting of at least one type of lactone and/or at least one type of hydroxy acid,
wherein preferably the at least one lactone and/or hydroxy acid is/are selected from the groups i) and/or ii), with
i) lactone(s), i.e. cyclic esters, starting with α-lactone (three ring atoms) followed by β-lactone (four ring atoms), γ-lactone (five ring atoms) and so on; such lactones preferably being β-propiolactone, g-butyrolactone, δ-valerolactone, g-valerolactone, e-caprolactone, d-decalactone, g-decalactone, e-decalactone; preferably caprolactone;
and
ii) hydroxy acid(s), which may be derived from any lactone by hydrolyzation, specifically from any lactone within group i) before, specifically an α-, β- or γ-hydroxy acid derived from the corresponding lactone by hydrolyzation, and lactic acid, glycolic acid, 4-hydroxybutanoic acid, 6-hydroxy hexanoic acid, 12-hydroxy stearic acid, citric acid;
preferably lactic acid or caprolactone, more preferably caprolactone,
wherein the polymer backbone as a graft base (A) is selected from
(A1) a backbone consisting of a randomly arranged order of monomeric, oligomeric and/or polymeric (a1)-sub-units and monomeric, oligomeric and/or polymeric (a2)-sub-units, with more than one sub-unit (a1) and/or more than one sub-unit (a2) being present;
(A2) a backbone consisting of oligo- or polymerized sub-units (a2) as an inner block and two outer blocks of oligomeric and/or polymeric (a1)-sub-units, defined as “-[block of (a1)]-[block of (a2)]-[block of (a1)]-”, and also possibly comprising higher block-polymers such as 5-, 7- and 9-etc. blocks where at the outside of the tri-block structure further blocks of (a1) and (a2) are connected, such as a penta-block “[block of (a1)]-[block of (a2)]-[block of (a1)]-[block of (a2)]-[block of (a1)]-[block of (a2)]-[block of (a1)]” and so on; and
(A3) a backbone consisting of and inner block of oligomeric and/or polymeric (a1)-sub-units and two outer blocks of oligo- or polymeric sub-units (a2), in the form of at least an tri-block-polymer defined as “-[block of (a2)]-[block of (a1)]-[block of (a2)]-”, (A4) a backbone consisting of a first block with
(i) on one end an end-cap-such end-cap being a C1 to C18-, preferably C1-C4-alkyl-group attached to said first block via an ether-function; and
(ii) an oligo- or polymeric sub-unit (a1); and
a second block which is attached to said first block at the opposite end of said first block (“opposite” in relation to the end-cap on said first block) via an ether or ester-function, said second block being composed of at least one sub-unit (a2) and optionally at least one sub-unit (a1),
wherein the optional sub-unit(s) (a1) in said second block may be different to that/those in the first block or may be arranged in a different order compared to those in the first block, and the order of the sub-unit(s) (A1) and (a2) may be also in any order, including random structure,
such di-block-structure having as an idealized structure in case of using only sub-unit(s) (a2) for the second block: [end-cap]-[sub-unit(s) (a1)]-[sub-unit(s) (a2)] or in case of using sub-unit(s) (a1) and (a2) for the second block:
[end-cap]-[sub-unit(s) (a1)]-[random-{sub-unit(s) (a2)-sub unit(s) (a1)}.

In a preferred embodiment the polymer backbones (A), and specifically (A1), (A2) and (A3), are not capped but bear hydroxy-groups at the chain ends.

Preferably, the polyalkoxylate-ester backbone comprises moieties derived from
(i) alkylene oxides (AO) comprising at least one of ethylene oxide (EO), propylene oxide (PO), and butylene oxide (BO), preferably at least one of EO and PO,
with the AO in an amount of from 40 to 95, preferably up to 90, and preferably from 50, more preferably from 60, and even more preferably from 70 wt %, and any number and range in between, each based on the total weight of the backbone, the amount of EO being of from 0 to 100 wt. %, preferably from 10, more preferably from 20, even more preferably from 30, even more preferably from 40, such as from 50, 60, 70, 80 or even from 90 wt %, based on total AO,
   the PO and/or BO, in an total amount of each from 0 to 100 wt. %, preferably up to 90, more preferably up to 80, even more preferably up to 70, even more preferably up to 60, and most preferably up to 50, and any number in between such as up to 5, 10, 15, 25, 30, 35, 40, 45, 55, 65, 75, 85 or up to 95, and more preferably from 10, even more preferably from 20, even further more preferably from 30, such as from 40, 50, 60, 70, 80 or even from 90 wt %, each based on the total weight of AO, with the total amount of PO and BO adding up to 100 wt. % for the sum of PO and BO,
   with the total amount of AO adding up to 100 wt. %;
(ii) lactone/hydroxy acid monomer in an amount of from 1 and up to 60, preferably up to 50, more preferably up to 40, most preferably up to 30 wt. %, and preferably from 2, more preferably from 3, even more preferably from 4 and most preferably from 5 wt. %, each based on the total weight of the backbone, preferably only caprolactone;

With the total weight of the sum of sub-units (a1) and sub-units (a2) in the backbone (A) adding up to 100 wt %.

More preferably, the amount of EO is at least 80 wt %, preferably at least about 85, more preferably at least about 90, even more preferably at least about 95%, and most preferably about 100 wt. % based on total AO; the amount of PO and/or BO is each from about 0 to 50 wt. % based on the total weight of AO, more preferably at most about 30, even more preferably at most about 20%, even more preferably about 10, and most preferably about 0 wt. %, each based on total AO; in a more preferred embodiment, the amounts for PO and BO given in this paragraph before are the total amounts for the sum of PO and BO. In an even more preferred embodiment, the backbone-unit (a1) is made from ethylene oxide only. In an alternative but preferred embodiment, at least two different alkylene oxides are employed for the preparation of the backbone/are present in the backbone.

Hence, in one more preferred embodiment, the polymer backbone consists of
(i) alkylene oxides (AO) being selected from ethylene oxide (EO), propylene oxide (PO), and butylene oxide (BO), preferably only EO and PO, the amount of EO being of from 10 to 90, preferably 20 to 80, more preferably 30 to 70, and most preferably 40 to 60 wt %, based on total AO, the total amount of PO and BO being from 10 to 90, preferably 20 to 80, more preferably 30 to 70, and most preferably 40 to 60 wt %, each based on the total weight of AO, with the total amount of PO and BO adding up to 100 wt. % for the sum of PO and BO, and
   with the total amount of AO adding up to 100 wt. %;
(ii) lactone/hydroxy acid monomer in an amount of from 1 and up to 60, preferably up to 40, more preferably up to 30, even more preferably up to 25, even further more preferably up to 20, and most preferably up to 15 wt. %, and preferably from 2, more preferably from 3, even more preferably from 4 and most preferably from 5 wt. %, each based on the total weight of the backbone, preferably only caprolactone;
   with the total weight of the sum of sub-units (a1) and sub-units (a2) in the backbone (A) adding up to 100 wt %,
   and wherein in case of (A1), (A2) and (A3) the use of a starter molecule is optional.

Hence, in one more preferred, alternative embodiment, the polymer backbone consists of
(i) alkylene oxides (AO) is selected from ethylene oxide (EO), propylene oxide (PO), and butylene oxide (BO), preferably only EO and PO, more preferably only EO
   the amount of EO being of from 20 to 100 wt %, based on total AO,
   the total amount of PO and BO being from 0 to 80 wt. %, preferably up to 50, more preferably up to 30, even more preferably up to 20, and even further preferably up to 10, and most preferably zero, such as 45, 45, 45, 25, 15, 7 and 5, and any number in between, each based on the total weight of AO, with the total amount of PO and BO adding up to 100 wt. % for the sum of PO and BO,
   with the total amount of AO adding up to 100 wt. %;
(ii) lactone/hydroxy acid monomer in an amount of from 5 and up to 50, preferably up to 40, more preferably up to 35, and even more preferably up to 30, and as lower limit preferably from 7, more preferably from 10, even more preferably from 12 wt %, and most preferably from 15, such as 6, 8, 9, 11, 12, 13, 14 and 15 and any number in between as lower limit and such as 30, 33, 37, 45 and any number in between as upper limit, based on the total weight of the backbone, preferably only caprolactone;
with the total weight of the sum of sub-units (a1) and sub-units (a2) in the backbone (A) adding up to 100 wt %,
and wherein in case of (A1), (A2) and (A3) the use of a starter molecule is optional.

In an even more preferred embodiment, the backbone for any of the embodiments of the inventive graft polymer as defined herein is a structure chosen from the structures (A1), (A2), (A3) and/or (A4).

### Second Structural Unit (Grafted Side Chains)

The second structural unit of the graft polymer are polymeric side chains (B), which are grafted onto the polymer backbone (A), wherein said polymeric sidechains (B) are obtainable by (co-) polymerization of at least one vinyl ester monomer (B1), at least one, preferably at least two nitrogen-containing monomer (B2), optionally further monomer(s) (B3), and optionally further monomers besides (B1), (B2) and (B3).

As vinyl ester monomer (B1), at least one of vinyl acetate, vinyl propionate and/or vinyl laurate is selected. Besides those, further vinyl ester monomers (B1) may be employed which are known to a person skilled in the art as C4 to C16-vinylesters, such as vinyl valerate, vinyl pivalate, vinyl neodecanoate, vinyl decanoate and/or vinyl benzoate.

As monomer (B2) at least one, preferably at least two nitrogen-containing monomer(s) are selected from the group consisting of vinyllactames, vinyl imidazoles, 1-vinyltriazole, 4-vinylpyridine, 4-vinylpyridine-N-oxide, 2-vinylpyridine, 1-vinyloxazolidinone, N-vinylformamide, N-vinylacetamide, N-vinyl-N-methylacetamide, and acrylamides such as acrylamide, methacrylamide, N-alkyl-substituted acrylamides, N,N′-di alkyl (meth) acrylamide; mono- and dialkylamino-alkyl-(meth)acrylates; preferred are vinyllactame-monomer and/or a vinylimidazole-monomer; the vinyllactame being more preferably selected from N-vinyllactams, such as N-vinylpyrrolidone, N-vinylpiperidone, N-vinylcaprolactam, even more preferably N-vinylpyrrolidone, N-vinylcaprolactam, and most preferably N-vinylpyrrolidone; the vinylimidazole being preferably N-vinyl imidazole, 2-methyl-1-imidazole, more preferably N-vinyl imidazole.

Preferably, at least two monomers (B2) are employed as (B2a) and (B2b), with
(B2a) being at least one monomer selected from vinylimidazole-monomers, being preferably N-vinyl imidazole, 2-methyl-1-imidazole, more preferably N-vinyl imidazole; and
(B2b) being at least one monomer selected from vinyllactame-monomers, more preferably selected from N-vinyllactams, such as N-vinylpyrrolidone, N-vinylpiperidone, N-vinylcaprolactam, even more preferably N-vinylpyrrolidone, N-vinylcaprolactam, and most preferably N-vinylpyrrolidone.

Further monomers (B3) may be employed as optional monomers, such monomers being different to (B1) and (B2) and being present only in an amount of preferably less than 10% of the total amount of monomers employed for obtaining the polymeric sidechains (B), and are more preferably present only as impurities but not deliberately added for polymerization. (B3) monomers may be in principle any monomer polymerizable with (B1) and (B2), preferably at least one monomer of 1-vinyl oxazolidinone and other vinyl oxazolidinones, 4-vinyl pyridine-N-oxide, N-vinyl formamide and its amine if hydrolyzed after polymerization, N-vinyl acetamide, N-vinyl-N-methyl acetamide, alkyl esters of (meth)acrylic acid.

More preferably, (B3) is present only in an amount of less than 2% of the total amount of monomers employed for obtaining the polymeric sidechains (B), and is preferably present only as impurities but not deliberately added for polymerization, and most preferably is not present at all.

Besides monomers (B1), (B2) and (B3) at least one further monomer, being different from those before, may optionally be present for the co-polymerization to yield the side chains (B), wherein such further monomer is present only in an amount of less than 2% of the total amount of monomers employed for obtaining the polymeric sidechains (B), and is preferably present only as impurities but not deliberately added for polymerization, and most preferably is not present at all.

The amounts of monomers in the graft polymer are preferably as follows:
(B) is 10 to 40%, more preferably 15 to 35 and most preferably 15 to 30%;
(B1) (vinylester) in weight percent being based on the total WEIGHT OF THE GRAFT POLYMER is
   from 0 to 20%, preferably up to 15, more preferably up to 10, even more preferably up to 5%;
(B2) (nitrogen-containing monomer) in weight percent being based on the total WEIGHT OF THE GRAFT POLYMER is
   from 10 to 40%, preferably up to 35, more preferably up to 30, even more preferably up to from 25, and most preferably up to 20, and more preferably at least 15, and—more preferably—
(B2a) vinyl imidazole-monomer, preferably N-vinylimidazole, is from 20 to 80, preferably from 30 to 70, most preferably from 40 to 60%, each in weight percent based on total weight of (B2); and
(B2b) vinyl lactame-monomer, preferably N-vinylpyrrolidone, is equal to [the total amount of (B2) minus (B2a)];

And further provided that (B3) (further monomer) is from 0 to 5, preferably at most 2, more preferably at most 1, even more preferably about 0 based on the total WEIGHT OF THE GRAFT POLYMER, but in all cases at most 10 wt. % of the amount of (B2).

The amount of further monomer(s) besides (B1), (B2) and (B3) is as detailed before.

In a more preferred embodiment, the monomers in the graft polymer are as follows:
(B) is 15 to 30% based on total weight of the graft polymer; and the monomers are:
(B1) (vinylester) is not present
(B2) (nitrogen-containing monomer) is 15 to 30% based on total weight of the graft polymer
(B2a) N-vinylimidazole, is from 40 to 60%, in weight percent based on total weight of (B2); and
(B2b) N-vinylpyrrolidone, is equal to [the total amount of (B2) minus (B2a)];
(B3) and further monomers being essentially not present.

In a more preferred, alternative embodiment to the one before, the monomers in the graft polymer are as follows:
(B) is 15 to 30%; and the monomers are:
(B1) being vinyl acetate, from 5 to 10% in weight percent being based on the total WEIGHT OF THE GRAFT POLYMER;
(B2) (nitrogen-containing monomer) in weight percent being based on the total WEIGHT OF THE GRAFT POLYMER is from 10 to 25%, with
(B2a) being N-vinylimidazole, is from 40 to 60%, in weight percent based on total weight of (B2); and
(B2b) vinyl lactame-monomer, preferably N-vinylpyrrolidone, is equal to [the total amount of (B2) minus (B2a)];
(B3) and further monomers being essentially not present.

In an alternative embodiment, at least one vinylimidazole, preferably N-vinylimidazole, as monomer (B2a) is present besides at least one monomer (B1), with monomer (B1) being preferably comprising vinyl acetate, and even more preferably being only vinyl acetate. Even more preferably, vinyl acetate is the only monomer (B1) and N-vinylimidazole is the only monomer (B2).

In another embodiment, the monomer (B1) may be partially or fully hydrolyzed after the polymerization reaction. In a preferred embodiment thereof, monomer (B1) is partially hydrolyzed, and is even more preferably hydrolyzed to up to 80, 70 or 60, 50, 40, 30, 20 or 10 mole percent based on the total amount of monomer(s) (B1). In a more preferred embodiment, the vinyl esters are not hydrolyzed at all.

It is to be understood that the amounts for (A), (B), (B1), (B2), (B2a), (B2b), (B3) and further monomers besides the ones before may be selected from the various detailed ranges given independently, i.e. lower and upper borders may be combined also from two different ranges given for one aspect to result in a numerical range not specified explicitly in numbers, such combined range for e.g. (A), (B), (B1), (B2), (B2a), (B2b), and (B3) however being explicitly intended to be encompassed by this present intention.

Also, broad ranges and very particularly preferred narrow ranges may be combined in one embodiment of this invention, with the selection of the ranges for one component being chosen independently of that for the other component, in as far as the overall numbers add up to a “100%-polymer”: e.g. the most preferred range for (A) and (B) may be chosen and combined with the broadest possible ranges given for (B1)/(B2)/(B2a)/(B2b)/(B3), and any other possible combination.

Preferably, for all selections possible to be made for (A)/(B) and (B1)/(B2)/(B2a)/(B2b)/(B3)), the same selections are to be made, e.g. all “preferred” ranges are chosen, or—more preferably—all “more preferred” ranges are chosen, or—most preferably—all “most preferable” ranges are chosen.

The inventive graft polymer as detailed before has a polydispersity (PDI) Mw/Mn of at most 10, preferably at most 5, more preferably at most 3, and most preferably in the range from 1.0 to 2.6, and any number a as upper or lower limit and any range in between such as 1,3 to 2,6, 1 to 3 etc. (with Mw=weight average molecular weight in g/mol, and Mn=number average molecular weight in g/mol; with the PDI being unitless), with lower numbers being preferred, but depending on the Mn of the polymer backbone employed (the higher the Mn of (A) also typically the higher the PDI) and also on the amount of (B) (the higher the amount of (B) relative to the amount of (A) typically the higher the PDI).

The respective values of Mw and Mn can be determined using GPC standard methods, such as the one referenced in the experimental section. However, the molecular weights of the backbones used in this invention can also be calculated, as those reactions proceed basically to completeness. Hence, the calculation of the molecular weights based on the total molar amounts of ingredients employed for the preparation reaction is a viable way as well.

The graft polymers of the invention may contain a certain amount of ungrafted polymers (“ungrafted side chains”) made of monomers not being reacted with (i.e. grafted (on-) to) the polymer backbone.

The amount of such ungrafted polymers may be high or low, depending on the reaction conditions, but is preferably to be lowered and thus is more preferably low. By this lowering, the amount of grafted side chains is preferably increased. Such lowering can be achieved by suitable reaction conditions, such as dosing of monomers and radical initiator and their relative amounts and also in relation to the amount of backbone being present. Such adjustment is in principle known to a person of skill in the present field, and detailed hereinafter for this present invention within the description of a process to obtain the inventive graft polymers.

It has been found that the inventive graft polymers as detailed herein before exhibit an improved bio-degradability which is at least 35, more preferably at least 40, even more preferably at least 50, such as 41, 42, 43, 44, 45 etc., 51, 52, 53 etc, 55, 60, 65, etc. and any number in between and up to 100%, within 28 days when tested under OECD 301F.

The ratios of (A) to (B) for the embodiments herein are:
(A) 20 to 95%, preferably 50 to 90%, more preferably 60 to 90%, even more preferably 65 to 85%, most preferably 70 bis 85% of a polymer backbone as a graft base, and
(B) 5 to 80%, preferably 10 to 50%, more preferably 10 to 40%, even more preferably 15 to 35 and most preferably 15 to 30%, of polymeric sidechains (B) grafted onto the polymer backbone (A),
   with each percentage being on the total weight of the graft polymer, and the total of (A) plus (B) being 100 wt. %.

Any and each of the sub-units (a1), (a2), the polymer backbones as graft bases (A), (A1), (A2), (A3) and (A4) as defined by their structure or their preparation, and the monomers (B), (B1), (B2), (B2a), (B2b), (B3), and further monomers besides (B1), (B2), (B2a), (B2b), (B3) are the ones as defined herein and specifically those defined before in all of their embodiments, preferred embodiment etc, and in the examples; any such embodiment for the sub-units (a1), (a2), the polymer backbones as graft bases (A), (A1), (A2), (A3) and (A4) as defined by their structure or their preparation, and the monomers (B), (B1), (B2), (B3), and further monomers besides (B1), (B2), (B2a), (B2b), (B3) may be chosen individually and combined, provided that such selection is possible and not ruled out herein, i.e. the totals need to add up as required and the embodiments are compatible (i.e. an embodiment requiring (B2) obviously not be combined with an embodiment requiring the absence of (B).

Thus, in a preferred embodiment of the invention, the graft polymer is characterized by:
(A) 20 to 95%, preferably 50 to 90%, more preferably 60 to 90%, even more preferably 65 to 85%, most preferably 70 bis 85% of a polymer backbone as a graft base, which comprises at least one sub-unit (a1) and at least one sub-unit (a2), wherein
   (a1) is a unit comprising, preferably essentially consisting of, moieties derived from at least one alkylene oxide monomer and/or at least one polyalkylene oxide-polymer having two hydroxy-end-groups, the alkylene oxide monomer selected from the group of C2- to C10-alkylene oxides, preferably C2 to C5-alkylene oxides,
   (a2) is a unit comprising, preferably consisting of, moieties derived from at least one lactone and/or at least one hydroxy acid, such sub-unit (a2) being a moiety derived from a single lactone and/or hydroxy-acid or being oligo-or-polymeric units consisting of at least one type of lactone and/or at least one type of hydroxy acid,
      wherein preferably the at least one lactone and/or hydroxy acid is/are selected from the groups i) and/or ii), with
      i) lactone(s), i.e. cyclic esters, starting with α-lactone (three ring atoms) followed by β-lactone (four ring atoms), γ-lactone (five ring atoms) and so on; such lactones preferably being β-propiolactone, g-butyrolactone, δ-valerolactone, g-valerolactone, e-caprolactone, d-decalactone, g-decalactone, e-decalactone; preferably caprolactone;
      and
      ii) hydroxy acid(s), which may be derived from any lactone by hydrolyzation, specifically from any lactone within group i) before, specifically an α-, β- or γ-hydroxy acid derived from the corresponding lactone by hydrolyzation, and lactic acid, glycolic acid, 4-hydroxybutanoic acid, 6-hydroxy hexanoic acid, 12-hydroxy stearic acid, citric acid;
      preferably lactic acid or caprolactone, more preferably caprolactone,
   wherein the polymer backbone is
   a) obtained
   (A1) by co-polymerization of at least one sub-unit (a1) and at least one sub-unit (a2), wherein optionally at least one oligomer or polymer made from at least one sub-unit (a1) or at least one sub-unit (a2) can be employed within the copolymerization of at least one sub-unit (a1) and at least one sub-unit (a2) as well;
   (A2) by first oligo-/polymerizing sub-unit(s) (a2) and then polymerizing the product with sub-unit(s) (a1); or
   (A3) By first oligo-/polymerizing sub-unit(s) (a1) and then co-polymerizing the product with sub-unit(s) (a2);
   (A4) by first providing an oligo- or polymeric sub-unit (a1) which is bears an end-cap on one side, preferably is etherified with alcohols, more preferably short-chain alcohols C1 to C4, which—as starter-block—is thereafter reacted with at least one sub-unit (a2) and optionally at least one sub-unit (a1)—wherein the sub-unit (a1) may be different to that/those in the starter block or may be arranged in a different order compared to those in the starter block—to attach to the non-end capped side of the starter block a new block comprising moieties from the sub-units employed for the (co-) polymerization, thereby obtaining a di-block-structure of [end-cap]-[sub-unit(s) (a1)]-[sub-unit(s) (a2)], or [end-cap]-[sub-unit(s) (a1)]-[random-{sub-unit(s) (a2)-sub unit(s) (a1)}];
wherein in case more than one sub-unit (a1) and/or more than one sub-unit (a2) are present already in an employed oligomer or polymer, those sub-units can be arranged in any order within such employed oligomer or polymer, and
wherein in case more than one sub-unit (a1) and/or more than one sub-unit (a2) are present for the polymerization, those sub-units (and the optional oligomer/polymers if employed) can be arranged in any order within the obtained backbone;
and wherein in case of (A1), (A2) and (A3) the use of a starter molecule is optional; or
   b) selected from
   (A1) a backbone consisting of a randomly arranged order of monomeric, oligomeric and/or polymeric (a1)-sub-units and monomeric, oligomeric and/or polymeric (a2)-sub-units, with more than one sub-unit (a1) and/or more than one sub-unit (a2) being present;
   (A2) a backbone consisting of oligo- or polymerized sub-units (a2) as an inner block and two outer blocks of oligomeric and/or polymeric (a1)-sub-units, defined as “-[block of (a1)]-[block of (a2)]-[block of (a1)]-”, and also possibly comprising higher block-polymers such as 5-, 7- and 9-etc. blocks where at the outside of the tri-block structure further blocks of (a1) and (a2) are connected, such as a penta-block “[block of (a1)]-[block of (a2)]-[block of (a1)]-[block of (a2)]-[block of (a1)]-[block of (a2)]-[block of (a1)]” and so on; and
   (A3) a backbone consisting of and inner block of oligomeric and/or polymeric (a1)-sub-units and two outer blocks of oligo- or polymeric sub-units (a2), in the form of at least an tri-block-polymer defined as “-[block of (a2)]-[block of (a1)]-[block of (a2)]-”,
   (A4) a backbone consisting of
      a first block with
      (i) on one end an end-cap-such end-cap being a C1 to C18-, preferably C1-C4-alkyl-group attached to said first block via an ether-function; and
      (ii) an oligo- or polymeric sub-unit (a1); and
      a second block which is attached to said first block at the opposite end of said first block (“opposite” in relation to the end-cap on said first block) via an ether or ester-function, said second block being composed of at least one sub-unit (a2) and optionally at least one sub-unit (a1), wherein the optional sub-unit(s) (a1) in said second block may be different to that/those in the first block or may be arranged in a different order compared to those in the first block, and the order of the sub-unit(s) (A1) and (a2) may be also in any order, including random structure,
      such di-block-structure having as an idealized structure in case of using only sub-unit(s) (a2) for the second block: [end-cap]-[sub-unit(s) (a1)]-[sub-unit(s) (a2)]
      or in case of using sub-unit(s) (a1) and (a2) for the second block:
      [end-cap]-[sub-unit(s) (a1)]-[random-{sub-unit(s) (a2)-sub unit(s) (a1)}];
   and wherein in case of (A1), (A2) and (A3) the use of a starter molecule is optional;
and
(B) 5 to 80%, preferably 10 to 50%, more preferably 10 to 40%, even more preferably 15 to 35 and most preferably 15 to 30%, of polymeric sidechains (B) grafted onto the polymer backbone (A), wherein said polymeric sidechains (B) are obtainable by (co-) polymerization of
(B1) optionally at least one vinyl ester, selected from vinyl acetate, vinyl propionate and/or vinyl laurate and any further vinylester known to a person skilled in the art, such as vinyl valerate, vinyl pivalate, vinyl neodecanoate, vinyl decanoate and/or vinyl benzoate;
(B2) at least one, preferably at least two nitrogen-containing monomer being selected from the group consisting of vinyllactames, vinyl imidazoles, 1-vinyltriazole, 4-vinylpyridine, 4-vinylpyridine-N-oxide, 2-vinylpyridine, 1-vinyloxazolidinone, N-vinylformamide, N-vinylacetamide, N-vinyl-N-methylacetamide, and acrylamides such as acrylamide, methacrylamide, N-alkyl-substituted acrylamides, N,N′-di alkyl (meth) acrylamide; mono- and dialkylamino-alkyl-(meth)acrylates, being preferably a vinyllactame-monomer and/or a vinylimidazole-monomer, the vinyllactam being more preferably selected from N-vinyllactams, such as N-vinylpyrrolidone, N-vinylpiperidone, N-vinylcaprolactam, even more preferably N-vinylpyrrolidone, N-vinylcaprolactam, and most preferably N-vinylpyrrolidone, and the vinylimidazole being preferably N-vinyl imidazole, 2-methyl-1-imidazole, more preferably N-vinyl imidazole;
optionally
(B3) at least one further monomer, such as any one or more of 1-vinyl oxazolidinone and other vinyl oxazolidinones, 4-vinyl pyridine-N-oxide, N-vinyl formamide and its amine if hydrolyzed after polymerization, N-vinyl acetamide, N-vinyl-N-methyl acetamide, alkyl esters of (meth)acrylic acid; and

Optionally
at least one further monomer, being different from those before, such other monomer being present only in an amount of less than 2% of the total amount of monomers employed for obtaining the polymeric sidechains (B), and are preferably present only as impurities but not deliberately added for polymerization
with all percentages as weight percent in relation to the total weight of the graft polymer,
and with the amounts of monomers being
(B1) (vinylester) in weight percent being based on the total WEIGHT OF THE GRAFT POLYMER is
from 0 to 20%, preferably up to 15, more preferably up to 10, even more preferably up to 5%;
(B2) (nitrogen-containing monomer) in weight percent being based on the total WEIGHT OF THE GRAFT POLYMER is
from 10 to 40%, preferably up to 35, more preferably up to 30, even more preferably up to from 25, and most preferably up to 20, and more preferably at least 15,
and—more preferably—
(B2a) vinyl imidazole-monomer, preferably N-vinylimidazole, is from 20 to 80, preferably from 30 to 70, most preferably from 40 to 60%, each in weight percent based on total weight of (B2); and
(B2b) vinyl lactame-monomer, preferably N-vinylpyrrolidone, is equal to [the total amount of (B2) minus (B2a)];
And further provided that (B3) (further monomer) is from 0 to 5, preferably at most 2, more preferably at most 1, even more preferably about 0 based on the total WEIGHT OF THE GRAFT POLYMER, but in all cases at most 10 wt. % of the amount of (B2).

In a more preferred embodiment, the graft polymer of the invention and/or as detailed before consists of:
(A) at least on polymer backbone as graft base, such graft bases being any of the previously defined polymer backbones in any of the embodiments, preferably any of (a1), (A2), (A3) and (A4) as previously defined,
   in the amounts defined in any of the embodiments herein,
   including the description, the examples, and the claims,
and
(B) polymeric sidechains (B) grafted onto the polymer backbone (A), wherein said polymeric sidechains (B) are obtainable by (co-) polymerization of optionally at least one vinyl ester monomer (B1), at least one, preferably at least two nitrogen-containing monomer(s) (B2), preferably at least one (B2a) and optionally also at least one (B2b), and optionally further monomer(s) (B3), and optionally further monomers besides (B1), (B2) and (B3),
   all such monomers being any of the monomers as defined in any of the embodiments herein,
   in the amounts defined in any of the embodiments herein,
   including the description, the examples, and the claims.

In one embodiment of the previous embodiment, the vinyl ester monomer is vinyl acetate as the only monomer (B1), and more preferably N-vinyl imidazole is the only monomer (B2a), and vinylpyrrolidone is the only monomer (B2b), and most preferably no other monomers (B3) and further monomers besides the previous ones are present, whereas in an alternative embodiment of the previous embodiment, the no vinyl ester monomer is present, and N-vinyl imidazole is the only monomer (B2a), and vinylpyrrolidone is the only monomer (B2b), and most preferably no other monomers (B3) and further monomers besides the previous ones are present.

Inventive polymers have preferably at least one of the following additional properties, preferably two or more, to be more successfully employed in the various fields of applications targeted with this present invention:
i) the polymer backbone (A) may bear as the end-groups two hydroxy-groups or may be capped on both ends with C1 to C22-alkyl groups, preferably C1 to C4 alkyl groups;
ii) the graft polymer has a polydispersity (PDI) Mw/Mn of at most 10, preferably at most 5, more preferably at most 3, and most preferably in the range from 1.0 to 2.6, and any number a as upper or lower limit and any range in between such as 1,3 to 2,6, 1 to 3 etc. (with Mw=weight average molecular weight and Mn=number average molecular weight [g/mol/g/mol]);
iii) the biodegradability of the graft polymer is at least 35, more preferably at least 40, even more preferably at least 45, even further more preferably at least 50, such as 46, 47, 48, 49, 50, 55, 60, 65, 70, 75 etc. and any number in between and up to 100%, within 28 days, when tested under OECD 301F.

Further, the graft polymer is preferably water-soluble to a certain extent, to be able to employ the polymers within the aqueous environment typically present in the fields of applications as generally targeted with this present invention. Preferably inventive polymers should exhibit a medium to good, more preferably a good solubility in the environment of an aqueous formulation as typically employed in such fields for the various kinds of formulations, e.g. fabric cleaning and fabric care formulations etc.

Further, the graft polymer solution preferably has a viscosity that at reasonably high solid concentrations of the polymer as to be handled in and after production and to be provided to the user, which could be e.g. as a “pure” (then typically liquid) product, dissolved in a solvent, typically an aqueous solution containing water and organic solvents, only water or only organic solvents, the viscosity of such polymer or polymer solution being in a range that allows typical technical process steps such as pouring, pumping, dosing etc. Hence, the viscosities should be preferably in a range of about up to less than 4000 mPas, more preferably up to 3500 mPas, even more preferably up to 3000 mPas, such as up to 4500, 3750, 3250, 2750 or even 2600 or below such as 2500, 2000, 1750, 1500, 1250, 1000, 750, 500, 250, 200, 150, or 100 mPas, at concentrations of the polymer (based on the total solid content of the polymer in solution, as defined by weight percent of the dry polymer within the total weight of the polymer solution) of preferably at least 10 wt. %, more preferably at least 20, and even more preferably at least 40 wt. %, and most preferably at least 50 wt. %, such as at least 60, 70, 80 or even 90 wt. %. The viscosity may be measured at either 25° C. or at elevated temperature, e.g. temperatures of 50 or even 60° C. By this a suitable handling of the polymer solutions in commercial scales is possible. It is of course evident that depending on the amount of solvent being added the viscosity is lower when the amount of solvent increases and vice versa, thus allowing for adjustment in case desired. It is also evident that the viscosity being measured depends on the temperature at which it is being measured, e.g. the viscosity of a given polymer with a given solid content of e.g. 80 wt. % will be higher when measured at lower temperature and lower when measured at a higher temperature. In a preferred embodiment the solid content is in between 70 and 99 wt. %, more preferably in between 75 and 85 wt. %, with no additional solvent being added but the polymer as prepared. In a more preferred embodiment, the solid content is in between 70 and 99 wt. %, more preferably in between 75 and 95 wt. %, with no additional solvent being added but the polymer as prepared, and the viscosity is lower than 3000 mPas, more preferably 3250, or even below 2750, 2600, 2500, 2000, 1750, 1500, 1250, 1000, 750, 500 or even 250 mPas, when measured at 60° C. The viscosity may be determined as generally known for such polymers, preferably as described below in the experimental part.

As further criteria, of course, the individual performance of a specific polymer needs to be evaluated and thus ranked for each individual formulation in a specific field of application. Due to the broad usefulness of the inventive polymers an exhaustive overview or detailed guidance for each area is not possible, but the present specification and examples give a guidance on how to prepare and select useful polymers of desired properties and how to tune the properties to the desired needs. One such criteria for the area of home care and especially fabric care of course it he performance upon dye transfer inhibition, e.g. subjecting a certain coloured fabric material to a defined washing procedure.

The examples give some guidance for the application for washing of fabrics, i.e. the general area of fabric care.

Depending on the individual needs for a polymer exhibiting a defined degree of biodegradation, water solubility and viscosity (i.e. handling properties) the general and specific teachings herein—without being intended to be limited to the specific examples being given—will guide on how to obtain such polymer.

### Process

The invention also encompasses a process for obtaining a graft polymer according to any of the previous embodiments as defined herein and specifically any embodiment in the previous section, but also in any of the examples disclosed herein, comprising the step of polymerizing at optionally least one vinyl ester monomer (B1), at least one, preferably at least two nitrogen-containing monomer (B2), and optionally further monomer(s) (B3) and further optionally including further monomer(s) as impurities within (B1), (B2) and/or (B3) is/are polymerized in the presence of at least one polymer backbone (A), wherein the polymeric sidechains (B) are obtained by radical polymerization, preferably using radical forming compounds to initiate the radical polymerization,
wherein each (B1), (B2), (B2a), (B2b) and (B3) (and further monomers besides (B1), (B2) (B2a), (B2b) and (B3)) and (A), (A1), (A2), (A3) and (A4) are as defined herein before, in any of the embodiments including the claims and including as exemplified in the examples below, with each of it preferably being selected from any of its grades of preferences, in as far as each can be selected individually form its preferences, but always confirming to the general requirements of compatibility of preferences, such as total sums not exceeding 100% etc.

It has to be noted that the “grafting process” as such, wherein a polymeric backbone, such as the polymer backbone (A) described herein above, is grafted with polymeric sidechains, is known to a person skilled in the art. Any process known to the skilled person in this respect can in principle be employed within the present invention.

The radical polymerization as such is also known to a skilled person. That person also knows that the inventive process can be carried out in the presence of a radical-forming initiator (C) and/or at least one solvent (D).

The skilled person knows the respective components suitable as such.

The term “radical polymerization” as used within the context of the present invention comprises besides the free radical polymerization also variants thereof, such as controlled radical polymerization. Suitable control mechanisms are RAFT, NMP or ATRP, which are each known to the skilled person, including suitable control agents.

In a preferred embodiment, the process to produce a graft polymer of the invention and/or as detailed before comprises the polymerization of the monomers (B) in the presence of at least one polymer backbone (A), preferably selected from backbones (A1), (A2), (A3) and (A4), a free radical-forming initiator (C) and, optionally, up to 50% by weight, based on the sum of components (A), (B), and (C), of at least one solvent (D), at a mean polymerization temperature at which the initiator (C) has a decomposition half-life of from 40 to 500 min, in such a way that the fraction of unconverted graft monomers optional (B1), (B2) and optional (B3) and initiator (C) in the reaction mixture is constantly kept in a quantitative deficiency relative to the polymer backbone (A), with the further monomers typically not being monitored as present only as impurity in low, thus neglectable amounts.

Generally, the amount of further monomer(s) besides (B1), (B2) and (B3) is minimized, preferably they are not present at all.

In an alternative embodiment no monomer (B1) is employed. In a more preferred embodiment, no monomer (B1) nor monomer (B3) are employed.

In a preferred embodiment of the process as detailed herein—when (B1) is employed—, at least 10 weight percent of the total amount of vinyl ester monomer (B1) is selected from vinyl acetate, vinyl propionate and vinyl laurate, more preferably from vinyl acetate and vinyl laurate, and most preferably vinyl acetate, and wherein the remaining amount of vinyl ester may be any other known vinyl ester, wherein preferably at least 60, more preferably at least 70, even more preferably at least 80, even more preferably at least 90 weight percent, and most preferably essentially only (i.e. about 100 wt. % or even 100 wt. %) vinyl acetate is employed as vinyl ester (weight percent being based on the total weight of vinyl ester monomers B1 being employed).

In a more preferred embodiment of the previous two paragraphs, the following additional provisions 1) (presence of (B2)) and 2) (absence of (B2)) apply for the amounts and ratios of monomers:

In this process, the amounts employed for the process are the following:
(A) is 20 to 95%, preferably 50 to 90%, more preferably 60 to 90%, even more preferably 65 to 85%, most preferably 70 bis 85% of a polymer backbone as a graft base,
(B) is 5 to 80%, preferably 10 to 50%, more preferably 10 to 40%, even more preferably 15 to 35 and most preferably 15 to 30%; with
   (B1) (vinylester) in weight percent being based on the total WEIGHT OF THE GRAFT POLYMER is
   from 0 to 20%, preferably up to 15, more preferably up to 10, even more preferably up to 5%;
   (B2) (nitrogen-containing monomer) in weight percent being based on the total WEIGHT OF THE GRAFT POLYMER is
      from 10 to 40%, preferably up to 35, more preferably up to 30, even more preferably up to from 25, and most preferably up to 20, and more preferably at least 15,
         and—more preferably—
   (B2a) vinyl imidazole-monomer, preferably N-vinylimidazole, is from 20 to 80, preferably from 30 to 70, most preferably from 40 to 60%, each in weight percent based on total weight of (B2); and
   (B2b) vinyl lactame-monomer, preferably N-vinylpyrrolidone, is equal to [the total amount of (B2) minus (B2a)];
And further provided that (B3) (further monomer) is from 0 to 5, preferably at most 2, more preferably at most 1, even more preferably about 0 based on the total WEIGHT OF THE GRAFT POLYMER, but in all cases at most 10 wt. % of the amount of (B2).

Generally, besides monomers (B1), (B2) and (B3), at least one further monomer, being different from those before, may be employed for the co-polymerization to yield the side chains (B), wherein such further monomer is present only in an amount of less than 2% of the total amount of monomers employed for obtaining the polymeric sidechains (B), and is preferably employed only as—in practical aspects non-avoidable—impurities but not deliberately added for polymerization, and most preferably is not present at all.

Preferably, optional further monomers (B3) are present also only as impurities but not deliberately added for polymerization. More preferably, the amount is less than 1, more preferably less than 0.5%, even more preferably less than 0.01% by weight based on total weight of monomers (B1), most preferably there is essentially no such monomers (B3), and most preferably even a total absence of any other monomer besides the monomers (B1) and optional monomers (B2). The same applies for the further monomers besides (B1), (B2) and (B3).

The amount of ((free) radical-forming) initiator (C) is preferably from 0.1 to 5% by weight, in particular from 0.3 to 3.5% by weight, based in each case on the polymeric sidechains (B).

For the process according to the invention, it is preferred that the steady-state concentration of radicals present at the mean polymerization temperature is substantially constant and the graft monomers (B), and especially (B1) and (B2b)-if present-, more preferably (B1) and (B2), even more preferably (B1), (B2) and (B3), are present in the reaction mixture constantly only in low concentration (for example of not more than 5% by weight in total). This allows the reaction to be controlled, and graft polymers can be prepared in a controlled manner with the desired low polydispersity.

To assure a safe temperature control although-especially when a polymerization is started at high solid concentrations or in bulk and/or with a large amount of monomers being present from the start on it is advisable, and thus preferred, to use an additional and efficient measure to control the temperature. This can be done by external and/or internal cooling; such cooling can be done by internal and/or external coolers such as heat exchangers, or using reflux condensers when working at the boiling temperature of the solvent or the solvent mixture at a given temperature/pressure-combination.

The same measure could of course be used for the preferred embodiment mentioned before wherein the monomers are added over a prolonged period of time, and thus the monomer concentration in the reaction volume being constantly low over time.

However, under such conditions, temperature control is usually not a crucial point, as the temperature is at least partially controlled also by the propagation of the polymerization reaction by controlling the radical concentration and the available amount of polymerizable monomers. Of course, depending on the scale of the polymerisation reaction, such additional cooling as described before may become necessary for both variants-batch reaction or bulk reactions with large amounts of monomer present from the start or semi-continuous or continuous polymerization reactions with typically constantly low monomer concentrations-when the scale gets large enough that the ratio from volume to surface of the polymerization mixture becomes very large.

This however is generally known to a person of skill in the art of commercial scale polymerisations, and thus can be adapted to the needs.

According to the invention, the initiator (C) and the graft monomers (B), and especially (B1) and/or (B2) and/or (B3), preferably twice “and”, are advantageously added-if employed—in such a way that a low and substantially constant concentration of undecomposed initiator and graft monomers (B), and especially a constant but low amount of (B1) and especially even more (B2) (especially in case when vinylpyrrolidone is selected as (B2)), are present in the reaction mixture. The proportion of undecomposed initiator in the overall reaction mixture is preferably ≤15% by weight, in particular ≤10% by weight, based on the total amount of initiator metered in during the monomer addition.

The mean polymerization temperature for the main polymerization and the post-polymerization is appropriately in the range from 50 to 140° C., preferably from 60 to 120° C. and more preferably from 65 to 110° C. Typically, the temperature for the post-polymerization is higher by 5 to 40° C. compared to the polymerization.

The term “mean polymerization temperature” is intended to mean here that, although the process is substantially isothermal, there may, owing to the exothermicity of the reaction, be temperature variations which are preferably kept within the range of +/−10° C., more preferably in the range of +/−5° C.

According to the invention, the (radical-forming) initiator (C) at the mean polymerization temperature should have a decomposition half-life of from 40 to 500 min, preferably from 50 to 400 min and more preferably from 60 to 300 min.

Examples of suitable initiators (C) whose decomposition half-life in the temperature range from 50 to 140° C. is from 20 to 500 min are:
O—C₂-C₁₂-acylated derivatives of tert-C₄-C₁₂-alkyl hydroperoxides and tert-(C₉-C₁₂-aralkyl) hydroperoxides, such as tert-butyl peroxyacetate, tert-butyl monoperoxymaleate, tert-butyl peroxyisobutyrate, tert-butyl peroxypivalate, tert-butyl peroxyneoheptanoate, tert-butyl peroxy-2-ethylhexanoate, tert-butyl peroxy-3,5,5-trimethylhexanoate, tert-butyl peroxyneodecanoate, tert-amyl peroxypivalate, tert-amyl peroxy-2-ethylhexanoate, tert-amyl peroxyneodecanoate, 1,1,3,3-tetramethylbutyl peroxyneodecanoate, cumyl peroxyneodecanoate, tert-butyl peroxybenzoate, tert-amyl peroxybenzoate and di-tert-butyl diperoxyphthalate;
di-O—C₄-C₁₂-acylated derivatives of tert-C₈-C₁₄-alkylene bisperoxides, such as 2,5-dimethyl-2,5-di(2-ethylhexanoylperoxy) hexane, 2,5-dimethyl-2,5-di(benzoyl-peroxy) hexane and 1,3-di(2-neodecanoylperoxyisopropyl)benzene;
di(C2-C12-alkanoyl) and dibenzoyl peroxides, such as diacetyl peroxide, dipropionyl peroxide, disuccinyl peroxide, dicapryloyl peroxide, di(3,5,5-trimethylhexanoyl) peroxide, didecanoyl peroxide, dilauroyl peroxide, dibenzoyl peroxide, di(4-methylbenzoyl) peroxide, di(4-chlorobenzoyl) peroxide and di(2,4-dichlorobenzoyl) peroxide;
tert-C₄-C₅-alkyl peroxy (C₄-C₁₂-alkyl) carbonates, such as tert-amyl peroxy (2-ethylhexyl) carbonate;
di(C₂-C₁₂-alkyl) peroxydicarbonates, such as di(n-butyl) peroxydicarbonate and di(2-ethylhexyl) peroxydicarbonate.

Depending on the mean polymerization temperature, examples of particularly suitable initiators (C) are:
at a mean polymerization temperature of from 50 to 60° C.:
tert-butyl peroxyneoheptanoate, tert-butyl peroxyneodecanoate, tert-amyl peroxypivalate, tert-amyl peroxyneodecanoate, 1,1,3,3-tetramethylbutyl peroxyneodecanoate, cumyl peroxyneodecanoate, 1,3-di(2-neodecanoyl peroxyisopropyl)benzene, di(n-butyl) peroxydicarbonate and di(2-ethylhexyl) peroxydicarbonate;
at a mean polymerization temperature of from 60 to 70° C.:
tert-butyl peroxypivalate, tert-butyl peroxyneoheptanoate, tert-butyl peroxyneodecanoate, tert-amyl peroxypivalate and di(2,4-dichlorobenzoyl) peroxide;
at a mean polymerization temperature of from 70 to 80° C.:
tert-butyl peroxypivalate, tert-butyl peroxyneoheptanoate, tert-amyl peroxypivalate, dipropionyl peroxide, dicapryloyl peroxide, didecanoyl peroxide, dilauroyl peroxide, di(2,4-dichlorobenzoyl) peroxide and 2,5-dimethyl-2,5-di(2-ethylhexanoylperoxy) hexane;
at a mean polymerization temperature of from 80 to 90° C.:
tert-butyl peroxyisobutyrate, tert-butyl peroxy-2-ethylhexanoate, tert-amyl peroxy-2-ethylhexanoate, dipropionyl peroxide, dicapryloyl peroxide, didecanoyl peroxide, dilauroyl peroxide, di(3,5,5-trimethylhexanoyl) peroxide, dibenzoyl peroxide and di(4-methylbenzoyl) peroxide;
at a mean polymerization temperature of from 90 to 100° C.:
tert-butyl peroxyisobutyrate, tert-butyl peroxy-2-ethylhexanoate, tert-butyl monoperoxymaleate, tert-amyl peroxy-2-ethylhexanoate, dibenzoyl peroxide and di(4-methylbenzoyl) peroxide;
at a mean polymerization temperature of from 100 to 110° C.:
tert-butyl monoperoxymaleate, tert-butyl peroxyisobutyrate and tert-amyl peroxy (2-ethylhexyl) carbonate;
at a mean polymerization temperature of from 110 to 120° C.:
tert-butyl monoperoxymaleate, tert-butyl peroxy-3,5,5-trimethylhexanoate and tert-amyl peroxy (2-ethylhexyl) carbonate.

Preferred initiators (C) are O—C₄-C₁₂-acylated derivatives of tert-C₄-C₅-alkyl hydroperoxides, particular preference being given to tert-butyl peroxypivalate and tert-butyl peroxy-2-ethylhexanoate.

Particularly advantageous polymerization conditions can be established effortlessly by precise adjustment of initiator (C) and polymerization temperature. For instance, the preferred mean polymerization temperature in the case of use of tert-butyl peroxypivalate is from 60 to 80° C., and, in the case of tert-butyl peroxy-2-ethylhexanoate, from 80 to 100° C.

The inventive polymerization reaction can be carried out in the presence of, preferably small amounts of, a solvent (D). It is of course also possible to use mixtures of different solvents (D). Preference is given to using water-soluble or water-miscible organic solvents. However, water as only solvent is in principle also possible but not preferred.

When a solvent (D) is used as a diluent, generally from 1 to 40% by weight, preferably from 1 to 35% by weight, more preferably from 1.5 to 30% by weight, most preferably from 2 to 25% by weight, based in each case on the sum of the components (A), (B1), optionally (B2), optionally (B3) and optional further monomers, and (C), are used.

Examples of suitable solvents (D) include:
monohydric alcohols, preferably aliphatic C₁-C₁₆-alcohols, more preferably aliphatic C₂-C₁₂-alcohols, most preferably C₂-C₄-alcohols, such as ethanol, propanol, isopropanol, butanol, sec-butanol and tert-butanol;
polyhydric alcohols, preferably C₂-C₁₀-diols, more preferably C₂-C₆-diols, most preferably C₂-C₄-alkylene glycols, such as ethylene glycol, 1,2-propylene glycol and 1,3-propylene glycol;
alkylene glycol ethers, preferably alkylene glycol mono(C₁-C₁₂-alkyl) ethers and alkylene glycol di(C₁-C₆-alkyl) ethers, more preferably alkylene glycol mono- and di(C₁-C₂-alkyl) ethers, most preferably alkylene glycol mono(C₁-C₂-alkyl) ethers, such as ethylene glycol monomethyl and -ethyl ether and propylene glycol monomethyl and -ethyl ether;
polyalkylene glycols, preferably poly(C₂-C₄-alkylene) glycols having 2-20 C₂-C₄-alkylene glycol units, more preferably polyethylene glycols having 2-20 ethylene glycol units and polypropylene glycols having 2-10 propylene glycol units, most preferably polyethylene glycols having 2-15 ethylene glycol units and polypropylene glycols having 2-4 propylene glycol units, such as diethylene glycol, triethylene glycol, dipropylene glycol and tripropylene glycol;
polyalkylene glycol monoethers, preferably poly(C₂-C₄-alkylene) glycol mono(C₁-C₂₅-alkyl) ethers having 2-20 alkylene glycol units, more preferably poly(C₂-C₄-alkylene) glycol mono(C₁-C₂₀-alkyl) ethers having 2-20 alkylene glycol units, most preferably poly(C₂-C₃-alkylene) glycol mono(C₁-C₁₆-alkyl) ethers having 3-20 alkylene glycol units;
carboxylic esters, preferably C₁-C₈-alkyl esters of C₁-C₆-carboxylic acids, more preferably C₁-C₄-alkyl esters of C₁-C₃-carboxylic acids, most preferably C₂-C₄-alkyl esters of C₂-C₃-carboxylic acids, such as ethyl acetate and ethyl propionate;
aliphatic ketones which preferably have from 3 to 10 carbon atoms, such as acetone, methyl ethyl ketone, diethyl ketone and cyclohexanone;
cyclic ethers, in particular tetrahydrofuran.

The solvents (D) are advantageously those solvents, which are also used to formulate the inventive graft polymers for use (for example in washing and cleaning compositions) and can therefore remain in the polymerization product.

Preferred examples of these solvents are polyethylene glycols having 2-15 ethylene glycol units, polypropylene glycols having 2-6 propylene glycol units and in particular alkoxylation products of C₆-C₈-alcohols (alkylene glycol monoalkyl ethers and polyalkylene glycol monoalkyl ethers).

Particular preference is given here to alkoxylation products of C₈-C₁₆-alcohols with a high degree of branching, which allow the formulation of polymer mixtures which are free-flowing at 40-70° C. and have a very low polymer content at comparatively low viscosity. The branching may be present in the alkyl chain of the alcohol and/or in the polyalkoxylate moiety (copolymerization of at least one propylene oxide, butylene oxide or isobutylene oxide unit). Particularly suitable examples of these alkoxylation products are 2-ethylhexanol or 2-propylheptanol alkoxylated with 1-15 mol of ethylene oxide, C₁₃/C₁₅ oxo alcohol or C₁₂/C₁₄ or C₁₆/C₁₈ fatty alcohol alkoxylated with 1-15 mol of ethylene oxide and 1-3 mol of propylene oxide, preference being given to 2-propylheptanol alkoxylated with 1-15 mol of ethylene oxide and 1-3 mol of propylene oxide.

In an alternative embodiment the polymerization is performed using a mixture of at least one organic solvent and water.

In a preferred embodiment, the amount of water during the polymerization is low, preferably at most 10 wt. %, more preferably at most 5 wt % based on total solvent, more preferably at most 1%.

In a further alternative embodiment the polymerization is performed using water as solvent (D). However, water as only solvent is not preferred.

The radical initiator (C) is preferably employed in the form of a concentrated solution in one of the solvents mentioned before. The concentration of course depends on the solubility of the radical initiator. It is preferred, that the concentration is as high as possible to allow to introduce as little as possible of the organic solvent into the polymerization reaction. In case the initiator is soluble in water, and thus water is used as solvent for introducing the initiator, the concentration is not critical from the viewpoint of residual levels of water.

Preferably, the amount of water during the polymerisation is at most 10 wt. %, preferably at most 5 wt. %, more preferably at most 1 wt. %, based on total weight of graft polymer (at the end of the polymerization) or based on total weight of (A) and (B) (at the start of the polymerization).

In the process according to the invention, polymer backbone (A), graft monomer(s) (B), initiator (C) and, if appropriate, solvent (D) are usually heated to the selected mean polymerization temperature in a reactor.

According to the invention, the polymerization is carried out in such a way that an excess of polymer (polymer backbone (A) and formed graft polymer) is constantly present in the reactor. The quantitative ratio of polymer to ungrafted monomer and initiator is generally ≥10:1, preferably ≥15:1 and more preferably ≥20:1.

The polymerization process according to the invention can in principle be carried out in various reactor types. Such reactor types are generally known, and includes any stirred-type reactor such as vessels, but also includes tube reactors, reactor cascades from vessels or various tubes etc.

The reactor used is preferably a stirred tank in which the polymer backbone (A), if appropriate together with portions, of generally up to 15% by weight of the particular total amount, of graft monomers (B), initiator (C) and solvent (D), are initially charged fully or partly and heated to the polymerization temperature, and the remaining amounts of (B), (C) and, if appropriate, (D) are metered in, preferably separately. The remaining amounts of (B), (C) and, if appropriate, (D) are metered in preferably over a period of ≥2 h, more preferably of ≥4 h and most preferably of ≥5 h.

In the case of a particularly preferred, substantially solvent-free process variant, the entire amount of polymer backbone (A) is initially charged as a melt and the graft monomers (B1) and, if appropriate, (B2) and/or (B3), and also the initiator (C) present preferably in the form of a from 10 to 50% by weight solution in one of the solvents (D), are metered in, the temperature being controlled such that the selected polymerization temperature, on average during the polymerization, is maintained with a range of especially+/−10° C., in particular +/−5° C.

In a further particularly preferred, low-solvent process variant, the procedure is as described above, except that solvent (D) is metered in during the polymerization in order to limit the viscosity of the reaction mixture. It is also possible to commence with the metered addition of the solvent only at a later time with advanced polymerization, or to add it in portions.

The polymerization can be affected under standard pressure or at reduced or elevated pressure. When the boiling point of the monomers (B1) and/or (B2) (and if employed also monomer (B3)) and/or of any solvent (D) used is exceeded at the selected pressure, the polymerization is carried out with reflux cooling.

A post-polymerization process step may be added after the main polymerization reaction. For that a further amount of initiator (dissolved in the solvent(s)) can be added over a period of 0.5 hour and typically up to 3 hours, preferably about 1 to 2 hours, more preferably about 1 hour, (such duration however also depending on the scale of the reactor) with the radical initiator and the solvent(s) for the initiator typically- and preferred-being the same as the ones for the main polymerization reaction. Of course, a different radical initiator and/or different solvent(s) may be employed as well.

The temperature of the post-polymerisation process step may be the same as in the main polymerization reaction (which is preferred in this invention) or may be increased. In case increased, it may be typically higher by about 5 to 40° C., preferably 10 to 20° C.

In between the post-polymerisation and the main polymerization a certain period of time may be waited, where the main polymerization reaction is left to proceed, before the post-polymerisation reaction is started by starting the addition of further radical initiator.

For solvents having a boiling point of approximately less than 110-120° C. at atmospheric pressure, such solvents may—as a purification step—be removed partially or essentially complete by thermal or vacuum distillation or stripping with a gas such as steam or nitrogen, such as stripping with steam made from water, all at ambient or reduced pressure, preferably vacuum distillation, whereas higher boiling solvents will usually stay in the polymer products obtained.

When mercaptoethanol is employed as chain transfer regulator, steam distillation is the preferred step of purification. Hence, higher boiling solvents like 1-methoxy-2-propanol, 1,2-propandiol and tripropylene glycol will stay in the polymer product, and thus their amounts should be minimized as far as possible by using as high as possible concentrations of the radical initiator when such solvents are used only for introducing the initiator, unless such solvents form also part of the formulation the graft polymer will be used within.

The graft polymers of the invention prepared using the process as defined herein may contain a certain amount of ungrafted polymers (“ungrafted side chains”) made of vinyl ester(s), e.g. poly vinyl acetate in case only vinyl acetate is employed, and/or—when further monomers are employed—homo- and copolymers of vinyl ester(s) with the other monomers. The amount of such ungrafted vinyl ester-homo- and copolymers may be high or low, depending on the reaction conditions, but is preferably to be lowered and thus low. By this lowering, the amount of grafted side chains is preferably increased. Such lowering can be achieved by suitable reaction conditions, such as dosing of vinyl ester and radical initiator and their relative amounts and also in relation to the amount of backbone being present. Such reaction controlling and the necessary process steps is generally known to a person of skill in the present field, specific guidance being given herein.

This adjustment of the degree of grafting and this amount of ungrafted polymers can be used to optimize the performance in areas of specific interest, e.g. certain (e.g. detergent-) formulations, application areas or desired cleaning etc. performance.

It is believed that the conditions considered favorable herein promote a—suspected—higher degree of grafting; such higher degree of grafting is associated with a better performance. This suspected higher degree of grafting however does not compromise the biodegradation —which is attributed to the ester linkage in the backbone, which can “compensate” the lower biodegradation of a graft polymer having a higher degree of grafting—which is seen in the “conventional graft polymers” based on polyalkylene oxides as backbone.

A drawback is that it is extremely difficult if not even impossible to actually verify such degree of grafting on a polymer, especially with increasing molecular weights of the polymers, as the total amount of grafting sites in a polymer is generally very low compared to the molecular weight; thus, the signal-to-noise-ratio is unfavorable for polymers in view of current analytical tools.

In another—alternative—embodiment of the present invention, the units in polymeric sidechains (B) of the graft polymer according to the present invention are—if monomer (B1) is employed for the process-fully or partially hydrolyzed, preferably partially hydrolyzed, more preferably up to 50 mole %, and preferably from 20 mole %, more preferably 20 to 50, even more preferably 30 to 45, such as about 40 mole %, based on the total moles of (B1) employed, after the polymerization reaction and thus after the graft polymer as such is obtained. This means that the full or at least partial hydrolyzation of the polymeric sidechains (B1) of the graft polymer is carried out in a further process step after the polymerization process (including after the optional post-polymerisation step if employed) of the polymeric sidechains (B1) is finished.

In another alternative embodiment, no hydrolysis is performed on the graft polymer after the polymerization process of the polymeric sidechains (B1) is finished.

Due to this full or at least partial hydrolyzation of the units in polymeric sidechains (B) stemming from (B1) of the graft polymers according to the present invention, the respective sidechain units originating from the at least one vinyl ester monomer (B1) are changed from the respective ester function into the alcohol function within the polymeric sidechain (B). It has to be noted that the corresponding vinyl alcohol is not suitable to be employed as monomer within the polymerization process of the polymeric sidechains (B) due to stability aspects of the “vinylalcohol”-monomer. In order to obtain an alcohol function (hydroxy substituent) within the polymeric sidechains (B) of the graft polymers according to the present invention, the alcohol function is typically introduced by hydrolyzing the ester function of the sidechains.

From a theoretical point of view, each ester function of the polymeric sidechain (B) may be partially or completely replaced by an alcohol function (hydroxy group). In such a case, the polymeric sidechain is fully hydrolyzed (“saponified”).

The hydrolysis can be carried out by any method known to a person skilled in the art. For example, the hydrolysis can be induced by addition of a suitable base, such as sodium hydroxide or potassium hydroxide. Such hydrolysis processes are known from prior art.

In one embodiment, vinyl acetate is employed as monomer (B1), vinylimidazole as monomer (B2a) and vinylpyrrolidone as monomer (B2b) and no other monomers are employed besides (B1) and (B2), and the polymer moiety stemming from vinyl acetate is partially hydrolyzed after polymerisation, preferably in an amount of from 20 to 50 mole, more preferably 30 to 45, such as—most preferably—about 40 mole % based on the total moles of (B1) employed.

The graft polymer of this invention, i.e. the polymer solution obtained from the process, may be also subjected to a means of concentration and/or drying.

The graft polymer solution obtained may be concentrated by subjecting the polymer solutions to means for removing part of the volatiles and especially solvent(s) to increase the solid polymer concentration. This may be achieved by distillation processes such as thermal or vacuum distillation, or by stripping using gases such as steam or inert gases such as nitrogen or argon, which is performed until the desired solid content is achieved. Such process can be combined with the purification step as disclosed before wherein the graft polymer solution obtained is purified by removing part or all of the volatile components such as volatile solvents and/or unreacted, volatile monomers, by removing the desired amount of solvent.

The graft polymer solution may be also after the main and/or the optional post-polymerization step and the optional purification step further concentrated or dried by subjecting the graft polymer solution to means of removing the volatiles partially or fully, such as—for concentration—distillation processes such as thermal or vacuum distillation, or by stripping using gases such as steam or inert gases such as nitrogen or argon, which is performed until the desired solid content is achieved, and/or drying such as roller-drum drying, spray-drying, vacuum drying or freeze-drying, preferably—mainly for cost-reasons—spray-drying. Such drying process may be also combined with an agglomeration or granulation process such as spray-agglomeration, granulation or drying in a fluidized-bed dryer.

Hence, the process of the invention encompasses preferably at least one further process step selected from i) to iv), with i) post-polymerisation; ii) purification; iii) concentration; and iv) drying.

More preferably, the process as detailed herein in any of the embodiments defined, comprises at least one further process step selected from i) and ii):
i) a post-polymerization process step that is performed after the main polymerization reaction, wherein preferably a further amount of initiator (optionally dissolved in the solvent(s)) is added over a period of 0.5 hour and up to 3 hours, preferably about 1 to 2 hours, more preferably about 1 hour, with the radical initiator and the solvent(s) for the initiator typically—and preferred—being the same as the ones for the main polymerization reaction; and wherein after the polymerization reaction and before the post-polymerisation reaction preferably a period is waited when the main polymerization reaction is left to proceed, before the post-polymerisation reaction is started by starting the addition of further radical initiator, such period being preferably from 10 minutes and up to 4 hours, preferably up to 2 hours, even more preferably up to 1 hour, and most preferably up to 30 minutes; and wherein the temperature of the post-polymerisation process step is—preferably—the same as in the main polymerization reaction, or is increased, such increase being preferably higher by about 5 to 40° C., preferably 10 to 20° C. compared to the temperature of the main polymerisation reaction;
ii) a step of subjecting the graft polymer as obtained from the main polymerization or—if performed, the post-polymerisation process—to a means of purification, concentration and/or drying to remove part of or almost all of the remaining solvent(s) (as far as they are removable due to their boiling points) and/or volatiles such as residual monomers, wherein
   a. the concentration is performed by removing part of the solvent(s) and optionally also volatiles—by this this step additionally serves as means for purification—to increase the solid polymer concentration—and optionally as well for purification—, by preferably applying a distillation process such as thermal or vacuum distillation, preferably vacuum distillation, and/or applying stripping with gas such as steam or an inert gas such as nitrogen, preferably using steam from water, which is performed until the desired solid content and optionally also purity is achieved, preferably is performed until the desired part or all of the volatile components such as volatile solvents and/or unreacted, volatile monomers, are removed;
   b. the drying is performed by subjecting the graft polymer containing at least residual amounts of volatiles such as remaining solvent and/or unreacted monomers etc. to a means of removing the volatiles, such as drying using a roller-drum, a spray-dryer, vacuum drying or freeze-drying, preferably—mainly for cost-reasons—spray-drying; and optionally combining such drying process step with a means of agglomeration or granulation to obtain agglomerated or granulated graft polymer particles, such process being preferably selected from spray-agglomeration, granulation or drying in a fluidized-bed dryer, spray-granulation device and the like.

### Uses

In principle the graft polymers of this invention can be employed in any application to replace conventional graft polymers of the same or very similar composition (in terms of relative amounts of polymer backbone and grafted monomers especially when the type and amounts of grafted monomers is similar or comparable. Such applications are for example: redeposition of soils and removing of stains, avoiding or reducing re-soiling or greying or depositioning of solids, dispersion of actives in formulations of agrochemicals, pigments, colours, inorganic salts etc., inhibiting crystal growth including for inhibiting gas hydrate formation and/or reducing sedimentation and/or agglomeration, improve pigment dispersion stability, hydrophobisation of surfaces, reduction of growth of microbes on surfaces, and/or odor control etc., all compared to corresponding polymers or graft polymers according to the prior art.

Typical applications are:

Technical applications: Such compositions and formulations include glues of any kind, non-water and—preferably—water-based liquid formulations or solid formulations, the use as dispersant in dispersions of any kind, such as in oilfield applications, automotive applications, typically where a solid or a liquid is to be dispersed within another liquid or solid.

Lacquer, paints and colorants formulations: Such compositions and formulations include non-water—and—preferably—water-based lacquer and colourants, paints, finishings.

Agricultural Formulations: Such compositions and formulations include formulations and compositions containing agrochemical actives within a liquid, semi-solid, mixed-liquid-solid or solid environment.

Aroma Chemical-formulations: Such compositions and formulations include formulations which dissolve or disperse aroma chemicals in liquid or solid compositions, to evenly disperse and/or retain their stability, so as to retain their aroma profile over extended periods of time; encompassed are also compositions that show a release of aroma chemicals over time, such as extended release or retarded release formulations.

The inventive graft polymers as defined herein, obtainable by a process as defined herein or obtained by the process as defined herein, can improve the overall bio-degradation ratio of such formulation, compositions and products by replacing non-biodegradable polymers of similar structures or properties. They may thus be advantageously used—partly also depending on the monomer(s) B employed for grafting and thus adjusted in their performance to the specific needs of the specific applications; such monomer substitution pattern as possibly also derivable from the prior art of analogous graft polymers based on simple PEGs and polyalkylene glycols.

Specifically, and beyond the performance in a certain type of application, the graft polymers according to the present invention lead to an improved biodegradability when being employed within such compositions or products, compared to the previously known graft polymers.

Most preferably, the graft polymer of the invention is usable as dye transfer inhibitor, and this is used preferably for such use.

Hence, another subject matter of the present invention is the use of the graft polymers of the invention and/or obtained by or obtainable by a process of the invention and/or as detailed before, in cleaning compositions, fabric and home care products, in particular cleaning compositions for improved oily and fatty stain removal, removal of solid dirt such as clay, prevention of greying of fabric surfaces, anti-scale agents, and/or as dye transfer inhibitor, preferably as dye transfer inhibitor, wherein the cleaning composition is preferably a laundry detergent formulation, more preferably a liquid laundry detergent formulation.

Hence, another subject matter of the present invention is the use of the graft polymers of the invention and/or obtained by or obtainable by a process of the invention and/or as detailed before in any of in this chapter before-mentioned applications, such as fabric care and home care products, in cosmetic and personal care formulations, as crude oil emulsion breaker, in technical applications including in pigment dispersions for ink jet inks, in formulations for electro plating, in cementitious compositions, in agrochemical formulations as e.g. dispersants, crystal growth inhibitor and/or solubilizer, in lacquer and colorants formulations, textile and leather treatment products for use during or after production, formulations containing inorganic salts such as especially silver salts, mining, metal production and treatment including metal refining and metal quenching, purification of liquids such as waste water from industry, production or consumers, preferably in agrochemical compositions and cleaning compositions and in fabric and home care products, in particular cleaning compositions for improved oily and fatty stain removal, removal of solid dirt such as clay, prevention of greying of fabric surfaces, anti-scale agents, and/or as dye transfer inhibitor, and most preferably—for inhibiting the transfer of dyes, wherein the cleaning composition is preferably a laundry detergent formulation, more preferably a liquid laundry detergent formulation.

Another subject-matter of the present invention is, therefore, also a cleaning composition, fabric care and home care product, industrial and institutional cleaning product, agrochemical formulations, or a formulation or product for any of the previously mentioned applications and application fields, preferably in laundry detergents, in cleaning compositions and/or in fabric and home care products, each comprising at least one graft polymer as defined above or obtained by or obtainable by a process of the invention and/or as detailed herein.

Hence, a preferred subject matter of this invention is also the use of at least one inventive graft polymer and/or at least one graft polymer obtained or obtainable by the inventive process in fabric care and home care products, industrial and institutional cleaning product, or a formulation or product for any of the previously mentioned applications, preferably in cleaning compositions and in laundry treatment, laundry care products and laundry washing products, more preferably a laundry detergent formulation, even more preferably a liquid laundry detergent formulation. In particular, the inventive graft polymer is employed in such composition/product/formulation for improved dye transfer inhibition.

Such inventive uses and inventive compositions/products encompass the use of the graft polymer as detailed herein and/or as obtainable from or obtained from the inventive process, such graft polymer resembling that as detailed above describing the polymer structure in any of its embodiments disclosed herein before, including any variations mentioned, and more specifically any of the preferred, more preferred etc. embodiments.

Laundry detergents, cleaning compositions and/or fabric and home care products as such are known to a person skilled in the art. Any composition etc. known to a person skilled in the art, in connection with the respective use, can be employed within the context of the present invention.

In a preferred embodiment, it is a cleaning composition and/or fabric and home care product and/or industrial and institutional cleaning product, comprising at least one graft polymer as defined above. In particular, it is a cleaning composition for improved dye transfer inhibition, preferably a laundry detergent formulation, more preferably a liquid laundry detergent formulation.

The graft polymers may also support the removal of various hydrophobic and hydrophilic soils, such as body soils, food and grease soil, particulate soil such clay or carbon black, grass soil, make-up, motor oil etc. from textile or hard surfaces by the surfactants and thus improve the washing and cleaning performances of the formulations.

In one embodiment it is also preferred in the present invention that the cleaning composition comprises (besides at least one graft polymer as described above) additionally at least one enzyme, preferably selected from one or more optionally further comprising at least one enzyme, preferably selected from one or more lipases, hydrolases, amylases, proteases, cellulases, hemicellulases, phospholipases, esterases, pectinases, lactases, pectate lyases, cutinases, DNases, xylanases, oxicoreductases, dispersins, mannanases and peroxidases, and combinations of at least two of the foregoing types, preferably at least one enzyme being selected from lipases.

Another subject-matter of the present invention is, therefore, a cleaning composition such as a fabric and home care product and an industrial and institutional (I&I) cleaning product, comprising at least one graft polymer as defined above, and in particular a cleaning composition for improved as dye transfer inhibition.

At least one graft polymer as described herein is present in said inventive cleaning compositions in an amount ranging from about 0.01% to about 20%, preferably 0.05 to 10%, more preferably from about 0.1% to 8%, even more preferably from about 0.2% to about 6%, and further more preferably from about 0.2% to about 4%, and most preferably in amounts of up to 2%, each in weight % in relation to the total weight of such composition or product; such cleaning composition may—and preferably does—further comprise a from about 1% to about 70% by weight of a surfactant system.

Preferably, such inventive cleaning composition is a fabric and home care product or an industrial and institutional (1&1) cleaning product, preferably a fabric and home care product, more preferably a laundry detergent, comprising at least one inventive graft polymer, and optionally further comprising at least one surfactant or a surfactant system, providing improved dye transfer inhibition.

Even more preferably, the cleaning compositions of the present invention comprising at least one inventive graft polymer, and optionally further comprising at least one surfactant or a surfactant system—as detailed before—are those for cleaning and dye transfer inhibition within laundry, such as those on fabrics, and may additionally comprise at least one enzyme selected from the list consisting of optionally further comprising at least one enzyme, preferably selected from one or more optionally further comprising at least one enzyme, preferably selected from one or more lipases, hydrolases, amylases, proteases, cellulases, hemicellulases, phospholipases, esterases, pectinases, lactases, pectate lyases, cutinases, DNases, xylanases, oxicoreductases, dispersins, mannanases and peroxidases, and combinations of at least two of the foregoing types, preferably selected from one or more lipases, hydrolases, amylases, proteases, cellulases, and combinations of at least two of the foregoing types, more preferably at least one enzyme being selected from lipases.

In one embodiment the inventive graft polymer may be used for reducing the greying of fabric (anti-greying), preferably more than one of the before mentioned actions as present, i.e. more than one of improved cleaning, anti redeposition, primary washing, soil removal of particulate stains and/or oily and fatty stains, whiteness maintenance and/or anti-greying being exhibited by the graft polymers of the invention.

In another embodiment, the inventive graft polymer may be used for improved dye transfer inhibition, i.e. to prevent the transfer of dyes from one piece of fabric to another piece of fabric, either by direct contact or via the washing liquor. For such application it is preferred that the graft polymer contains at least one monomer (B2) as herein defined for such cases. More preferably, (B2) is at least one (B2a), even more preferably at least one vinylimidazole. Such graft polymers comprising such (B2) are being defined herein with suitable compositions and processes to obtain such graft polymers.

In one preferred embodiment, the cleaning composition of the present invention is a liquid or solid laundry detergent composition.

In another embodiment, the cleaning composition of the present invention is a hard surface cleaning composition that may be used for cleaning various surfaces such as hard wood, tile, ceramic, plastic, leather, metal, glass.

In one embodiment, the inventive graft polymers may be utilized in cleaning compositions comprising a surfactant system comprising C10-C15 alkyl benzene sulfonates (LAS) as the primary surfactant and one or more additional surfactants selected from non-ionic, cationic, amphoteric, zwitterionic or other anionic surfactants, or mixtures thereof.

In a further embodiment, the inventive graft polymers may be utilized in cleaning compositions, such as laundry detergents of any kind, and the like, comprising C8-C18 linear or branched alkyl ethersulfates with 1-5 ethoxy-units as the primary surfactant and one or more additional surfactants selected from non-ionic, cationic, amphoteric, zwitterionic or other anionic surfactants, or mixtures thereof.

In a further embodiment the inventive graft polymers may be utilized in cleaning compositions, such as laundry detergents of any kind, and the like, comprising C12-C18 alkyl ethoxylate surfactants with 5-10 ethoxy-units as the primary surfactant and one or more additional surfactants selected from anionic, cationic, amphoteric, zwitterionic or other non-ionic surfactants, or mixtures thereof.

In one embodiment of the present invention, the graft polymer is a component of a cleaning composition, such as preferably a laundry formulation, more preferably a liquid laundry, that each additionally comprise at least one surfactant, preferably at least one anionic surfactant.

Within such inventive laundry detergent, cleaning composition or fabric and home care product as detailed in any of the embodiments of this invention and specifically any of the previous most preferred embodiments, at least one graft polymer—when solely employed as dye transfer inhibitor and thus—preferably—containing (B2)-monomers in amounts as detailed in any such of the embodiments disclosed herein including specifically any of the previous most preferred embodiments in the chapter disclosing such graft polymer—is present at a concentration of from about 0.01% to about 20%, preferably 0.05 to 10%, more preferably from about 0.1% to 8%, even more preferably from about 0.2% to about 6%, and further more preferably from about 0.2% to about 4%, and most preferably in amounts of up to 2%, each in weight % in relation to the total weight of such composition or product, and all numbers in between, and including all ranges resulting from selecting any of the lower limits and combing with any of the upper limits, each in weight % in relation to the total weight of such composition or product, and optionally further at least one enzyme, preferably selected from one or more lipases, selected from one or more lipases, hydrolases, amylases, proteases, cellulases, hemicellulases, phospholipases, esterases, pectinases, cutinases, DNases, xylanases, mannanases, dispersins, ocidoreductases, lactases and peroxidases, and combinations of at least two of the foregoing types, is comprised, and further optionally an antimicrobial agent selected from the group consisting of 2-phenoxyethanol; preferably comprising said antimicrobial agent in an amount ranging from 2 ppm to 5% by weight of the composition, more preferably comprising 0.1 to 2% of phenoxyethanol, is comprised, and optionally further 4,4′-dichoro 2-hydroxydiphenylether in a concentration from 0.001 to 3%, preferably 0.002 to 1%, more preferably 0.01 to 0.6%, each by weight of the composition is comprised, and further a surfactant system is comprised from about 1% to about 70% by weight of such detergent, composition or product.

In a further embodiment, this invention also encompasses a composition comprising a graft polymer as described herein before, further comprises an antimicrobial agent as disclosed hereinafter, preferably selected from the group consisting of 2-phenoxyethanol, more preferably comprising said antimicrobial agent in an amount ranging from 2 ppm to 5% by weight of the composition; even more preferably comprising 0.1 to 2% of phenoxyethanol.

In a further embodiment, this invention also encompasses a method of preserving an aqueous composition against microbial contamination or growth, such composition comprising a graft polymer as described herein before, such composition being preferably a detergent composition, such method comprising adding at least one antimicrobial agent selected from the disclosed antimicrobial agents as disclosed hereinafter, such antimicrobial agent preferably being 2-phenoxyethanol.

In a further embodiment, this invention also encompasses a composition, preferably a cleaning composition, more preferably a liquid laundry detergent composition or a liquid hand dish composition, even more preferably a liquid laundry detergent composition, or a liquid softener composition for use in laundry, such composition comprising a graft polymer as described herein before, such composition further comprising 4,4′-dichoro 2-hydroxydiphenylether in a concentration from 0.001 to 3%, preferably 0.002 to 1%, more preferably 0.01 to 0.6%, each by weight of the composition.

In a further embodiment, this invention also encompasses a method of laundering fabric or of cleaning hard surfaces, which method comprises treating a fabric or a hard surface with a cleaning composition, more preferably a liquid laundry detergent composition or a liquid hand dish composition, even more preferably a liquid laundry detergent composition, or a liquid softener composition for use in laundry, such composition comprising a graft polymer as described herein before, such composition further comprising 4,4′-dichoro 2-hydroxydiphenylether.

The selection of the additional surfactants in these embodiments may be dependent upon the application and the desired benefit.

The graft polymers according to the present invention may be used, for example, within cleaning compositions and/or fabric and home care products. They lead to an at least comparable and preferably even improved performance within such compositions or products, where the inventive graft polymers can replace similar graft polymers which however are not biodegradable or such ones exhibiting a much lower biodegradation.

### Definitions

As used herein, the articles “a” and “an” when used in a claim or an embodiment, are understood to mean one or more of what is claimed or described. As used herein, the terms “include(s)” and “including” are meant to be non-limiting, and thus encompass more than the specific item mentioned after those words.

The term “about” as used herein encompasses the exact number “X” mentioned as e.g. “about X %” etc., and small variations of X, including from minus 5 to plus 5% deviation from X (with X for this calculation set to 100%), preferably from minus 2 to plus 2%, more preferably from minus 1 to plus 1%, even more preferably from minus 0.5 to plus 0.5% and smaller variations. Of course, if the value X given itself is already “100%” (such as for purity etc.) then the term “about” clearly can and thus does only mean deviations thereof which are smaller than “100”.

Similarly, the dimensions and values disclosed herein are not to be understood as being strictly limited to the exact numerical values recited. Instead, also encompassed are—besides the strict numerical values—also a functionally equivalent range surrounding that value. For example, a dimension disclosed as “40 mm” is intended to mean “about 40 mm”.

The term “free of water” means that the composition contains no more than 5 wt.-% of water based on the total amount of solvent, in another embodiment no more than 1 wt.-% of water based on the total amount of solvent, in a further embodiment the solvent contains no water at all.

The compositions of the present disclosure can “comprise” (i.e. contain other ingredients), “consist essentially of” (comprise mainly or almost only the mentioned ingredients and other ingredients in only very minor amounts, mainly only as impurities), or “consist of” (i.e. contain only the mentioned ingredients and in addition may contain only impurities not avoidable in an technical environment, preferably only the ingredients) the components of the present disclosure.

Similarly, the terms “substantially free of . . . ” or “substantially free from . . . ” or “(containing/comprising) essentially no . . . ” may be used herein; this means that the indicated material is at the very minimum not deliberately added to the composition to form part of it, or, preferably, is not present at analytically detectable levels. It is meant to include compositions whereby the indicated material is present only as an impurity in one of the other materials deliberately included. The indicated material may be present, if at all, at a level of less than 1%, or even less than 0.1%, or even more less than 0.01%, or even 0%, by weight of the composition.

Generally, as used herein, the term “obtainable by” means that corresponding products do not necessarily have to be produced (i.e. obtained) by the corresponding method or process de-scribed in the respective specific context, but also products are comprised which exhibit all features of a product produced (obtained) by said corresponding method or process, wherein said products were actually not produced (obtained) by such method or process. However, the term “obtainable by” also comprises the more limiting term “obtained by”, i.e. products which were actually produced (obtained) by a method or process described in the respective specific context.

Unless otherwise noted, all component or composition levels are in reference to the active portion of that component or composition, and are exclusive of impurities, for example, residual solvents or by-products, which may be present in commercially available sources of such components or compositions.

All temperatures herein are in degrees Celsius (C) unless otherwise indicated. Unless otherwise specified, all measurements herein are conducted at 20° C. and under the atmospheric pressure. In all embodiments of the present disclosure, all percentages are by weight of the total composition, unless specifically stated otherwise. All ratios are weight ratios, unless specifically stated otherwise.

Throughout this description, the term “inventive compound” may be used instead of the “inventive (graft) polymer(s)” and “(graft) polymer(s) of this (present) invention”, meaning those compounds being disclosed herein as invention, defined by their structure and/or their process to produce or obtainable by the process defined herein.

The definitions and their preferences given within the “Definition”-section are included as part of this invention as described herein.

The specific embodiments as described throughout this disclosure are encompassed by the present invention as part of this invention; the various further options being disclosed in this present specification as “optional”, “preferred”, “more preferred”, “even more preferred” or “most preferred” (or “preferably” etc.) options of a specific embodiment may be individually and independently (unless such independent selection is not possible by virtue of the nature of that feature or if such independent selection is explicitly excluded) selected and then combined within any of the other embodiments (where other such options and preferences can be also selected individually and independently unless such independent selection is not possible by virtue of the nature of that feature or if such independent selection is explicitly excluded), with each and any and all such possible combinations being included as part of this invention as individual embodiments.

Description of cleaning compositions, formulations and their ingredients

The phrase “cleaning composition” as used herein includes compositions and formulations designed for cleaning soiled material. Such compositions and formulations include those designed for cleaning soiled material or surfaces of any kind.

Compositions for “industrial and institutional cleaning” includes such cleaning compositions being designed for use in industrial and institutional cleaning, such as those for use of cleaning soiled material or surfaces of any kind, such as hard surface cleaners for surfaces of any kind, including tiles, carpets, PVC-surfaces, wooden surfaces, metal surfaces, lacquered surfaces.

The phrase “fabric care composition” is meant to include compositions and formulations designed for treating fabric. Such compositions include but are not limited to, laundry cleaning compositions and detergents, fabric softening compositions, fabric enhancing compositions, fabric freshening compositions, laundry prewash, laundry pretreat, laundry additives, spray products, dry cleaning agent or composition, laundry rinse additive, wash additive, post-rinse fabric treatment, ironing aid, unit dose formulation, delayed delivery formulation, detergent contained on or in a porous substrate or nonwoven sheet, and other suitable forms that may be apparent to one skilled in the art in view of the teachings herein and detailed herein below when describing the compositions. Such compositions may be used as a pre-laundering treatment, a post-laundering treatment, or may be added during the rinse or wash cycle of the laundering operation, and as further detailed herein below when describing the use and application of the inventive graft polymers and compositions comprising such graft polymers.

“Compositions for Fabric and Home Care” include cleaning compositions including but not limited to laundry cleaning compositions and detergents, fabric softening compositions, fabric enhancing compositions, fabric freshening compositions, laundry prewash, laundry pretreat, laundry additives, spray products, dry cleaning agent or composition, laundry rinse additive, wash additive, post-rinse fabric treatment, ironing aid, dish washing compositions, hard surface cleaning compositions, unit dose formulation, delayed delivery formulation, detergent contained on or in a porous substrate or nonwoven sheet, light duty liquid detergents compositions, heavy duty liquid detergent compositions, detergent gels commonly used for laundry, bleaching compositions, laundry additives, fabric enhancer compositions, and other suitable forms that may be apparent to one skilled in the art in view of the teachings herein. Such compositions may be used as a pre-laundering treatment, a post-laundering treatment, or may be added during the rinse or wash cycle of the laundering operation, preferably during the wash cycle of the laundering or dish washing operation. More preferably, such Composition for Fabric and Home Care is a laundry cleaning composition, a laundry care product or laundry washing product, most preferably a liquid laundry detergent formulation or liquid laundry detergent product.

The cleaning compositions of the invention may be in any form, namely, in the form of a “liquid” composition including liquid-containing composition types such as paste, gel, emulsion, foam and mousse; a solid composition such as powder, granules, micro-capsules, beads, noodles, pearlised balls, agglomerates, tablets, granular compositions, sheets, pastilles, beads, fibrous articles, bars, flakes; or a mixture thereof; types delivered in single-, udal- or multi-compartment pouches or containers; single-phase or multi-phase unit dose; a spray or foam detergent; premoistened wipes (i.e., the cleaning composition in combination with a nonwoven material such as that discussed in U.S. Pat. No. 6,121,165, Mackey, et al.); dry wipes (i.e., the cleaning composition in combination with a nonwoven materials, such as that discussed in U.S. Pat. No. 5,980,931, Fowler, et al.) activated with water by a user or consumer; and other homogeneous, non-homogeneous or single-phase or multiphase cleaning product forms.

The composition can be encapsulated in a single or multi-compartment pouch. A multi-compartment pouch may have at least two, at least three, or at least four compartments. A multi-compartmented pouch may include compartments that are side-by-side and/or superposed. The composition contained in the pouch or compartments thereof may be liquid, solid (such as powders), or combinations thereof.

Non-limiting examples of “liquids”/“liquid compositions” include light duty and heavy duty liquid detergent compositions, fabric enhancers, detergent gels commonly used for laundry, bleach and laundry additives. Gases, e.g., suspended bubbles, or solids, e.g. particles, may be included within the liquids.

The liquid cleaning compositions of the present invention preferably have a viscosity of from 50 to 10000 mPa*s; liquid manual dish wash cleaning compositions (also liquid manual “dish wash compositions”) have a viscosity of preferably from 100 to 10000 mPa*s, more preferably from 200 to 5000 mPas and most preferably from 500 to 3000 mPa*s at 20 l/s and 20° C.; liquid laundry cleaning compositions have a viscosity of preferably from 50 to 3000 mPa*s, more preferably from 100 to 1500 mPa*s and most preferably from 200 to 1000 mPa*s at 20 l/s and 20° C.

The liquid cleaning compositions of the present invention may have any suitable pH-value. Preferably the pH of the composition is adjusted to between 4 and 14. More preferably the composition has a pH of from 6 to 13, even more preferably from 6 to 10, most preferably from 7 to 9. The pH of the composition can be adjusted using pH modifying ingredients known in the art and is measured as a 10% product concentration in demineralized water at 25° C. For example, NaOH may be used and the actual weight % of NaOH may be varied and trimmed up to the desired pH such as pH 8.0. In one embodiment of the present invention, a pH>7 is adjusted by using amines, preferably alkanolamines, more preferably triethanolamine.

Cleaning compositions such as fabric and home care products and formulations for industrial and institutional cleaning, more specifically such as laundry and manual dish wash detergents, are known to a person skilled in the art. Any composition etc. known to a person skilled in the art, in connection with the respective use, can be employed within the context of the present invention by including at least one inventive polymer, preferably at least one polymer in amounts suitable for expressing a certain property within such a composition, especially when such a composition is used in its area of use.

One aspect of the present invention is also the use of the inventive polymers as additives for detergent formulations, particularly for liquid detergent formulations, preferably concentrated liquid detergent formulations, or single mono doses for laundry.

The cleaning compositions of the invention may—and preferably do—contain adjunct cleaning additives (also abbreviated herein as “adjuncts”), such adjuncts being preferably in addition to a surfactant system as defined before.

Suitable adjunct cleaning additives include builders, cobuilders, a surfactant system, fatty acids and/or salts thereof, structurants, thickeners and rheology modifiers, clay/soil removal/anti-redeposition agents, polymeric soil release agents, dispersants such as polymeric dispersing agents, polymeric grease cleaning agents, solubilizing agents, amphiphilic copolymers (including those that are free of vinyl pyrrolidone), chelating agents, enzymes, enzyme stabilizing systems, encapsulated benefit agents such as encapsulated perfume, bleaching compounds, bleaching agents, bleach activators, bleach catalysts, catalytic materials, brighteners, malodor control agents, pigments, dyes, opacifiers, pearlescent agents, hueing agents, dye transfer inhibiting agents, fabric softeners, carriers, suds boosters, suds suppressors (antifoams), color speckles, silver care, anti-tarnish and/or anti-corrosion agents, alkalinity sources, pH adjusters, pH-buffer agents, hydrotropes, scrubbing particles, antibacterial and anti-microbial agents, preservatives, anti-oxidants, softeners, carriers, fillers, solvents, processing aids, pro-perfumes, and perfumes.

All such cleaning compositions, their ingredients including (adjunct) cleaning additives, their general compositions and more specific compositions are known, as for example illustrated in the publications 800542 and 800500 as published by Protegas, Liechtenstein, and also from WO 2022/136409 and WO 2022/136408, wherein in any of the before prior art documents the graft polymer within the general compositions and also each individualized specific cleaning composition disclosed in the beforementioned publications may be replaced partially or completely by the graft polymer of this present invention having the same function. In those beforementioned documents, also various types of formulations for cleaning compositions are disclosed; all such composition types—the general compositions and also each individualized specific cleaning composition—can be equally applied also to those cleaning compositions contemplated herein.

Hence, the present invention also encompasses any and all of such disclosed compositions of the before-mentioned prior art-disclosures but further comprising at least one of the inventive graft polymer in addition to or as a replacement for any already ins such prior art-composition contained polymer or any such compound, which can be replaced by such inventive graft polymer-such replacements known to a person of skill in the art-, with the content of the inventive graft polymer being present in said formulations at a concentration of generally from about 0.01% to about 20%, preferably 0.05 to 10%, more preferably from about 0.1% to 8%, even more preferably from about 0.2% to about 6%, and further more preferably from about 0.2% to about 4%, and most preferably in amounts of up to 2%, each in weight % in relation to the total weight of such composition or product.

It is preferred, that within the respective laundry detergent, cleaning composition and/or fabric and home care product, the at least one graft polymer is present at a concentration of from about 0.01% to about 20%, preferably 0.05 to 10%, more preferably from about 0.1% to 8%, even more preferably from about 0.2% to about 6%, and further more preferably from about 0.2% to about 4%, and most preferably in amounts of up to 2%, each in weight % in relation to the total weight of such composition or product, and all numbers in between, and including all ranges resulting from selecting any of the lower limits mentioned and including further 0.2, 0.3, 0.4, 1, 1,5, 2, 2.5, 3, 3.5 and 4, and combing with any of the upper limits mentioned and including 19, 18, 17, 16, 14, 13, 12, 11, 9, 8, 7, and 6.

The specific embodiments as described throughout this disclosure are encompassed by the present invention as part of this invention; the various further options being disclosed in this present specification as “optional”, “preferred”, “more preferred”, “even more preferred” or “most preferred” options of a specific embodiment may be individually and independently (unless such independent selection is not possible by virtue of the nature of that feature or if such independent selection is explicitly excluded) selected and then combined within any of the other embodiments (where other such options and preferences can be also selected individually and independently), with each and any and all such possible combinations being included as part of this invention as individual embodiments.

The following examples shall further illustrate the present invention without restricting the scope of the invention.

### Example Section

### Polymer Biodegradability

Biodegradation in wastewater was tested in triplicate using the OECD 301F manometric respirometry method. 30 mg/mL test substance is inoculated into wastewater taken from Mannheim Wastewater Treatment Plant and incubated in a closed flask at 25° C. for 28 days. The consumption of oxygen during this time is measured as the change in pressure inside the flask using an OxiTop C (WTW). Evolved CO2 is absorbed using an NaOH solution. The amount of oxygen consumed by the microbial population during biodegradation of the test substance, after correction using a blank, is expressed as a % of the ThOD (Theoretical Oxygen Demand).

The number average molecular weight (Mn), the weight average molecular weight (Mw) and the polydispersity Mw/Mn of the inventive graft polymers can be determined by gel permeation chromatography in dimethylacetamide. The mobile phase (eluent) to be used is dimethylacetamide comprising 0.5 wt % LiBr. The concentration of graft polymer in tetrahydrofuran is 4.0 mg per mL. After filtration (pore size 0.2 μm), 100 μL of this solution are to be injected into the GPC system. Four columns (heated to 60° C.) may be used for separation (PLgel precolumn, 3 Plgel MIXED-E column). The GPC system is operated at a flow rate of 1 mL per min. A DRI Agilent 1100 may be used as the detection system. Poly(ethylene glycol) (PEG) standards (PL) having a molecular weight Mn from 106 to 1 378 000 g/mol may be used for the calibration.

The molecular weights given in the tables are calculated weights unless “Mw” or “Mn” is stated, based on the total molar amounts of ingredients employed for the preparation reaction. As those reactions proceed basically to completeness, this is an acceptable way of calculation the molecular weights

The following backbone are prepared as backbone for inventive graft polymers; their abbreviations of the structures are:
A: 5CL+61EO+5CL
B: 1.5CL+61EO+1.5CL
C: 23 EO+4 CL+neopentylglycol+4 CL+23 EO
D: 20 EO/2 PO+4 CL+neopentylglycol+4 CL+20 EO/2PO
E: 20 EO+1 CL+neopentylglycol+1 CL+20 EO

Abbreviations used: EO=ethylene oxide; CL=epsilon-caprolactame; PO=propylene oxide

### Explanation of Short Description

Backbone of example A=“5CL+61EO+5CL” is identical to “(PEG with 61 EO)+35Caprolacton/OH”=PEG (polyethylene glycol) made from on average 61 moles of EO was first reacted with 3 moles of CL (per hydroxy-end group) and thereafter reacted with 35 moles of EO (per hydroxy-end group formed in the previous step)

### Graft Polymers—General Synthesis According to Process (a)

A polymerization vessel equipped with stirrer and reflux condenser is initially charged with 100 g of the backbone (see table 3) and 100 g of water under a nitrogen atmosphere and heated to 80° C. Dosage of the initiator tert-butyl peroxypivalate (amount see table 1) as 8.0 wt % solution in isopropanole is started with a constant flow for 6:30 h. At the same time the feeds of vinylimidazole, vinylpyrrolidone and a 2.0 wt % aqueous solution of 2-mercaptoethanol (amount see table 1) are started and continued with a constant flow rate for 6:00 h. After completion of the feeds, the reaction mixture is stirred for 2 h at 80° C. The remaining amount of the initiator solution is added within 1 h and the mixture is stirred for 1 h at 80° C. upon complete addition of the feed. The polymer solution is heated to 110° C. and a steam distillation is conducted for 2 h to remove the volatiles. Demineralized water can be added to adjust the desired solid content.

TABLE 1
Amount of tert-butyl peroxypivalate and 2-mercaptoethanol
for inventive examples 1, 2, 4, 5, 9, 10.

| Example | tert-butyl peroxypivalate [g] | 2-mercaptoethanol [g] |
|---|---|---|
| Inv. 1 | 2.3 | 0.50 |
| Inv. 2 | 3.4 | 0.57 |
| Inv. 4 | 2.7 | 0.57 |
| Inv. 5 | 2.2 | 0.47 |
| Inv. 9 | 2.2 | 0.47 |
| Inv. 10 | 2.2 | 0.47 |

### Graft Polymers—General Synthesis According to Process (b)

A polymerization vessel equipped with stirrer and reflux condenser is initially charged with 100 g of the backbone (see table 3) under a nitrogen atmosphere and heated to 90° C. Dosage of the initiator tert-butyl peroxy-2-ethylhexanoate (amount see table 2) as 17 wt % solution in tripropylene glycol is started with a constant flow for 6:10 h. After 0:10 h, the feeds of vinylimidazole, vinylpyrrolidone and vinylacetate are started and continued with a constant flow rate for 6:00 h. After completion of the feeds, the residual amount of the initiator solution is added within 0:56 h and the reaction mixture is stirred for 1 h at 90° C. A vacuum distillation at 90° C. and 40 mbar for 2 h is carried out to remove volatile components. Demineralized water can be added to adjust the desired solid content.

TABLE 2
Amount of tert-butyl peroxy-2-ethylhexanoate
for inventive examples 3, 6, 7, 8.

| Example | tert-butyl peroxy-2-ethylhexanoate [g] |
|---|---|
| Inv. 3 | 1.8 |
| Inv. 6 | 2.0 |
| Inv. 7 | 1.7 |
| Inv. 8 | 1.5 |

TABLE 3
Inventive examples.

| | Backbone | | | Graft | | | |
|---|---|---|---|---|---|---|---|
| | | Molecular | | Type of | | | Biodeg |
| Example | Type | weight g/mol | Wt % | monomer | Wt % | Process | (%) |
| Inv. 1 | A | 3842 | 80 | VI/VP | 10/10 | a | 45 |
| Inv. 2 | A | 3842 | 70 | VI/VP | 20/10 | a | 37 |
| Inv. 3 | A | 3842 | 65 | VAc/VI/VP | 5/15/15 | b | 33 |
| Inv. 4 | B | 3000 | 70 | VI/VP | 20/10 | a | 41 |
| Inv. 5 | B | 3000 | 85 | VI/VP | 7.5/7.5 | a | 55 |
| Inv. 6 | B | 3000 | 70 | VI/VP | 20/10 | b | 36 |
| Inv. 7 | B | 3000 | 85 | VI/VP | 7.5/7.5 | b | 49 |
| Inv. 8 | C | 3040 | 80 | VAc/VI/VP | 5/7.5/7.5 | b | |
| Inv. 9 | D | 3009 | 85 | VI/VP | 7.5/7.5 | a | 34 |
| Inv. 10 | E | 2092 | 85 | VI/VP | 7.5/7.5 | a | 58 |
| Ex. 11*) | F | 4165 | 65 | VAc | 35 | | 54 |

VAc = Vinyl acetate; VI = Vinyl imidazole; VP = Vinyl pyrrolidone.
Note:
(In case of deviations between the backbone description in the tables and the synthesis descriptions hereinafter, the following descriptions prevail.
*)although not inventive due to the definitions of the monomers, this graft polymer shows the advantage in terms of stability over - still und-disclosed - prior art)

### Example 1

### Example 1 a: Polyethylene Glycol (Molecular Weight 600 g/Mol), Ethoxylated with 47.2 Moles Ethylene Oxide

In a 2 l autoclave 222.5 g polyethylene glycol (molecular weight 600 g/mol) and 2.0 g potassium tert. butoxide were placed and the mixture was heated to 80° C. The vessel was purged three times with nitrogen and the mixture was heated to 130° C. 770.0 g ethylene oxide was added within 10 hours. To complete the reaction, the mixture was allowed to post-react for additional 5 hours at 140° C. The reaction mixture was stripped with nitrogen and volatile compounds were removed in vacuo at 80° C. After filtration 990.0 g of a light brown solid was obtained (hydroxy value. 45.8 mgKOH/g).

### Example 1 b

polyethylene glycol (molecular weight 600 g/mol), ethoxylated with 47.2 moles ethylene oxide and modified with 10 moles caprolactone (Backbone A):

In a 4-neck vessel with thermometer, reflux condenser, nitrogen inlet, dropping funnel, and stirrer, 617.9 g polyethylene glycol (molecular weight 600 g/mol), ethoxylated with 47.2 moles ethylene oxide (example 8a) and 0.9 g tin (II) ethylhexanoate were placed and heated to 80° C. 288.8 g epsilon-caprolactone was added within 15 minutes. The reaction mixture was heated to 160° C. and stirred for 12 hours at 160° C. under nitrogen. After cooling to room temperature, 900.0 g of an orange oil was obtained. ¹H-NMR in CDCl3 indicated 99.0% conversion of caprolactone.

### Example 1 c (Graft Polymer)

Example 1 c (Inv. 1) was synthesized according to general process a.

### Example 2 (Graft Polymer)

Example 2 (Inv. 2) was synthesized according to general process a.

### Example 3 (Graft Polymer)

Example 3 (Inv. 3) was synthesized according to general process b.

### Example 4

### Example 4 a

polyethylene glycol (molecular weight 600 g/mol), ethoxylated with 47.2 moles ethylene oxide and modified with 3 moles caprolactone) (Backbone B)

In a 4-neck vessel with thermometer, reflux condenser, nitrogen inlet, dropping funnel, and stirrer, 669.8 g polyethylene glycol (molecular weight 600 g/mol), ethoxylated with 47.2 moles ethylene oxide (example 1a) and 0.8 g tin (II) ethylhexanoate were placed and heated to 80° C. 85.6 g epsilon-caprolactone was added within 15 minutes. The reaction mixture was heated to 160° C. and stirred for 12 hours at 160° C. under nitrogen. After cooling to room temperature, 746.0 g of an orange solid was obtained. ¹H-NMR in CDCl3 indicated 98.0% conversion of caprolactone.

### Example 4 b (Graft Polymer)

Example 4 b (Inv. 4) was synthesized according to general process a.

### Example 5 (Graft Polymer)

Example 5 (Inv. 5) was synthesized according to general process a.

### Example 6 (Graft Polymer)

Example 6 (Inv. 6) was synthesized according to general process b.

### Example 7 (Graft Polymer)

Example 7 (Inv. 7) was synthesized according to general process b.

### Example 8

### Example 8 a

Neopentylglycol, Modified with 8 Moles Caprolactone

In a 4-neck vessel with thermometer, reflux condenser, nitrogen inlet, dropping funnel, and stirrer, 104.1 g neopentyl glycol and 1.0 g tin (II) ethylhexanoate were placed and heated to 140° C. 913.0 g epsilon-caprolactone was added within 15 minutes. The reaction mixture was heated to 160° C. to 205° C. and stirred for 4 hours at 160° C. under nitrogen. After cooling to room temperature, 971.0 g of an light yellow oil was obtained. ¹H-NMR in CDCl3 indicated 99.0% conversion of caprolactone.

### Example 8 b

Neopentylglycol, Modified with 8 Moles Caprolactone and Ethoxylated with 46 Moles Ethylene Oxide) (Backbone C)

In a 2 l autoclave 356.1 g neopentylglycol, modified with 8 moles caprolactone (example 8 a) and 2.01 g potassium tert. butoxide were placed and the mixture was heated to 80° C. The vessel was purged three times with nitrogen and the mixture was heated to 140° C. 709.2 g ethylene oxide was added within 14 hours. To complete the reaction, the mixture was allowed to post-react for additional 5 hours at 140° C. The reaction mixture was stripped with nitrogen and volatile compounds were removed in vacuo at 80° C. 1.1 g acetic acid was added. After filtration 1060.0 g of a light brown solid was obtained. 1H-NMR in CDCl3 confirmed the expected structure.

### Example 8 c (Graft Polymer)

Example 8 c (Inv. 8) was synthesized according to general process b.

### Example 9

### Example 9 a

Neopentylglycol, Modified with 8 Moles Caprolactone and Alkoxylated with a Mixture of 40 Moles Ethylene Oxide and 4 Moles Propylene Oxide (Backbone D)

In a 2 l autoclave 300.0 g neopentylglycol, modified with 8 moles caprolactone (example 8 a) and 1.8 g potassium tert. butoxide were placed and the mixture was heated to 80° C. The vessel was purged three times with nitrogen and the mixture was heated to 140° C. A mixture of 519.6 g ethylene oxide and 68.5 g propylene oxide was added within 14 hours. To complete the reaction, the mixture was allowed to post-react for additional 5 hours at 140° C. The reaction mixture was stripped with nitrogen and volatile compounds were removed in vacuo at 80° C. 0.9 g acetic acid was added. After filtration 880.0 g of a light brown oil was obtained. 1H-NMR in CDCl3 confirmed the expected structure.

### Example 9 b (Graft Polymer)

Example 9 b (Inv. 9) was synthesized according to general process a.

### Example 10

### Example 10 a

Neopentylglycol, Modified with 2 Moles Caprolactone

In a 4-neck vessel with thermometer, reflux condenser, nitrogen inlet, dropping funnel, and stirrer, 156.2 g neopentyl glycol and 0.5 g tin (II) ethylhexanoate were placed and heated to 140° C. 342.4 g epsilon-caprolactone was added within 15 minutes. The reaction mixture was heated to 160° C. and stirred for 2 hours at 160° C. under nitrogen. After cooling to room temperature, 477.0 g of a light yellow oil was obtained. ¹H-NMR in CDCl3 indicated 99.0% conversion of caprolactone.

### Example 10 b

Neopentylglycol, Modified with 2 Moles Caprolactone and Ethoxylated with 40 Moles Ethylene Oxide (Backbone E)

In a 2 l autoclave 149.6 g neopentylglycol, modified with 2 moles caprolactone (example 10 a) and 1.9 g potassium tert. butoxide were placed and the mixture was heated to 80° C. The vessel was purged three times with nitrogen and the mixture was heated to 140° C. 792.0 g ethylene oxide was added within 14 hours. To complete the reaction, the mixture was allowed to post-react for additional 5 hours at 140° C. The reaction mixture was stripped with nitrogen and volatile compounds were removed in vacuo at 80° C. 1.0 g acetic acid was added. After filtration 940.0 g of a light brown oil was obtained. 1H-NMR in CDCl3 confirmed the expected structure.

### Example 10 c (Graft Polymer)

Example 10 c (Inv. 10) was synthesized according to general process a.

### Example 11 (for Comparison of Stability)

### Example 11 a: polyethylene glycol (molecular weight 1500 g/mol), ethoxylated with 44 moles ethylene oxide

In a 2 l autoclave 599.9 g polyethylene glycol (molecular weight 1500 g/mol) and 2.7 g potassium tert. butoxide were placed and the mixture was heated to 80° C. The vessel was purged three times with nitrogen and the mixture was heated to 140° C. 754.2 g ethylene oxide was added within 14 hours. To complete the reaction, the mixture was allowed to post-react for additional 5 hours at 140° C. The reaction mixture was stripped with nitrogen and volatile compounds were removed in vacuo at 80° C. After filtration 1350.0 g of a light brown solid was obtained. 1H-NMR in CDCl3 confirmed the expected structure.

### Example 11 b (Backbone F): polyethylene glycol (molecular weight 1500 g/mol), Ethoxylated with 44 Moles Ethylene Oxide and Modified with 6 Moles Caprolactone

In a 4-neck vessel with thermometer, reflux condenser, nitrogen inlet, dropping funnel, and stirrer, 1044.1 g polyethylene glycol (molecular weight 1500 g/mol), ethoxylated with 44 moles ethylene oxide (example 5a) and 1.25 g tin (II) ethylhexanoate were placed and heated to 90° C.

205.5 g epsilon-caprolactone was added within 15 minutes. The reaction mixture was heated to 160° C. and stirred for 10 hours at 160° C. under nitrogen. After cooling to room temperature, 1236.0 g of an orange oil was obtained. ¹H-NMR in CDCl3 indicated 98.8% conversion of caprolactone.

### Example 11 c (Graft Polymer)

A polymerization vessel equipped with stirrer and reflux condenser was initially charged with Backbone F (455.00 g) under nitrogen atmosphere and heated to 90° C. Feed 1 (2.81 g of tert-Butyl peroxy-2-ethylhexanoate dissolved in 24.76 g of tripropylene glycol) and 10 min upon the start of Feed 1, Feed 2 (245.00 g of vinyl acetate) were started and dosed to the stirred vessel with a variable feed rate of Feed 1 (0:00 h to 00:10 h: 9.20 g/h and 00:10 h to 06:10 h: 4.34 g/h) and a constant feed rate of Feed 2 (00:10 h to 06:10 h: 40.8 g/h). Upon completion of Feed 1 and Feed 2, Feed 3 (1.79 g of tert-Butyl peroxy-2-ethylhexanoate dissolved in 15.72 g of tripropylene glycol) was dosed within 0:56 h with constant feed rate at 90° C. The mixture was stirred for 1:00 h at 90° C. upon complete addition of the feed. The polymerization mixture was heated to 95° C. and a vacuum of 500 mbar was applied to remove the volatiles. The yield was 745 g of a polymer solution.

### Synthesis of Comp. Ex

TABLE 4
Comparative examples.

| | | | | | Weight Ratio of | |
|---|---|---|---|---|---|---|
| | Polymer | Polymer | Polymer | Sidechain | Polymer Backbone to | |
| | Backbone | Backbone | Backbone | Monomers | Sidechain Monomers | Biodegradation |
| Example | Mₙ [g/mol] | % EO | Structure | (B1/B2) | (A):(B1):(B2) | [%], 28 d |
| Comp. | — | — | — | VI/VP | 0:50:50 | 0 |
| Ex. I | | | | | | |
| Comp. | 1500 | 100 | Pure | VI/VP | 20:25:55 | 12 |
| Ex. II | | | PEG | | | |
| Comp | 4000 | 100 | Pure | VI/VP | 60:20:20 | 43 |
| Ex. III | | | PEG | | | |
| Comp | 3000 | 60 | B | VI/VP | 60:20:20 | 41 |
| Ex. IV | | | | | | |
| Comp | 4000 | 100 | Pure | VI/VP | 65:20:15 | 36 |
| Ex. V | | | PEG | | | |
| Comp | 1950 | 50 | 1) | VI/VP | 50:25:25 | 37 |
| Ex. VI | | | | | | |
| Comp. | 6000 | 100 | PEG | VAc/VP | 30*/20 | 15 |
| Ex. VII | | | | | | |

1) Pluronic RPE 1050; 50% EO; PO/EO/PO tri-block copolymer;
*hydrolyzed after polymerization to about 40% of VAc-derived moieties

### Synthesis Procedures for Comparative Examples

### Comp. Ex. I: Copolymer of N-Vinylpyrrolidone and 1-N-Vinylimidazole, Weight Ratio 1:1; K-Value Approximately 30; Obtainable as e.g. Sokalan HP 56 from BASF

### Comp. Ex. II: The Polymer was Prepared as Described in WO03/042264 Example 1

### Comp Ex. III

A polymerization vessel equipped with stirrer and reflux condenser was initially charged with PEG (288.00 g) and water (629.00 g) under nitrogen atmosphere and heated to 80° C. Feed 1 (96.00 g of vinyl imidazole and 96.00 g of vinyl pyrrolidone), Feed 2 (3.20 g of tert-butyl peroxypivalate dissolved in 71.81 g of isopropanol) and Feed 3 (1.92 g of 2-mercaptoethanol in 98.08 g of water), were started simultaneously and dosed to the stirred vessel with constant feed rate in Feed 1 (6:00 h), Feed 2 (6:30 h) and Feed 3 (6:00 h). Upon completion of the feeds the mixture was stirred at 80° C. for 2:00 h. Feed 4 (1.28 g of tert-butyl peroxypivalate dissolved in 28.70 g of isopropanol) was dosed within 1:00 h with constant feed rate at 80° C. The mixture was stirred for 1:00 h at 80° C. upon complete addition of the feed. The polymerization mixture was diluted with 400 g of water and heated to 100° C. Steam distillation was conducted for 1:00 h at 100° C. to remove the volatiles. The yield was 1213 g of polymer solution.

### Comp Ex. IV

A polymerization vessel equipped with stirrer and reflux condenser was initially charged with random EO/PO copolymer (288.00 g) and water (386.00 g) under nitrogen atmosphere and heated to 80° C. Feed 1 (96.00 g of vinyl imidazole and 96.00 g of vinyl pyrrolidone), Feed 2 (3.20 g of tert-butyl peroxypivalate dissolved in 71.81 g of isopropanol) and Feed 3 (1.92 g of 2-mercaptoethanol in 98.08 g of water), were started simultaneously and dosed to the stirred vessel with constant feed rate in Feed 1 (6:00 h), Feed 2 (6:30 h) and Feed 3 (6:00 h). Upon completion of the feeds the mixture was stirred at 80° C. for 2:00 h. Feed 4 (1.28 g of tert-butyl peroxypivalate dissolved in 28.70 g of isopropanol) was dosed within 1:00 h with constant feed rate at 80° C. The mixture was stirred for 1:00 h at 80° C. upon complete addition of the feed. The polymerization mixture was diluted with 600 g of water and heated to 100° C. Steam distillation was conducted for 1:00 h at 100° C. to remove the volatiles. The yield was 1813 g of polymer solution.

### Comp Ex. V

A polymerization vessel equipped with stirrer and reflux condenser was initially charged with PEG (312.00 g) and water (312.00 g) under nitrogen atmosphere and heated to 80° C. Feed 2 (9.60 g of tert-butyl peroxypivalate dissolved in 21.91 g of tripropylene glycol) was started and 10 min upon the start of Feed 2, Feed 1 (96.00 g of vinyl imidazole and 72.00 g of vinyl pyrrolidone) and Feed 3 (1.92 g of 2-mercaptoethanol in 98.06 g of water) were started simultaneously. All Feeds were dosed to the stirred vessel with constant feed rate in Feed 1 (6:00 h), Feed 2 (6:40 h) and Feed 3 (6:00 h). Upon completion of the feeds the mixture was stirred at 80° C. for 2:00 h. Feed 4 (5.12 g of tert-butyl peroxypivalate dissolved in 11.69 g of tripropylene glycol) was dosed within 1:00 h with constant feed rate at 80° C. The mixture was stirred for 1:00 h at 80° C. upon complete addition of the feed. Water (268.10 g) was added and the polymerization mixture was heated to 100° C. Steam distillation was conducted for 1:00 h at 100° C. to remove the volatiles. The yield was 1232 g of polymer solution.

### Comp. Ex. VI

A polymerization vessel equipped with stirrer and reflux condenser was initially charged with EO/PO random copolymer (240.00 g) and water (240.00 g) under nitrogen atmosphere and heated to 80° C. Feed 2 (9.60 g of tert-butyl peroxypivalate dissolved in 21.91 g of tripropylene glycol) was started and 10 min upon the start of Feed 2, Feed 1 (120.00 g of vinyl imidazole and 120.00 g of vinyl pyrrolidone) and Feed 3 (1.92 g of 2-mercaptoethanol in 122.06 g of water) were started simultaneously. All Feeds were dosed to the stirred vessel with constant feed rate in Feed 1 (6:00 h), Feed 2 (6:40 h) and Feed 3 (6:00 h). Upon completion of the feeds the mixture was stirred at 80° C. for 2:00 h. Feed 4 (5.12 g of tert-butyl peroxypivalate dissolved in 11.69 g of tripropylene glycol) was dosed within 1:00 h with constant feed rate at 80° C. The mixture was stirred for 1:00 h at 80° C. upon complete addition of the feed. Water (340.10 g) was added and the polymerization mixture was heated to 100° C. Steam distillation was conducted for 1:00 h at 100° C. to remove the volatiles. The yield was 1232 g of polymer solution.

### Synthesis of Comp. Ex. VII

The polymer was prepared as described in US 2019/0390142 A1 Example 1K.

### Synthesis of Comparative Graft Polymer Comp. Ex. VIII

(following the disclosure of unpublished patent application PCT/EP2022/065983)

Synthesized in a three-step-procedure as follows:

### Step 1: Oxidation of PAG

Polyalkylene oxides with two primary OH end groups (called “diol”) were oxidized to mixtures containing at least a polyalkylene oxide with two COOH end groups (called “diacid”) and a polyalkylene oxide with one primary OH and one COOH end group (called “monoacid”), and, optionally, also remaining polyalkylene oxide with two primary OH end groups. The mixtures were prepared as follows.

Platinum on charcoal (5.0 wt.-% Pt on C, water content: 59.7 wt.-%, 283 g, 29.2 mmol Pt) was suspended in a mixture of polyalkylene oxide comprising two primary OH end groups (details see table 1) and water (details see Table 1), heated to 52° C. and stirred at 800 rpm. Oxygen was passed through the stirred mixture (20 nL/h) via a glass tube, equipped with a glass frit and the temperature was allowed to rise to 60° C. Oxygen dosage and temperature were maintained for the period mentioned in table 1, the oxygen dosage was then stopped and the mixture was allowed to cool down to room temperature. Solids were separated from the liquid phase by filtration and the filter cake was washed with 500 ml of warm water. The washing water was mixed with the filtrate. Water was removed from the liquid mixture by distillation over a wiped film evaporator (overall height: 87.2 cm, diameter: 3.54 cm, wiped height: 43 cm, feed: 4.0 mL/min, 44° C., 1.8 kPa abs, 600 rpm).

TABLE 1
Polymer backbone
Oxidation of PEG

| Descriptor of oxidized PEG | A1 | A2 |
|---|---|---|
| Typ^{#1} and molecular average molecular | EO600 | EO600 |
| weight M_{w} [g/mol] of polyalkylene oxide | | |
| Number average of number of ether groups | 12 | 12 |
| Amount of polyalkylene oxide [g] | 1500 | 1750 |
| Amount of water [g] | 3500 | 4083 |
| Oxidation time [h] | 72 | 8 |
| Ratio of oxidized OH groups [%]^{#2} | >99^{#2} | 51^{#2} |
| Acid number [mg KOH/g] | 55 | 28 |
| Physical property | solid | solid |

^{#1}EO = polyethylene oxide
^{#2}Calculated on basis of acid number of the reaction solution

### Step 2: Esterification

A mixture of polyalkylene oxides (see table 2) obtained by the oxidation of the diol (see table 1) and the esterification catalyst (see table 2) were mixed and heated for a period of time mentioned in Table 2 under vacuum at a pressure of 1 kPa abs at a temperature of 135° C.

TABLE 2
Esterification to PEG-Ester

| Polymer backbone descriptor | B1 |
|---|---|
| Educt | A1 (76.0 g) + |
| | A2 (1100 g) |
| Esterification catalyst ^{#1} | 0.83 wt.-% |
| | TIB Kat 620^{#2} |
| Reaction time [h] | 72 |
| K-value^{#2} | 20.2 |

Annotation to Polymer backbone-Table 2:
^{#1} cat = Zn-octanoate
^{#2}K-value measures the relative viscosity of dilute polymer solutions and is a relative measure of the average molecular weight. As the average molecular weight of the polymer increases for a particular polymer, the K-value tends to also increase. The K-value is determined in a 3% by weight NaCl solution at 23° C. and a polymer concentration of 1% polymer according to the method of H. Fikentscher in “Cellulosechemie”, 1932, 13, 58.

### Step 3: Synthesis of Comparative Graft Polymer 1

The polymer backbone B1 (350.0 g) is dosed in a vessel equipped with a stainless-steel anchor stirrer (and 2 other necks) and heated to 95° C. 1.00 g of a 14 wt % solution of t-butylperoxy-2-ethylhexanoate in tripropylene glycol was added within 1 min. Afterwards, the dosage of vinyl-acetate (350.0 g) was started and continued over 7.5 h with constant feed rate. At the same time the Initiator solution (50.0 g) t-butylperoxy-2-ethylhexanoate was dosed as a 14 wt % solution in tripropylene glycol with a constant feed rate within 8.5 h. For completion of the reaction, the mixture is stirred for another 180 minutes. Finally, volatile components were stripped for 90 minutes at 120° C. with nitrogen at a feed rate of 6 L N₂/h.

### Stability of Graft Polymer on Inventive Backbone*) Vs Comparative Graft Polymer

(*) although outside the monomer definitions and thus “not inventive” as such)

Aqueous solutions of the inventive graft polymer 11 and comparative polymer 1 (9 wt %) were prepared and the mixtures were stored at 54° C. for two weeks.

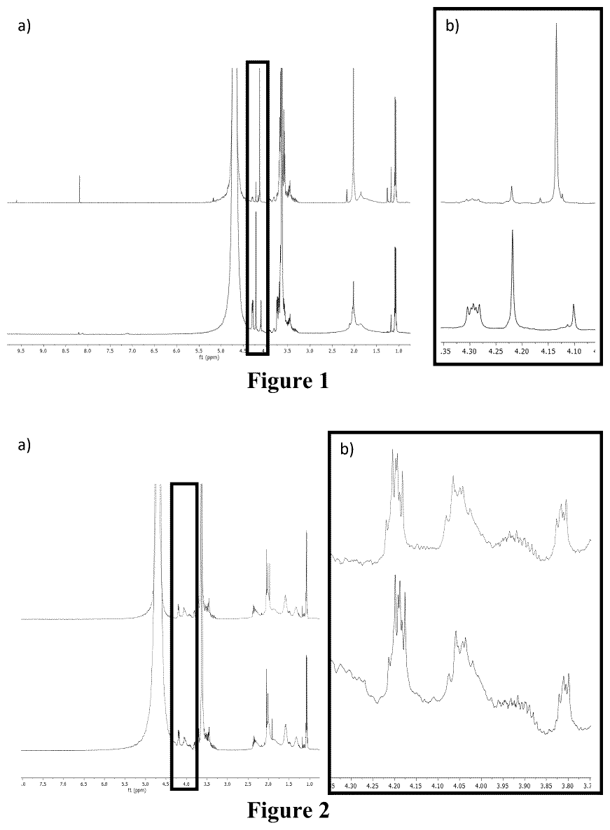

A brown precipitate was formed during storage of the comparative graft polymer 1. Recorded ¹H NMR (298 K, D₂O, 400 MHZ) spectra of the precipitate and the solution showed no differences. The comparison of the 1H NMR spectra of the fresh and the stored sample of comparative graft polymer showed significant rearrangements of the 1H NMR shifts in the regions of 4.0 to 4.35 ppm (typical for PEG-Ester bonds) and 1.8 to 2.2 ppm (typical for bound/non bound acetate) as shown in FIG. 1.

The comparison of ¹H NMR spectra (298 K, D₂O, 400 MHZ) of the fresh and the stored samples of inventive graft polymer (Inv. 5) showed no significant rearrangements in the spectra as shown in FIG. 2.

The results clearly demonstrate better hydrolysis instability from polymers based on inventive backbones.

### Performance Tests of Graft Polymer

Performance evaluations of the graft polymers can be obtained by laundry- and cleaning-experiments. Laundry experiments can be performed in washing machines or alternatively in equipment to perform model laundry experiments like Launderometer or Tergotometer.

### Evaluation of DTI Performance (Laundry Experiments)

### Wash Results:

Selected color fabric (EMPA 130 and EMPA 133 as dye donor) was washed at 60° C. in the presence of white test fabric and polyester ballast fabric with addition of the dye transfer inhibitor. The liquid detergent based upon a mixture of anionic and noninonic surfactants (LAS; AES, AEO). After the wash cycle, the fabric was rinsed, spun and dried. In order to determine the dye transfer inhibiting effect, the staining of the white test fabric was ascertained photometrically. The color values in L*a*b was determined with a Colour Consult b.v., Mach 5+, a camera-based multispectral color measurement instrument. Color Shift calculated in ΔΔE.

Composition of the liquid detergent (“ES1_C”)

| Ingredient | [% by weight] |
|---|---|
| Linear dodecylbenzenesulfonic acid | 5.5 |
| C12C14 fatty alcohol ether sulfate, Na salt | 5.4 |
| C13C15 oxo process alcohol with 7 EO | 5.4 |
| Coconut fatty acid K 12-18 | 2.4 |
| 1,2 propylene glycol | 6.0 |
| Ethanol | 2.0 |
| NaOH | 2.2 |
| Sodium citrate | 3.0 |
| DTI additive | 0.5/1.0 active material |
| Water | to 100 |

DTI-additive/DTI polymer=at least one graft polymer of this invention

Wash conditions

| Machine | Launder-o-meter, LP2 type, SDL Atlas Inc., USA | |
|---|---|---|
| Detergent dosage | 1.7 | g/L |
| Wash liquor | 250 ml water | |
| Water hardness | Ca²⁺:Mg²⁺:HCO3⁻ 4:1:8 | |
| Wash cycle | 1 | |
| Fabric/liquor ratio | 1:12.5 | |
| Wash duration | 20 | min |
| Wash temperature | 60° | C. |

| | |
|---|---|
| Color fabric | 1 g EMPA 130 |
| | 1 g EMPA 133 |
| Test fabric | 10 g wfk 10 A |
| | 5 g wfl 20 A |
| Ballast fabric | 5 g wfk 30 A, polyester fabric |

### Explanation of Abbreviations in Previous Table

wfk 10 A: cotton fabric
wfk 20 A: polyester-cotton fabric
EMPA 130: cotton fabric dyed with Direct Red 83.1
EMPA 133: cotton fabric dyed with Direct Blue71

Wash result for EMPA 130 color fabric (red colour) (evaluation in ΔΔE=ΔE (without)−ΔE (polymer))

| | Dosage DTI (two examples | ΔΔE | ΔΔE |
|---|---|---|---|
| | per DTI-polymer) | wfk 10 A | wfk 20 A |
| No DTI | | 0.0 | 0.0 |
| Comp. Ex I | 0.5 wt. % | 12.00 | 10.50 |
| | 1.0 wt. % | 12.24 | 10.65 |
| Comp. Ex. VII | 0.5 wt. % | 0.16 | −0.14 |
| | 1.0 wt. % | 0.45 | 0.65 |
| Ex: 2 | 0.5 wt. % | 7.96 | 6.53 |
| | 1.0 wt. % | 8.28 | 6.77 |
| Ex. 3 | 0.5 wt. % | 7.81 | 6.19 |
| | 1.0 wt. % | 8.19 | 6.51 |
| Ex. 7 | 0.5 wt. % | 8.06 | 7.05 |
| | 1.0 wt. % | 8.72 | 7.27 |
| Ex. 6 | 0.5 wt. % | 8.98 | 7.09 |
| | 1.0 wt. % | 9.41 | 7.22 |
| Ex. 5 | 0.5 wt. % | 8.03 | 7.09 |
| | 1.0 wt. % | 8.68 | 7.39 |
| Ex. 4 | 0.5 wt. % | 8.95 | 7.40 |
| | 1.0 wt. % | 9.35 | 7.35 |
| Ex. 8 | 0.5 wt. % | 10.48 | 7.65 |
| | 1.0 wt. % | 11.14 | 8.26 |
| Ex. 9 | 0.5 wt. % | 7.73 | 7.00 |
| | 1.0 wt. % | 8.32 | 7.30 |
| Ex. 1 | 0.5 wt. % | 7.42 | 6.77 |
| | 1.0 wt. % | 8.01 | 7.20 |
| Ex. 10 | 0.5 wt. % | 7.27 | 7.05 |
| | 1.0 wt. % | 7.80 | 7.34 |

Wash result for EMPA 133 color fabric (blue color) (evaluation in ΔΔE=ΔE (without)−ΔE (polymer))

| | Dosage DTI (two examples | ΔΔE | ΔΔE |
|---|---|---|---|
| | per DTI-polymer) | wfk 10 A | wfk 20 A |
| No DTI | | 0.0 | 0.0 |
| Comp. Ex I | 0.5 wt. % | 20.44 | 18.35 |
| | 1.0 wt. % | 22.49 | 19.24 |
| Comp. Ex. VII | 0.5 wt. % | 4.11 | 4.48 |
| | 1.0 wt. % | 5.66 | 7.19 |
| Ex. 2 | 0.5 wt. % | 8.80 | 8.72 |
| | 1.0 wt. % | 15.50 | 14.89 |
| Ex. 3 | 0.5 wt. % | 8.37 | 9.19 |
| | 1.0 wt. % | 15.24 | 14.76 |
| Ex. 7 | 0.5 wt. % | 3.63 | 4.78 |
| | 1.0 wt. % | 7.24 | 8.71 |
| Ex. 6 | 0.5 wt. % | 8.77 | 10.40 |
| | 1.0 wt. % | 16.42 | 15.54 |
| Ex. 5 | 0.5 wt. % | 2.75 | 4.55 |
| | 1.0 wt. % | 5.76 | 8.61 |
| Ex. 4 | 0.5 wt. % | 9.73 | 9.96 |
| | 1.0 wt. % | 16.78 | 16.00 |
| Ex. 8 | 0.5 wt. % | 3.45 | 3.00 |
| | 1.0 wt. % | 8.11 | 7.53 |
| Ex. 9 | 0.5 wt. % | 6.49 | 6.12 |
| | 1.0 wt. % | 10.88 | 10.97 |
| Ex. 1 | 0.5 wt. % | 3.75 | 3.30 |
| | 1.0 wt. % | 11.17 | 11.10 |
| Ex. 10 | 0.5 wt. % | 2.55 | 2.97 |
| | 1.0 wt. % | 6.61 | 6.82 |

### For Comparative Polymers Comp. Ex. I to Comp. Ex. VI—Further Set of Washing Examples

Selected color fabric (EMPA 130 and EMPA 133 as dye donor) was washed at 60° C. in the presence of white test fabric and polyester ballast fabric with addition of the dye transfer inhibitor. The liquid detergent based upon a mixture of anionic and noninonic surfactants (LAS; AES, AEO). After the wash cycle, the fabric was rinsed, spun and dried. In order to determine the dye transfer inhibiting effect, the staining of the white test fabric was ascertained photometrically. The reflectance was determined with a Datacolor photometer (Elrepho 2000) at 520 nm (EMPA 130) or at 600 nm (EMPA 133).

Composition of the liquid detergent

| Ingredient | [% by weight] |
|---|---|
| Linear dodecylbenzenesulfonic acid | 5.5 |
| C12C14 fatty alcohol ether sulfate, Na salt | 5.4 |
| C13C15 oxo process alcohol with 7 EO | 5.4 |
| Coconut fatty acid K 12-18 | 2.4 |
| 1,2 propylene glycol | 6.0 |
| Ethanol | 2.0 |
| NaOH | 2.2 |
| Sodium citrate | 3.0 |
| DTI additive | 0.5/1.0 active material |
| Water | to 100 |

Wash conditions

| Machine | Launder-o-meter, LP2 type, SDL Atlas Inc., USA | |
|---|---|---|
| Detergent dosage | 4 | g/L |
| Wash liquor | 250 ml water | |
| Water hardness | Ca²⁺:Mg²⁺:HCO3⁻ 4:1:8 | |
| Wash cycle | 1 | |
| Fabric/liquor ratio | 1:12.5 | |
| Wash duration | 20 | min |
| Wash temperature | 60° | C. |

| | |
|---|---|
| Color fabric | 1 g EMPA 130 |
| | 1 g EMPA 133 |
| Test fabric | 10 g wfk 10 A |
| | 5 g wfl 20 A |
| Ballast fabric | 5 g wfk 30 A, polyester fabric |

### Explanation of Abbreviations in Previous Table

wfk 10 A: cotton fabric, reflectance 83.4% (520 nm), 84.5% (600 nm)
wfk 20 A: polyester-cotton fabric, reflectance 83.8% (520 nm), 83.3% (600 nm)
EMPA 130: cotton fabric dyed with Direct Red 83.1
EMPA 133: cotton fabric dyed with Direct Blue71
Manufacturer/supplier: wfk Testgewebe GmbH, Bruggen, Germany; EMPA Testmaterialien AG, Sankt Gallen, Switzerland

Wash result for EMPA 130 and EMPA 133 color fabric (evaluation of % reflectance)

Wash result for EMPA 130 and EMPA 133 color fabric (evaluation of % reflectance)

| | Dosage | % | % | % | % |
|---|---|---|---|---|---|
| | DTI (two | reflectance | reflectance | reflectance | reflectance |
| | examples | wfk 10 A | wfk 20 A | wfk 10 A | wfk 20 A |
| | per DTI- | (washed with | (washed with | (washed with | (washed with |
| | polymer) | EMPA 130) | EMPA 130) | EMPA 133) | EMPA 133) |
| No DTI | | 66.0 | 68.9 | 45.5 | 49.5 |
| Comp. Ex. I | 0.5 wt. % | 82.7 | 82.2 | 79.2 | 80.4 |
| | 1.0 wt. % | 82.9 | 82.2 | 82.2 | 81.6 |
| Comp. Ex. II | 0.5 wt. % | 66.2 | 69.2 | 48.5 | 54.9 |
| | 1.0 wt. % | 66.3 | 69.4 | 49.9 | 55.5 |
| Comp Ex. III | 0.5 wt. % | 81.5 | 82.4 | 71.7 | 75.2 |
| | 1.0 wt. % | 82.4 | 82.9 | 81.0 | 81.5 |
| Comp Ex. IV | 0.5 wt. % | 81.3 | 82.2 | 72.1 | 74.7 |
| | 1.0 wt. % | 82.8 | 82.8 | 78.8 | 78.6 |
| Comp Ex. V | 0.5 wt. % | 84.39 | 82.58 | 66.52 | 71.65 |
| | 1.0 wt. % | 84.72 | 82.53 | 78.84 | 79.31 |
| Comp Ex. VI | 0.5 wt. % | 84.11 | 81.08 | 70.83 | 68.02 |
| | 1.0 wt. % | 84.52 | 81.44 | 79.24 | 79.60 |

1. A graft polymer consisting of:
(A) 20 to 95%, preferably 50 to 90%, more preferably 60 to 90%, even more preferably 65 to 85%, most preferably 70 bis 85% of a polymer backbone as a graft base,
which comprises at least one sub-unit (a1) and at least one sub-unit (a2), wherein
(a1) is a unit comprising, preferably essentially consisting of, moieties derived from at least one alkylene oxide monomer and/or at least one polyalkylene oxide-polymer having two hydroxy-end-groups, the alkylene oxide monomer selected from the group of C2- to C10-alkylene oxides, preferably C2 to C5-alkylene oxides,
(a2) is a unit comprising, preferably consisting of, moieties derived from at least one lactone and/or at least one hydroxy acid, such sub-unit (a2) being a moiety derived from a single lactone and/or hydroxy-acid or being oligo-or-polymeric units consisting of at least one type of lactone and/or at least one type of hydroxy acid,
wherein preferably the at least one lactone and/or hydroxy acid is/are selected from the groups i) and/or ii), with
i) lactone(s), i.e. cyclic esters, starting with α-lactone (three ring atoms) followed by β-lactone (four ring atoms), γ-lactone (five ring atoms) and so on; such lactones preferably being β-propiolactone, g-butyrolactone, δ-valerolactone, g-valerolactone, e-caprolactone, d-decalactone, g-decalactone, e-decalactone; preferably caprolactone;
and
ii) hydroxy acid(s), which may be derived from any lactone by hydrolyzation, specifically from any lactone within group i) before, specifically an α-, β- or γ-hydroxy acid derived from the corresponding lactone by hydrolyzation, and lactic acid, glycolic acid, 4-hydroxybutanoic acid, 6-hydroxy hexanoic acid, 12-hydroxy stearic acid, citric acid;
preferably lactic acid or caprolactone, more preferably caprolactone,
wherein the polymer backbone is
a) obtained
(A1) by co-polymerization of at least one sub-unit (a1) and at least one sub-unit (a2), wherein optionally at least one oligomer or polymer made from at least one sub-unit (a1) or at least one sub-unit (a2) can be employed within the copolymerization of at least one sub-unit (a1) and at least one sub-unit (a2) as well;
(A2) by first oligo-/polymerizing sub-unit(s) (a2) and then polymerizing the product with sub-unit(s) (a1); or
(A3) By first oligo-/polymerizing sub-unit(s) (a1) and then co-polymerizing the product with sub-unit(s) (a2);
(A4) by first providing an oligo- or polymeric sub-unit (a1) which is bears an end-cap on one side, preferably is etherified with alcohols, more preferably short-chain alcohols C1 to C4, which—as starter-block—is thereafter reacted with at least one sub-unit (a2) and optionally at least one sub-unit (a1)—wherein the sub-unit (a1) may be different to that/those in the starter block or may be arranged in a different order compared to those in the starter block—to attach to the non-end capped side of the starter block a new block comprising moieties from the sub-units employed for the (co-) polymerization, thereby obtaining a di-block-structure of [end-cap]-[sub-unit(s) (a1)]-[sub-unit(s) (a2)], or [end-cap]-[sub-unit(s) (a1)]-[random-{sub-unit(s) (a2)-sub unit(s) (a1)}];
wherein in case more than one sub-unit (a1) and/or more than one sub-unit (a2) are present already in an employed oligomer or polymer, those sub-units can be arranged in any order within such employed oligomer or polymer, and
wherein in case more than one sub-unit (a1) and/or more than one sub-unit (a2) are present for the polymerization, those sub-units (and the optional oligomer/polymers if employed) can be arranged in any order within the obtained backbone;
and wherein in case of (A1), (A2) and (A3) the use of a starter molecule is optional;
b) selected from
(A1) a backbone consisting of a randomly arranged order of monomeric, oligomeric and/or polymeric (a1)-sub-units and monomeric, oligomeric and/or polymeric (a2)-sub-units, with more than one sub-unit (a1) and/or more than one sub-unit (a2) being present;
(A2) a backbone consisting of oligo- or polymerized sub-units (a2) as an inner block and two outer blocks of oligomeric and/or polymeric (a1)-sub-units, defined as “-[block of (a1)]-[block of (a2)]-[block of (a1)]-”, and also possibly comprising higher block-polymers such as 5-, 7- and 9-etc. blocks where at the outside of the tri-block structure further blocks of (a1) and (a2) are connected, such as a penta-block “[block of (a1)]-[block of (a2)]-[block of (a1)]-[block of (a2)]-[block of (a1)]-[block of (a2)]-[block of (a1)]” and so on; and
(A3) a backbone consisting of and inner block of oligomeric and/or polymeric (a1)-sub-units and two outer blocks of oligo- or polymeric sub-units (a2), in the form of at least an tri-block-polymer defined as “-[block of (a2)]-[block of (a1)]-[block of (a2)]-”,
(A4) a backbone consisting of
a first block with
(i) on one end an end-cap-such end-cap being a C1 to C18-, preferably C1-C4-alkyl-group attached to said first block via an ether-function; and
(ii) an oligo- or polymeric sub-unit (a1); and
a second block which is attached to said first block at the opposite end of said first block (“opposite” in relation to the end-cap on said first block) via an ether or ester-function, said second block being composed of at least one sub-unit (a2) and optionally at least one sub-unit (a1), wherein the optional sub-unit(s) (a1) in said second block may be different to that/those in the first block or may be arranged in a different order compared to those in the first block, and the order of the sub-unit(s) (A1) and (a2) may be also in any order, including random structure,
such di-block-structure having as an idealized structure in case of using only sub-unit(s) (a2) for the second block: [end-cap]-[sub-unit(s) (a1)]-[sub-unit(s) (a2)] or in case of using sub-unit(s) (a1) and (a2) for the second block: [end-cap]-[sub-unit(s) (a1)]-[random-{sub-unit(s) (a2)-sub unit(s) (a1)}];
and wherein in case of (A1), (A2) and (A3) the use of a starter molecule is optional;
and
(B) 5 to 80%, preferably 10 to 50%, more preferably 10 to 40%, even more preferably 15 to 35 and most preferably 15 to 30%, of polymeric sidechains (B) grafted onto the polymer backbone (A), wherein said polymeric sidechains (B) are obtainable by (co-) polymerization of
optionally (B1) at least one vinyl ester monomer,
at least one, preferably a least two nitrogen-containing monomer (B2), and
optionally further monomer(s) (B3), and optionally further monomers,
with all percentages as weight percent in relation to the total weight of the graft polymer.

2. The graft polymer according to claim 1, wherein at least two different alkylene oxides are employed for the preparation of the backbone/are present in the backbone; and/or
wherein the monomers are selected from:
(B1) optionally at least one vinyl ester, selected from vinyl acetate, vinyl propionate and/or vinyl laurate and any further vinylester known to a person skilled in the art, such as vinyl valerate, vinyl pivalate, vinyl neodecanoate, vinyl decanoate and/or vinyl benzoate;
(B2) at least one, preferably at least two nitrogen-containing monomer being selected from the group consisting of vinyllactames, vinyl imidazoles, 1-vinyltriazole, 4-vinylpyridine, 4-vinylpyridine-N-oxide, 2-vinylpyridine, 1-vinyloxazolidinone, N-vinylformamide, N-vinylacetamide, N-vinyl-N-methylacetamide, and acrylamides such as acrylamide, methacrylamide, N-alkyl-substituted acrylamides, N,N′-di alkyl (meth) acrylamide; mono- and dialkylamino-alkyl-(meth)acrylates, being preferably a vinyllactame-monomer and/or a vinylimidazole-monomer, the vinyllactam being more preferably selected from N-vinyllactams, such as N-vinylpyrrolidone, N-vinylpiperidone, N-vinylcaprolactam, even more preferably N-vinylpyrrolidone, N-vinylcaprolactam, and most preferably N-vinylpyrrolidone, and the vinylimidazole being preferably N-vinyl imidazole, 2-methyl-1-imidazole, more preferably N-vinyl imidazole;
optionally
(B3) at least one further monomer, such as any one or more of 1-vinyl oxazolidinone and other vinyl oxazolidinones, 4-vinyl pyridine-N-oxide, N-vinyl formamide and its amine if hydrolyzed after polymerization, N-vinyl acetamide, N-vinyl-N-methyl acetamide, alkyl esters of (meth)acrylic acid; and
optionally
at least one further monomer, being different from those before, such other monomer being present only in an amount of less than 2% of the total amount of monomers employed for obtaining the polymeric sidechains (B), and are preferably present only as impurities but not deliberately added for polymerization.

3. The graft polymer according to claim 1, wherein the amount of
(B) is 10 to 40%, more preferably 15 to 35 and most preferably 15 to 30%;
(B1) (vinylester) in weight percent being based on the total weight of the graft polymer is from 0 to 20%, preferably up to 15, more preferably up to 10, even more preferably up to 5%;
(B2) (nitrogen-containing monomer) in weight percent being based on the total WEIGHT OF THE GRAFT POLYMER is from 10 to 40%, preferably up to 35, more preferably up to 30, even more preferably up to from 25, and most preferably up to 20, and more preferably at least 15,
and—more preferably—
(B2a) vinyl imidazole-monomer, preferably N-vinylimidazole, is from 20 to 80, preferably from 30 to 70, most preferably from 40 to 60%, each in weight percent based on total weight of (B2); and
(B2b) vinyl lactame-monomer, preferably N-vinylpyrrolidone, is equal to [the total amount of (B2) minus (B2a)];
And further provided that (B3) (further monomer) is from 0 to 5, preferably at most 2, more preferably at most 1, even more preferably about 0 based on the total WEIGHT OF THE GRAFT POLYMER, but in all cases at most 10 wt. % of the amount of (B2).

4. The graft polymer according to claim 1, wherein
at least 10 weight percent of the total amount of the optional vinyl ester monomer (B1) is selected from vinyl acetate, vinyl propionate and vinyl laurate, more preferably from vinyl acetate and vinyl laurate, and most preferably vinyl acetate, and wherein the remaining amount of vinyl ester may be any other known vinyl ester, wherein preferably at least 80, more preferably at least 90 weight percent, and most preferably essentially only vinyl acetate is employed as vinyl ester (weight percent being based on the total weight of vinyl ester monomers B1 being employed).

5. The graft polymer according to claim 1, wherein
(A) the polyalkoxylate-ester backbone comprises moieties derived from
(i) alkylene oxides (AO) comprising at least one of ethylene oxide (EO), propylene oxide (PO), and butylene oxide (BO), preferably at least one of EO and PO,
with the AO in an amount of from 40 to 99, preferably up to 90, and preferably from 50, more preferably from 60, and even more preferably from 70 wt %, and any number and range in between, each based on the total weight of the backbone,
the amount of EO being of from 0 to 100 wt. %, preferably from 10, more preferably from 20, even more preferably from 30, even more preferably from 40, such as from 50, 60, 70, 80 or even from 90 wt %, based on total AO,
the PO and/or BO, in an total amount of each from 0 to 100 wt. %, preferably up to 90, more preferably up to 80, even more preferably up to 70, even more preferably up to 60, and most preferably up to 50, and any number in between such as up to 5, 10, 15, 25, 30, 35, 40, 45, 55, 65, 75, 85 or up to 95, and more preferably from 10, even more preferably from 20, even further more preferably from 30, such as from 40, 50, 60, 70, 80 or even from 90 wt %, each based on the total weight of AO, with the total amount of PO and BO adding up to 100 wt. % for the sum of PO and BO,
with the total amount of AO adding up to 100 wt. %;
(ii) lactone/hydroxy acid monomer in an amount of from 1 and up to 60, preferably up to 50, more preferably up to 40, most preferably up to 30 wt. %, and preferably from 2, more preferably from 3, even more preferably from 4 and most preferably from 5 wt. %, each based on the total weight of the backbone, preferably only caprolactone;
with the total weight of the sum of sub-units (a1) and sub-units (a2) in the backbone (A) adding up to 100 wt %.

6. The graft polymer according to claim 5, wherein either α) or β) applies:
α)
(i) alkylene oxides (AO) is selected from ethylene oxide (EO), propylene oxide (PO), and butylene oxide (BO), preferably only EO and PO,
with the AO in an amount of from 40 to 99, preferably up to 90, and preferably from 50, more preferably from 60, and even more preferably from 70 wt %, and any number and range in between, each based on the total weight of the backbone,
the amount of EO being of from 10 to 90, preferably 20 to 80, more preferably 30 to 70, and most preferably 40 to 60 wt %, based on total AO,
the total amount of PO and BO being from 10 to 90, preferably 20 to 80, more preferably 30 to 70, and most preferably 40 to 60 wt %, each based on the total weight of AO, with the total amount of PO and BO adding up to 100 wt. % for the sum of PO and BO, and with the total amount of AO adding up to 100 wt. %;
(ii) lactone/hydroxy acid monomer in an amount of from 1 and up to 60, preferably up to 40, more preferably up to 30, even more preferably up to 25, even further more preferably up to 20, and most preferably up to 15 wt. %, and preferably from 2, more preferably from 3, even more preferably from 4 and most preferably from 5 wt. %, each based on the total weight of the backbone, preferably only caprolactone;
with the total weight of the sum of sub-units (a1) and sub-units (a2) in the backbone (A) adding up to 100 wt %;
or β)
(i) alkylene oxides (AO) is selected from ethylene oxide (EO), propylene oxide (PO), and butylene oxide (BO), preferably only EO and PO, more preferably only EO
the amount of EO being of from 20 to 100 wt %, based on total AO,
the total amount of PO and BO being from 0 to 80 wt. %, preferably up to 50, more preferably up to 30, even more preferably up to 20, and even further preferably up to 10, and most preferably zero, such as 45, 45, 45, 25, 15, 7 and 5, and any number in between, each based on the total weight of AO, with the total amount of PO and BO adding up to 100 wt. % for the sum of PO and BO,
with the total amount of AO adding up to 100 wt. %;
(ii) lactone/hydroxy acid monomer in an amount of from 5 and up to 50, preferably up to 40, more preferably up to 35, and even more preferably up to 30, and as lower limit preferably from 7, more preferably from 10, even more preferably from 12 wt %, and most preferably from 15, such as 6, 8, 9, 11, 12, 13, 14 and 15 and any number in between as lower limit and such as 30, 33, 37, 45 and any number in between as upper limit, based on the total weight of the backbone, preferably only caprolactone;
with the total weight of the sum of sub-units (a1) and sub-units (a2) in the backbone (A) adding up to 100 wt %.

7. The graft polymer according to claim 1, wherein (I) or (II) applies:
(I), wherein
(B) is 15 to 30%; and the monomers are:
(B1) (vinylester) is not present
(B2) (nitrogen-containing monomer) is
(B2a) N-vinylimidazole, is from 40 to 60%, in weight percent based on total weight of (B2); and
(B2b) N-vinylpyrrolidone, is equal to [the total amount of (B2) minus (B2a)];
(B3) and further monomers being essentially not present;
or (II), wherein
(B) is 15 to 30%; and the monomers are:
(B1) being vinyl acetate, from 5 to 10% in weight percent being based on the total weight of the graft polymer;
(b2) (nitrogen-containing monomer) in weight percent being based on the total weight of the graft polymer is from 10 to 25%, with
(B2a) being N-vinylimidazole, is from 40 to 60%, in weight percent based on total weight of (B2); and
(B2b) vinyl lactame-monomer, preferably N-vinylpyrrolidone, is equal to [the total amount of (B2) minus (B2a)];
(B3) and further monomers being essentially not present.

8. The graft polymer according to claim 1, wherein
wherein at least one of i), ii) and iii) is fulfilled:
i) the polymer backbones (A1), (A2) and (A3) may bear as the end-groups two hydroxy-groups or may be capped with C1 to C22-alkyl groups, preferably C1 to C4 alkyl groups;
such end-group being attached using standard means after final preparation of the backbone whereas for (A4) such end-cap is done on the oligo-/polymeric sub-unit (a1) prior to the polycondensation employing sub-unit(s) (a2);
ii) the graft polymer has a polydispersity (PDI) Mw/Mn of at most 10, preferably at most 5, more preferably at most 3, and most preferably in the range from 1.0 to 2.6, and any number a as upper or lower limit and any range in between such as 1.3 to 2.6, 1 to 3 etc. (with Mw=weight average molecular weight and Mn=number average molecular weight [g/mol/g/mol]);
iii) the biodegradability of the graft polymer is at least 35, more preferably at least 40, even more preferably at least 45, even further more preferably at least 50, such as 46, 47, 48, 49, 50, 55, 60, 65, 70, 75 etc. and any number in between and up to 100%, within 28 days, when tested under OECD 301F.

9. A process for obtaining a graft polymer according to claim 1, comprising the step of polymerizing at optionally least one vinyl ester monomer (B1), at least one, preferably at least two nitrogen-containing monomer (B2), and optionally further monomer(s) (B3) and further optionally including further monomer(s) as impurities within (B1), (B2) and/or (B3) is/are polymerized in the presence of at least one polymer backbone (A), wherein the polymeric sidechains (B) are obtained by radical polymerization, preferably using radical forming compounds to initiate the radical polymerization.

10. The process according to claim 9, comprising the polymerization of the monomers (B) in the presence of at least one polymer backbone (A), preferably selected from backbones (A1), (A2), (A3) and (A4), a free radical-forming initiator (C) and, optionally, up to 50% by weight, based on the sum of components (A), (B), and (C), of at least one solvent (D), at a mean polymerization temperature at which the initiator (C) has a decomposition half-life of from 40 to 500 min, in such a way that the fraction of unconverted graft monomers optional (B1), (B2) and optional (B3) and initiator (C) in the reaction mixture is constantly kept in a quantitative deficiency relative to the polymer backbone (A), wherein-if (B1) is employed-preferably at least 10 weight percent of the total amount of vinyl ester monomer (B1) is selected from vinyl acetate, vinyl propionate and vinyl laurate, more preferably from vinyl acetate and vinyl laurate, and most preferably vinyl acetate, and wherein the remaining amount of vinyl ester may be any other known vinyl ester, wherein preferably at least 60, more preferably at least 70, even more preferably at least 80, even more preferably at least 90 weight percent, and most preferably essentially only (i.e. about 100 wt. % or even 100 wt. %) vinyl acetate is employed as vinyl ester (weight percent being based on the total weight of vinyl ester monomers B1 being employed), and—preferably—the amounts of monomers are those as of any of the claims before listing such amounts, and wherein the monomers and amounts are preferably those of claim 7.

11. The process according to claim 7, wherein the process comprises at least one further process step selected from i) to iv):
i) Post-polymerisation; ii) Purification; iii) Concentration; and iv) Drying.

12. The process according to claim 9, wherein the process comprises at least one further process step selected from:
i) a post-polymerization process step that is performed after the main polymerization reaction, wherein preferably a further amount of initiator (optionally dissolved in the solvent(s)) is added over a period of 0.5 hour and up to 3 hours, preferably about 1 to 2 hours, more preferably about 1 hour, with the radical initiator and the solvent(s) for the initiator typically—and preferred—being the same as the ones for the main polymerization reaction; and wherein after the polymerization reaction and before the post-polymerisation reaction preferably a period is waited when the main polymerization reaction is left to proceed, before the post-polymerisation reaction is started by starting the addition of further radical initiator, such period being preferably from 10 minutes and up to 4 hours, preferably up to 2 hours, even more preferably up to 1 hour, and most preferably up to 30 minutes; and wherein the temperature of the post-polymerisation process step is-preferably—the same as in the main polymerization reaction, or is increased, such increase being preferably higher by about 5 to 40° C., preferably 10 to 20° C. compared to the temperature of the main polymerisation reaction;
ii) a step of subjecting the graft polymer as obtained from the main polymerization or—if performed, the post-polymerisation process—to a means of purification, concentration and/or drying to remove part of or almost all of the remaining solvent(s) (as far as they are removable due to their boiling points) and/or volatiles such as residual monomers, wherein
a. the concentration is performed by removing part of the solvent(s) and optionally also volatiles—by this this step additionally serves as means for purification—to increase the solid polymer concentration—and optionally as well for purification-, by preferably applying a distillation process such as thermal or vacuum distillation, preferably vacuum distillation, and/or applying stripping with gas such as steam or an inert gas such as nitrogen, preferably using steam from water, which is performed until the desired solid content and optionally also purity is achieved, preferably is performed until the desired part or all of the volatile components such as volatile solvents and/or unreacted, volatile monomers, are removed;
b. the drying is performed by subjecting the graft polymer containing at least residual amounts of volatiles such as remaining solvent and/or unreacted monomers etc. to a means of removing the volatiles, such as drying using a roller-drum, a spray-dryer, vacuum drying or freeze-drying, preferably-mainly for cost-reasons-spray-drying; and optionally combining such drying process step with a means of agglomeration or granulation to obtain agglomerated or granulated graft polymer particles, such process being preferably selected from spray-agglomeration, granulation or drying in a fluidized-bed dryer, spray-granulation device and the like.

13. The process according to claim 9, wherein the amount of water during the polymerisation is at most 10 wt. %, preferably at most 5 wt. %, more preferably at most 1 wt. %, based on total weight of graft polymer (at the end of the polymerization) or based on total weight of (A) and (B) (at the start of the polymerization).

14. Use of at least one graft polymer according to claim 1 in a composition, that is a fabric and home care product, cleaning composition, industrial and institutional cleaning product, preferably in cleaning compositions for in fabric and home care, the cleaning composition preferably being a laundry detergent formulation, and more preferably the graft polymer(s) being employed as dye transfer inhibitors,
optionally further comprising at least one enzyme, preferably selected from one or more lipases, hydrolases, amylases, proteases, cellulases, hemicellulases, phospholipases, esterases, pectinases, lactases, pectate lyases, cutinases, DNases, xylanases, oxicoreductases, dispersins, mannanases and peroxidases, and combinations of at least two of the foregoing types, preferably at least one enzyme being selected from lipases, hydrolases, amylases, proteases, cellulases,
wherein the at least one graft polymer is present in an amount ranging from about 0.01% to about 20%, preferably from about 0.05% to 15%, more preferably from about 0.1% to about 10%, and most preferably from about 0.5% to about 5%, in relation to the total weight of such composition or product in relation to the total weight of such composition or product, and such product or composition further comprising from about 1% to about 70% by weight of a surfactant system.

15. A composition that is a fabric and home care product, cleaning composition, industrial and institutional cleaning product, preferably a laundry detergent, containing at least one graft polymer according to claim 1,
the graft polymer preferably being employed as dye transfer inhibitor,
optionally further comprising at least one enzyme, preferably selected from one or more lipases, hydrolases, amylases, proteases, cellulases, hemicellulases, phospholipases, esterases, pectinases, lactases, pectate lyases, cutinases, DNases, xylanases, oxicoreductases, dispersins, mannanases and peroxidases, and combinations of at least two of the foregoing types, preferably at least one enzyme being selected from lipases, hydrolases, amylases, proteases, cellulases,
wherein the at least one graft polymer is present in an amount ranging from about 0.01% to about 20%, preferably 0.05 to 10%, more preferably from about 0.1% to 8%, even more preferably from about 0.2% to about 6%, and further more preferably from about 0.2% to about 4%, and most preferably in amounts of up to 2%, each in weight % in relation to the total weight of such composition or product, and
such product or composition further comprising from about 1% to about 70% by weight of a surfactant system.
